(19) United States
(12) Patent Application Publication
(10) Pub. No.: US 2026/0281197 A1
(43) Pub. Date: Sep. 17, 2026

(54) DEVICE CENTRIC METHODS FOR MANAGING SPATIAL ANCHORS IN 3GPP SYSTEMS

(71) Applicant: InterDigital Patent Holdings, Inc., Wilmington, DE (US)

(72) Inventors: Dale SEED, Allentown, PA (US); Quang LY, North Wales, PA (US); Lu LIU, Conshohocken, PA (US)

(73) Assignee: InterDigital Patent Holdings, Inc., Wilmington, DE (US)

(21) Appl. No.: 19/472,151

(22) PCT Filed: Mar. 29, 2024
(86) PCT No.: PCT/US2024/022191

§ 371 Date: Oct. 3, 2025

Related U.S. Application Data
(60) Provisional application No. 63/494,513, filed on Apr. 6, 2023.

(51) Int. Cl. H04L 67/52; H04L 9/40; H04L 65/1104; H04L 67/141

(52) U.S. Cl. CPC H04L 67/52; H04L 63/08; H04L 63/10; H04L 65/1104; H04L 67/141

(57) ABSTRACT

Device centric methods for managing spatial anchors in 3GPP systems are described herein. In one aspect, a method can include receiving, by an extended Reality and Media services (XRM) client of a UE, a spatial anchor request, wherein the spatial anchor request comprises a request to register a VAL client to the XRM client; and sending, by the XRM and in response to the spatial anchor request, a response comprising an identifier of a spatial anchor the VAL client is registered to, a representation of the spatial anchor the VAL is registered to, or both.

### CROSS-REFERENCE TO RELATED APPLICATIONS

This application claims the benefit of U.S. Provisional Application No. 63/494,513 (“Device Centric Methods for Managing Spatial Anchors in 3GPP Systems”) filed Apr. 6, 2023, the contents of which is hereby incorporated by reference in its entirety for any and all purposes.

### BACKGROUND

Augmented Reality (AR) and Virtual Reality (VR) technologies have been tantalizing users for some time for providing an immersive user experience, especially in the gaming industry. In AR, computer graphics are overlayed into a real-world view where a user can then interact with the added graphics to obtain more information about an object present in the user's view. VR, on the other hand, presents a user with a computer-generated virtual environment in which the user can interact with objects in the virtual world.

In both AR and VR, users may for example participate in a gaming session and feel as if they are part of the action. The action may be to guide a hero to infiltrate enemy territory, to navigate in a high-speed car chase, or to duel an opponent in a sporting event. The user may interface to the AR/VR application through wearable devices such as glasses/goggles, headsets, tactile gloves, and other bodily sensors. Users may transmit audio and visual information to the AR/VR application and to another user who may be involved in the gaming session.

An AR/VR service provider may host an application server in the cloud for which many users may gain access to the AR/VR application regardless of their locations. Users may utilize smartphones and/or AR/VR glasses within a static location or the user may be mobile. The mobile devices may require connectivity provided by a Mobile Network Operator's (MNO) cellular communication system.

eXtended Reality (XR) is a term used to describe technologies that enhance a user's view of the real and/or virtual world and therefore may encompass AR, VR, or a combination of both. When multiple users benefit from the same AR/VR/XR immersive experience, a term commonly used to describe such a scenario is the users are interacting with the metaverse. In other words, metaverse refers to the interactions of multiple XR users simultaneously while providing an immersive experience to each user as if they were all interacting in the same location.

Spatial anchors connect locations in a virtual and/or real-world environment with digital content. For example, FIG. 1 shows spatial anchors in a real-world AR use case involving a shopping mall. In this environment, spatial anchors are anchored to store fronts in a shopping mall. Each spatial anchor has a configured location tied to the location of a storefront. Each spatial anchor also has digital content associated with it (e.g., product advertisements). These spatial anchors are used to attract potential customers into the stores and guide them to products which meet their personalized shopping preferences (e.g., personalized advertisements and discounts on products they typically buy). These spatial anchors can be viewed on a customer's personal device (e.g., a smart phone or smart glasses) as they walk about the shopping mall.

In contrast, FIG. 2 shows spatial anchors used in a virtual-world VR use case such as a VR experience. In this type of use case, the spatial anchors are anchored to virtual objects which are rendered and placed throughout a virtual environment. For example, virtual walls, windows, and furniture located within a virtual room. The locations of the spatial anchors in these types of virtual-world use cases are based on a virtual mapped layout of the virtual room/setting. These spatial anchors are used to place and render the virtual objects in the virtual environment with respect to the location and distance of the user being immersed in the virtual environment. For example, as a user wearing a headset device moves around a room and changes their location and viewing angle, the spatial anchors of each virtual object in the room are used to change how the objects are rendered and viewed by the user (e.g., the pose and viewing angle of each object is modified based on the user's location and viewing angle).

The 3GPP system currently lacks XRM centric capabilities to assist VAL clients with the creation and management of spatial anchors. Some examples of specific capabilities currently lacking are the following: a capability for VAL clients to create spatial anchors which can then be discovered and accessed by other VAL clients and VAL servers in the 3GPP system; a capability for a VAL client to offload the management of the spatial anchor to a function on the UE itself (e.g., to control which VAL clients are able to discover and access the spatial anchor); a capability for a VAL client to anchor spatial anchors to the local UE upon which the VAL client resides such that the location associated with the spatial anchor is configured and kept updated as the location of the UE changes; a capability for a VAL client to anchor the spatial anchors to a location that is independent of the location of the local UE upon which the VAL client resides; and a capability on the UE for detecting if/when other UEs come within range of the UE spatial anchors using local ranging capabilities of UEs and generating notifications to VAL clients if/when this occurs.

### SUMMARY

Methods and procedures to enhance the 3GPP system with XRM client spatial anchor functionality are described herein. This proposed functionality provides device centric spatial anchor management functionality in a 3GPP system. In one aspect, an XRM client on a UE supporting spatial anchor functionality can receive and process the following types of spatial anchor requests from VAL clients: A request to register a VAL client to the XRM client such that the XRM client can authenticate the VAL clients and determine which XRM services VAL clients are authorized to access and their XRM service requirements, wherein the request may comprise one or more of the following types of information: VAL client ID, VAL service ID, VAL client supported spatial anchors, VAL client spatial anchors of interest VAL client address information (e.g., URI, port, callback function handle) which the XRM client may use to send future XRM messages to the VAL client, types of XRM services required (e.g., spatial anchor services), required XRM service requirements and/or KPIs, XRM service schedule, security credentials required by the XRM client to authenticate and authorize the VAL client to access the XRM client.

In some cases, the request can include a request to create or update one or more spatial anchors (either locally at the XRM client or remotely at another network server such as an XRM server), may comprise one or more of the following types of information: ID of VAL client associated with supported spatial anchor, ID of supported spatial anchor, type of supported spatial anchor (e.g. navigation, advertisement, etc.), IDs and/or types of content or services supported by VAL client for this spatial anchor, VAL client API information for receiving content or service requests for this supported spatial anchor (e.g., type definition of VAL content/service and callback functions/ports/URLs used to access VAL content/service), VAL client content that the XRM client is to store within the spatial anchor it creates for this supported spatial anchor, discovery information the XRM client is to store within the spatial anchor it creates for this supported spatial anchor (e.g. descriptive labels and metadata describing the spatial anchor and/or content or services provided), scheduled times when VAL client is available to receive content or service requests from the XRM client for this spatial anchor, required location, orientation, and distance of this supported spatial anchor such as a fixed/static location, orientation, and distance this spatial anchor is to be anchored to or a specified ID of a UE this spatial anchor is to be anchored to such that if the UE moves the spatial anchor's location, orientation, and distance are updated by the XRM client, required service area range of supported spatial anchor which may include a distance (e.g., within 500 ft of spatial anchor) and/or direction (e.g., heading toward the spatial anchor) used by XRM client to detect if/when UEs or objects enter service area limits of spatial anchor, required capabilities of spatial anchor such as whether this spatial anchor is mobile and requires mobility support, or whether this spatial anchor requires ranging to detect if/when UE and/or objects come within service area range limits of spatial anchor, required service KPIs of supported by this spatial anchor such as a spatial anchor location dimensionality (e.g., 2D, 3D), a spatial anchor location/orientation/distance/ranging detection precision, or spatial anchor content/service access latency or throughput, security credentials of this supported spatial anchor (e.g. keys/tokens/certificates that VAL client supports for accessing spatial anchor content or services), access control policies of this supported spatial anchor (e.g., rules specifying which entities are permitted to access a spatial anchor and/or the content or services associated with a spatial anchor, the types of operations permitted to spatial anchor, the permitted locations of entities when accessing spatial anchor, the permitted times of frequency of access to spatial anchor), advertisement policies of this supported spatial anchor (e.g., rules such as advertisement range/geo-fence, advertisement schedule, UE IDs/group IDs, VAL client IDs, etc. These rules may be used by an XRM client to determine if, when, and/or which entities in the 3GPP system to advertise spatial anchor context information to).

In some cases, the request can include a request to discover spatial anchors of interest to the VAL client can meet one or more specified spatial anchor criteria such as but not limited to: spatial anchors having a specified ID and/or type, spatial anchors having a specified types of associated content or service, spatial anchors supporting required service KPIs such as spatial anchor location/orientation/distance/ranging precision or a spatial anchor content/service access latency or throughput, spatial anchors having a specified location, orientation, distance, range relative to the VAL client, and spatial anchors having a specified availability schedule.

In some cases, the request can include a request to retrieve spatial anchor context information for one or more spatial anchors, wherein the information may comprise the information elements defined in Table 1.

In some cases, the request can include a request to subscribe to spatial anchors to receive spatial anchor notifications based on the detection of spatial anchor related events that are of interest to a VAL client such as: a ranging threshold value specifying a minimum distance between this spatial anchor and UEs that may enter into its proximity, a change in location, orientation, or distance of the spatial anchor (or to the object anchored to the spatial anchor) which exceeds a specified threshold, detection of UE(s) within the same location as the spatial anchor (or same location as the object which is anchored to the spatial anchor), detection of UE(s) having the same orientation or distance from a spatial anchor (or object which is anchored to the spatial anchor), for example, a UE moving towards a spatial anchor, detection of UE(s) within a specified range of the spatial anchor (or the object anchored to the spatial anchor), detection of UE(s) having content interests which match the type of content linked or stored within a spatial anchor, and detecting a specified type of operation performed on the spatial anchor (e.g., spatial anchor update, discovery, retrieval, or subscription).

In some cases, the request can include a request to access VAL content or services stored within a spatial anchor and/or linked to a spatial anchor, wherein the request may comprise a spatial anchor ID, IDs for one or more instances of VAL content stored within a spatial anchor, IDs, or links (e.g., URLs) of one or more instances of VAL content or VAL services associated with a spatial anchor and provided by a VAL server or VAL client.

In some cases, the request can include a request to delete one or more spatial anchors such that spatial anchor information is removed from the XRM client and/or XRM server and/or other servers such as a SEALDD server.

In some cases, the XRM client may return one or more corresponding responses to a VAL client request, wherein the response may comprise one or more of the following information elements: one or more identifier(s) and/or network addresses (e.g., URLs) of spatial anchors that have been created, discovered, retrieved or subscribed to, a representation of one or more spatial anchors comprising information elements such as: spatial anchor location, spatial anchor representation comprising one or more information elements defined in Table 1, authorization token to access spatial anchor and/or VAL content or services associated with spatial anchor, and a confirmation of whether the requested spatial anchor operations has been performed successfully, and if not a reason for failure (e.g., spatial anchor client is not authorized to access spatial anchor).

In another aspect, an XRM client on a UE supporting spatial anchor functionality can initiate the following types of spatial anchor requests: a request that is sent to a function or service in the 3GPP system to discover an XRM server or another XRM client, wherein the request comprises XRM discovery criteria such as but not limited to types of XRM services required (e.g., spatial anchor services), required XRM service requirements and/or KPIs, XRM service schedule; a request that is sent to an XRM server or another XRM client to register the XRM client, wherein the request may comprise an XRM client ID, security credentials to authenticate/authorize the XRM client, the types of XRM services required (e.g., spatial anchor services), the required XRM service requirements and/or KPIs, XRM service schedule; a request that is sent to an XRM server or another XRM client to discover spatial anchors of interest, wherein the request may comprise one or more of the aforementioned spatial anchor discovery criteria which the XRM client receives from a VAL client; a request that is sent to an XRM server or another XRM client to retrieve spatial anchor context information for one or more spatial anchors, wherein the information may comprise the information elements defined in Table 1; a request that is sent to an XRM server or another XRM client to create or update a spatial anchor, wherein the request may comprise one or more of the aforementioned spatial anchor information elements defined within the spatial anchor create or update request that the XRM client receives from a VAL client.

In some cases, the request can include a request that is sent to an XRM server or another XRM client to subscribe to a spatial anchor, wherein the request may comprise one or more of the aforementioned spatial anchor subscription elements defined within the spatial anchor subscribe request that the XRM client receives from a VAL client.

In some cases, the request can include a request that is sent to an XRM server or another XRM client to anchor a spatial anchor to a nearby UE or a nearby passive object whose location, orientation, and distance can be determined by a nearby UE, wherein the request may comprise: a spatial anchor ID, an ID of an object to anchor to the spatial anchor, a targeted XRM client to perform the anchoring operation on behalf of the XRM client, a targeted UE ID of the UE to perform the anchoring operation on behalf of the XRM client.

In some cases, the request can include a request that is sent to an XRM server, another XRM client, or another function or service in the 3GPP system to collect location, orientation, or distance information of an object such that the information can be used to perform a spatial anchor ranging operation by the XRM client, wherein the request may comprise: a spatial anchor ID, an ID of an object anchored to a spatial anchor, IDs of UE(s) in the proximity of a spatial anchor.

In some cases, the request can include a request that is sent to an XRM server, another XRM client, or another function or service in the 3GPP system to collect ranging information of an object with respect to the location, orientation, and distance of a spatial anchor, wherein the request may comprise: a spatial anchor ID, an ID of an object anchored to a spatial anchor, IDs of UE(s) in the proximity of a spatial anchor, the current or last known location(s) and/or distance of a spatial anchor, service area range limits of a spatial anchor, spatial anchor ranging requirements such as the location precision, format, and/or dimensionality required for location information returned for the UE.

In some cases, the request can include a request that is sent to an XRM server or another XRM client to access VAL content or services stored within a spatial anchor and/or linked to a spatial anchor, wherein the request may comprise a spatial anchor ID, IDs for one or more instances of VAL content stored within a spatial anchor, IDs or links (e.g., URLs) of one or more instances of VAL content or VAL services associated with a spatial anchor and provided by a VAL server or VAL client.

In some cases, the request can include a notification request is sent to an XRM server or another XRM client if/when detecting spatial anchor subscription criteria, such as those defined in aforementioned subscription requests, have been met, wherein the spatial anchor notification may comprise one or more spatial anchor information elements defined in Table 1.

In some cases, the request can include a request that is sent to an XRM server or another XRM client to delete or unsubscribe to one or more spatial anchors.

In some cases, the XRM client receives one or more corresponding responses from the targeted XRM server, XRM client or another function or service in the 3GPP system for the request, wherein the response may comprise one or more of the following information elements: one or more identifier(s) and/or network addresses (e.g., URLs) of spatial anchors that have been created, discovered, retrieved or subscribed to, a representation of one or more spatial anchors comprising information elements such as: spatial anchor location, spatial anchor representation comprising one or more information elements defined in Table 1; authorization token to access spatial anchor and/or VAL content or services associated with spatial anchor; a confirmation of whether the requested spatial anchor operations has been performed successfully, and if not a reason for failure (e.g., spatial anchor client is not authorized to access spatial anchor).

In another aspect, an XRM client can support spatial anchor functionality that receives and processes the following types of spatial anchor requests from an XRM server or XRM client: a request to discover or retrieve spatial anchors, wherein the request comprises one or more spatial anchor criteria such as the aforementioned criteria defined for a spatial anchor discovery request which an XRM client receives from a VAL client.

In some cases, the request can include a request to create or update a spatial anchor, wherein the request comprises one or more specified spatial anchor information elements such as the aforementioned information elements defined for a spatial anchor create or update request which an XRM client receives from a VAL client.

In some cases, the request can include a request to subscribe to a spatial anchor, wherein the request comprises one or more specified spatial anchor subscription elements such as the aforementioned subscription elements defined for a spatial anchor subscription request which an XRM client receives from a VAL client.

In some cases, the request can include a request to anchor a spatial anchor to the local UE of the XRM client, a nearby UE or a nearby passive object whose location, orientation, and distance can be determined by a nearby UE, wherein the request may comprise one or more of the aforementioned elements defined for an XRM client initiated anchoring request.

In some cases, the request can include a request for location, orientation, and/or distance information of a spatial anchor or object in the vicinity of a spatial anchor, wherein the request may comprise one or more of the aforementioned elements defined for an XRM client initiated spatial anchor location/orientation/distance request.

In some cases, the request can include a request for ranging information regarding the location and/or distance of an object with respect to a spatial anchor, wherein the request may comprise one or more of the aforementioned elements defined for an XRM client initiated spatial anchor ranging request.

In some cases, the request can include a request for VAL content or services associated with a spatial anchor, wherein the request may comprise one or more of the aforementioned elements defined for an XRM client initiated spatial anchor content or services request.

In some cases, the request can include a request to notify the XRM client of a spatial anchor event, wherein the request may comprise one or more of the aforementioned elements defined for an XRM client initiated spatial anchor notification request.

In some cases, the request can include a request to delete one or more spatial anchors, wherein the request may comprise one or more of the aforementioned elements defined for an XRM client initiated spatial anchor delete request.

In some cases, the XRM client may receive and process the request and return a response back to the XRM client or XRM server, wherein the response may comprise one or more of the aforementioned elements defined for a response that the XRM client receives for an XRM client initiated spatial anchor request.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

A more detailed understanding may be had from the following description, given by way of example in conjunction with the accompanying drawings.

FIG. 1 depicts Real-World AR Spatial Anchors.

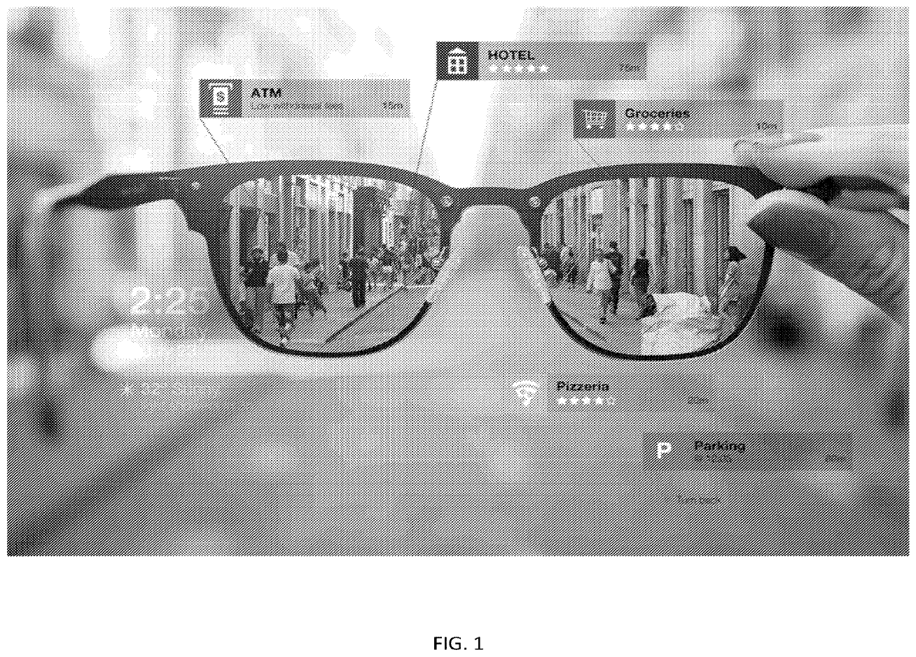

FIG. 2 depicts Virtual-World VR Spatial Anchors.

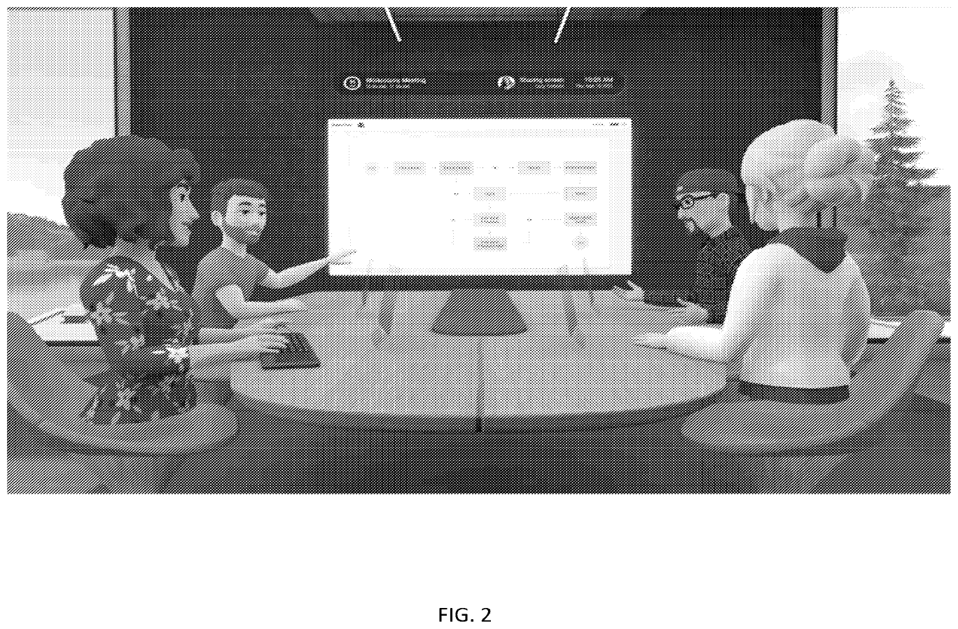

FIG. 3 depicts Device Centric Spatial Anchor Services Architecture.

FIG. 4 depicts Overview of Device Centric Spatial Anchor Procedures.

FIG. 5 depicts VAL Client Initiated XRM Service Registration/De-Registration.

FIG. 6 depicts VAL Client Initiated Spatial Anchor Advertisement.

FIG. 7 depicts VAL Client Initiated Spatial Anchor Discovery/Retrieval.

FIG. 8 depicts VAL Client Initiated Spatial Anchor Creation/Update

FIG. 9 depicts VAL Client Initiated Spatial Anchor Subscribe/Unsubscribe

FIG. 10 depicts VAL Client Initiated Spatial Anchor Content or Service Request

FIG. 11 depicts VAL Client Initiated Spatial Anchor Delete

FIG. 12 depicts XRM Client Initiated XRM Discovery

FIG. 13 depicts XRM Client Initiated XRM Registration/De-Registration

FIG. 14 depicts XRM Client Initiated Spatial Anchor Advertisement

FIG. 15 depicts XRM Client Initiated Spatial Anchor Discovery/Retrieval

FIG. 16 depicts XRM Client Initiated Spatial Anchor Creation/Update

FIG. 17 depicts XRM Client Initiated Spatial Anchor Subscribe/Unsubscribe

FIG. 18 depicts XRM Client Initiated Spatial Anchor Anchoring Operations

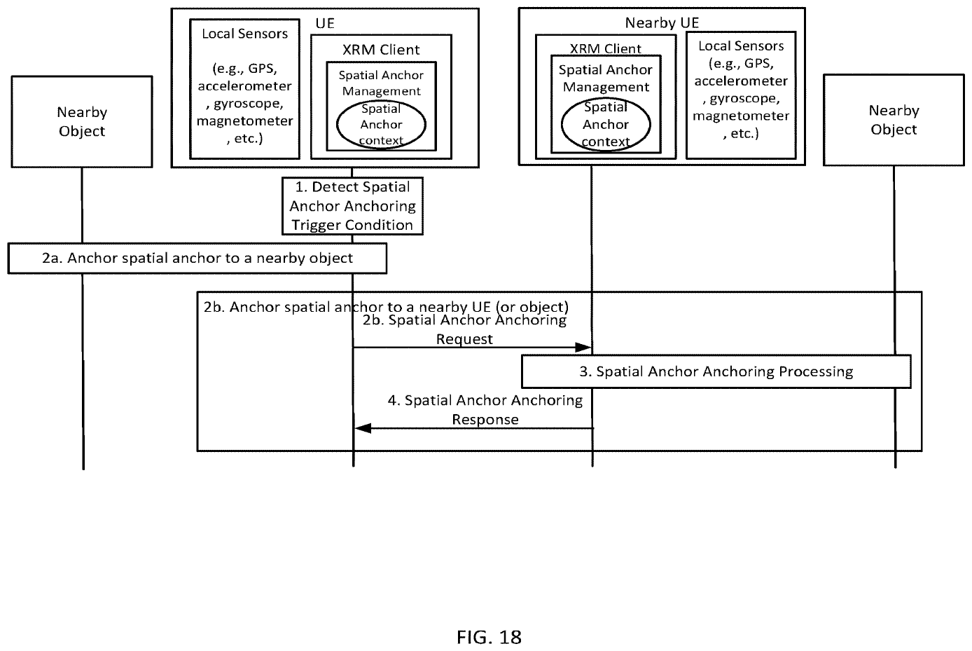

FIG. 19 depicts XRM Client Initiated Spatial Anchor Location/Distance Operations

FIG. 20 depicts XRM Client Initiated Spatial Anchor Ranging Operations

FIG. 21 depicts XRM Client Initiated Spatial Anchor Content or Service Request

FIG. 22 depicts XRM Client Initiated Spatial Anchor Notifications

FIG. 23 depicts XRM Client Initiated Spatial Anchor Delete

FIG. 24 depicts XRM Server Initiated Spatial Anchor Advertisement

FIG. 25 depicts XRM Server Initiated Spatial Anchor Discovery/Retrieval

FIG. 26 depicts XRM Server Initiated Spatial Anchor Creation/Update

FIG. 27 depicts XRM Server Initiated Spatial Anchor Subscribe/Unsubscribe

FIG. 28 depicts XRM Server Initiated Spatial Anchor Anchoring Request

FIG. 29 depicts XRM Server Initiated Spatial Anchor Location/Distance Request

FIG. 30 depicts XRM Server Initiated Spatial Anchor Ranging Request

FIG. 31 depicts XRM Server Initiated Spatial Anchor Content or Service Request

FIG. 32 depicts XRM Server Initiated Spatial Anchor Subscribe/Unsubscribe

FIG. 33 depicts XRM Server Initiated XRM Spatial Anchor Delete

FIG. 34 depicts XRM Spatial Anchor Client GUI

FIG. 35A depicts an example communications system in which the methods and apparatuses described and claimed herein may be an aspect of;

FIG. 35B depicts a block diagram of an example apparatus or device configured for wireless communications.

FIG. 35C depicts a system diagram of an example radio access network (RAN) and core network.

FIG. 35D depicts a system diagram of another example RAN and core network.

FIG. 35E depicts a system diagram of another example RAN and core network.

FIG. 35F depicts a block diagram of an example computing system.

FIG. 35G depicts a block diagram of another example communications system.

### DETAILED DESCRIPTION OF ILLUSTRATIVE EMBODIMENTS

### Device Centric Spatial Anchor Services Architecture

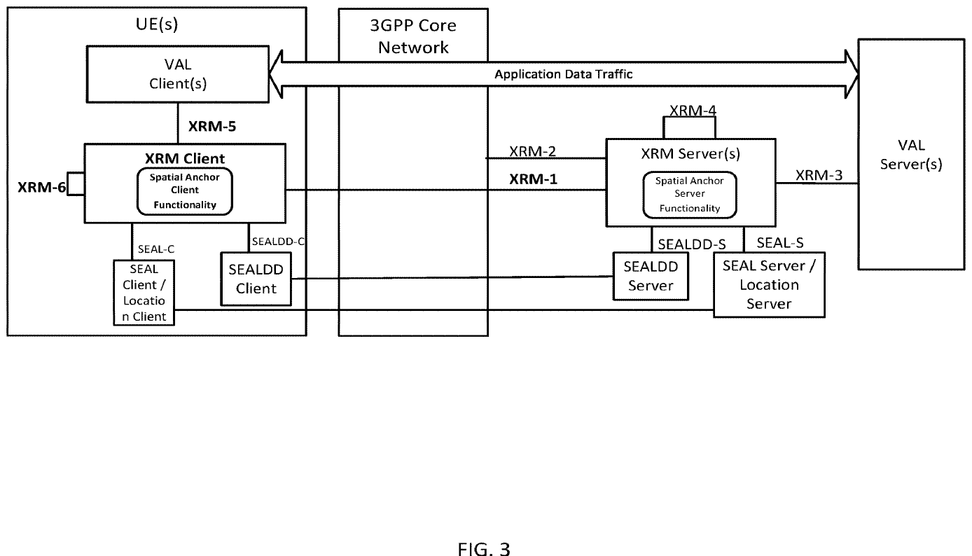

FIG. 3 illustrates a proposed architecture for supporting device centric spatial anchor services within the context of a 3GPP system. The architecture defines an XR and Media services (XRM) client in a 3GPP system which supports spatial anchor client functionality. The XRM client and its supported spatial anchor services may be accessed and used by VAL clients. For example, VAL clients can offload the creation and management of VAL client defined spatial anchors to the XRM client. To manage these spatial anchors, the XRM client may also interface to other functions and services in the 3GPP system such as but not limited to those shown in this proposed architecture. For example, the XRM client may interface to an XRM server (e.g., to access spatial anchor server functionality of the XRM server). The XRM client may interface to other functions and services such as 3GPP defined SEAL and SEALDD clients. The XRM client may also interface to other XRM clients (e.g., to access spatial anchor services of XRM clients resident on other UEs).

To interface an XRM client to VAL clients, XRM servers and other XRM clients, new reference points such as the ones shown in FIG. 3 may be defined. For example, an XRM-1 reference point may be defined to interface an XRM client to one or more XRM servers. An XRM-5 reference point may be defined to interface VAL clients with an XRM client. An XRM-6 reference point may be defined to interface an XRM client with another XRM client.

An XRM client may also interface to other functions and services defined in the 3GPP system via existing reference points. For example, the SEALDD-C reference point may be used by an XRM client to interface to a SEALDD client (e.g., to store and access spatial anchor context information within a SEALDD server and/or a SEALDD data repository). The SEAL-C reference point may be used by an XRM client to interface to a SEAL client and one or more SEAL services such as a SEAL location management server (e.g., to store and/or access spatial anchor location information).

One skilled in the art shall recognize that this proposed architecture is not intended to limit or exclude other possible architectural options for supporting spatial anchor services within the 3GPP system. For example, rather than device centric spatial anchor functionality being supported and defined within an XRM client, this functionality may be realized as a separate standalone client on a UE. Alternatively, the spatial anchor functionality may be realized as capabilities supported by other services on a UE such as but not limited to a SEALDD client or SEAL client.

Note that the XRM client shown in FIG. 3 may also be deployed on a non-3GPP device. Likewise, the XRM server shown in FIG. 3 may also be deployed by a cloud service provider offering XRM spatial anchor services which may or may not communicate with the 3GPP network. The cloud service provider may expose API's for VAL servers to access the spatial anchor services described in this invention.

### Device Centric Spatial Anchor Context Information

Table 1 defines device centric spatial anchor context information that may be transmitted, received, stored, updated, processed, and/or generated by various entities in a 3GPP system such as but not limited to an XRM client or server, SEAL client or server, SEALDD client or server. One skilled in the art will recognize that spatial anchor context information may be comprised of additional information elements not captured in Table 1.

TABLE 1
Device Centric Spatial Anchor Context Information

| Informational Element | Parameter Description |
|---|---|
| Information provided by VAL | Each VAL client may provide an XRM client with information regarding spatial |
| clients to XRM clients | anchors of interest to the VAL client. For example, spatial anchors in the 3GPP |
| regarding spatial anchors of | system that the VAL client would like the XRM client to discover and/or |
| interest to VAL clients | subscribe to for the VAL client. For example, if/when the VAL client is within the |
| | service area of these spatial anchors, the XRM client may send a notification to |
| | the VAL client with information regarding the spatial anchor. |
| | The types of information that a VAL client may provide to the XRM client |
| | regarding spatial anchors of interest may include: |
| | IDs and/or types of spatial anchors of interest |
| | IDs and/or types of content or services stored within spatial anchors or |
| | associated with spatial anchors of interest, |
| | Required service KPIs of spatial anchors of interest, |
| | Spatial anchor location/orientation/distance/ranging |
| | precision, |
| | Spatial anchor content/service access latency or throughput |
| | Notification criteria for spatial anchors of interest |
| | Locations, orientations, distances, ranges of the VAL client |
| | (or spatial anchor of interest) used to qualify if/when |
| | notifications are sent to VAL client for detected spatial |
| | anchors of interest, |
| | Max frequency of notifications sent to VAL client, |
| | Allowed or forbidden times for spatial anchor interest |
| | notifications |
| Information provided by VAL | Each VAL client may provide an XRM client with information regarding one or |
| clients to XRM clients | more spatial anchors supported by the VAL client. For example, information |
| regarding spatial anchors | regarding spatial anchors the VAL client supports providing spatial anchor |
| supported by VAL clients | content and/or services for, and the VAL client would like the XRM client to help |
| which XRM client is to help | manage on its behalf. Using this information, the XRM client can create |
| manage | corresponding spatial anchors in the 3GPP system and manage these 3GPP |
| | spatial anchors to help offload the VAL client. |
| | The types of information that a VAL client may provide to an XRM client |
| | regarding each supported spatial anchor may include: |
| | ID of the VAL client associated with this spatial anchor, |
| | ID of this spatial anchor |
| | Type of this spatial anchor (e.g. navigation, advertisement, etc.) |
| | IDs and/or types of content or services supported by VAL client for this |
| | spatial anchor, |
| | VAL client API information for receiving content or service requests for |
| | this spatial anchor (e.g., type definition of VAL content/service and |
| | callback functions/ports/URLs used to access VAL content/service) |
| | VAL client content that the XRM client is to store within the spatial |
| | anchor it creates for this spatial anchor, |
| | Discovery information the XRM client is to store within the spatial |
| | anchor it creates for this spatial anchor (e.g. descriptive labels and |
| | metadata describing the spatial anchor and/or content or services |
| | provided) |
| | Scheduled times when VAL client is available to receive content or |
| | service requests from the XRM client for this spatial anchor, |
| | Required location, orientation, and distance of this spatial anchor, |
| | E.g., A fixed/static location and distance this spatial anchor |
| | is to be anchored to |
| | E.g., A specified ID of a UE this spatial anchor is to be |
| | anchored to such that if the UE moves, the spatial anchor's |
| | location, orientation, and distance are updated by the XRM |
| | client. |
| | Required service area range of this spatial anchor which may include |
| | a distance (e.g., within 500 ft of spatial anchor) and/or orientation (e.g., |
| | heading or angle of arrival toward the spatial anchor) used by XRM |
| | client to detect if/when UEs or objects enter service area limits of |
| | spatial anchor, |
| | Required capabilities of spatial anchor such as whether this spatial |
| | anchor is mobile and requires mobility support, or whether this spatial |
| | anchor requires ranging to detect if/when UE and/or objects come |
| | within service area range limits of this spatial anchor, |
| | Required service KPIs of this spatial anchor such as spatial anchor |
| | location dimensionality (e.g., 2D, 3D), spatial anchor |
| | location/orientation/distance/ranging detection precision, or spatial |
| | anchor content/service access latency or throughput, |
| | Security credentials of this spatial anchor (e.g. keys/tokens/ |
| | certificates that VAL client supports for accessing spatial anchor |
| | content or services) |
| | Access control policies of this spatial anchor (e.g., rules specifying |
| | which entities are permitted to access a spatial anchor and/or the |
| | content or services associated with a spatial anchor, the types of |
| | operations permitted to spatial anchor, the permitted locations of |
| | entities when accessing spatial anchor, the permitted times of |
| | frequency of access to spatial anchor) |
| | Advertisement policies of this spatial anchor (e.g., rules such as |
| | advertisement range/geo-fence, advertisement schedule, UE IDs/ |
| | group IDs, VAL client IDs, etc. These rules may be used by an XRM |
| | client to determine if, when, and/or which entities in the 3GPP system |
| | to advertise spatial anchor context information to) |
| Information managed by an | For each spatial anchor managed by an XRM client, the following types of |
| XRM client for each spatial | spatial anchor context information may be managed and maintained by the |
| anchor | XRM client. |
| | Spatial anchor location, orientation, or distance - Current location, |
| | orientation, or distance of the spatial anchor. For example, an outdoor |
| | mapped location (e.g., GPS location coordinates) or an indoor mapped |
| | location such as the coordinates of a product on a store shelf which |
| | the spatial anchor is anchored to. |
| | Spatial anchor ID - Unique identifier of the spatial anchor |
| | Anchored Status - An indicator to reflect whether a spatial anchor is |
| | currently anchored to another entity (e.g. a UE) or unanchored. |
| | Anchored object profile or ID of spatial anchor - A profile or identifier |
| | of an object to which the spatial anchor is anchored to. An object |
| | profile may comprise one or more information elements pertaining to |
| | an object associated with the spatial anchor. These information |
| | elements of the profile may contain context describing the object (e.g., |
| | an ID, type, or metadata associated with the object). An object ID may |
| | be used to associate a spatial anchor to one or more objects in the |
| | real-world or a virtual world. For example, a spatial anchor may be |
| | anchored to a store shelf. The store shelf may shelve multiple items. |
| | The spatial anchor may be anchored to the shelf, or it may be |
| | anchored to one or more individual items on a store shelf. |
| | Spatial anchor content - VAL content received that is stored and |
| | maintained in the spatial anchor by the XRM client. The XRM client |
| | may perform operations such as controlling which entities in the 3GPP |
| | system are permitted to access this content based on other context |
| | information stored within the spatial anchor (e.g., access control |
| | policies, security credentials, service area range limits, etc.) as well as |
| | additional context information the XRM client may collect from other |
| | entities in the 3GPP system (e.g., the current location of other UEs). |
| | Spatial anchor status - A status indicating whether the spatial anchor |
| | is currently active or inactive. For example, this indicator may be a |
| | Boolean or enumerated type value indicating whether the spatial |
| | anchor is active (i.e. True) or inactive (i.e., False). When inactive, |
| | discovery and interaction with the spatial anchor by other entities in |
| | the 3GPP system may be blocked by the XRM client. |
| | Spatial anchor subscription information that may include one or more |
| | of the following elements: |
| | Spatial anchor subscription ID |
| | Subscriber information such as the identity of a VAL client, |
| | XRM client or XRM server that created the spatial anchor |
| | subscription. |
| | Spatial anchor subscription event criteria specifying spatial |
| | anchor events of interest to the subscriber (e.g., ranging |
| | threshold value specifying a minimum distance between this |
| | spatial anchor and UEs that may enter into its proximity) |
| | A change in location, orientation, or distance of the |
| | spatial anchor (or to the object anchored to the |
| | spatial anchor) which exceeds a specified threshold. |
| | Detection of objects(s) within the same location as |
| | the spatial anchor (or same location as the object |
| | which is anchored to the spatial anchor) |
| | Detection of objects(s) having the same direction as |
| | the spatial anchor (or object which is anchored to |
| | the spatial anchor). For example, a UE moving |
| | towards a spatial anchor. |
| | Detection of objects(s) within a specified range of |
| | the spatial anchor (or the object anchored to the |
| | spatial anchor) |
| | Detection of objects(s) having content interests |
| | which match the type of content linked or stored |
| | within a spatial anchor. |
| | Detecting a specified type of operation performed on |
| | the spatial anchor (e.g., spatial anchor update, |
| | discovery, retrieval, or subscription) |
| | Notification target(s) specifying contact information (e.g., IP |
| | address, port, URI) where spatial anchor notifications are |
| | sent by the XRM client if/when spatial anchor event criteria |
| | for this subscription have been met. |
| | Notification content specifying what spatial anchor |
| | information elements should be included (or excluded) in a |
| | notification that is sent to a notification target (e.g., spatial |
| | anchor ID, spatial anchor content, etc. |

### Device Centric XRM Spatial Anchor Procedures

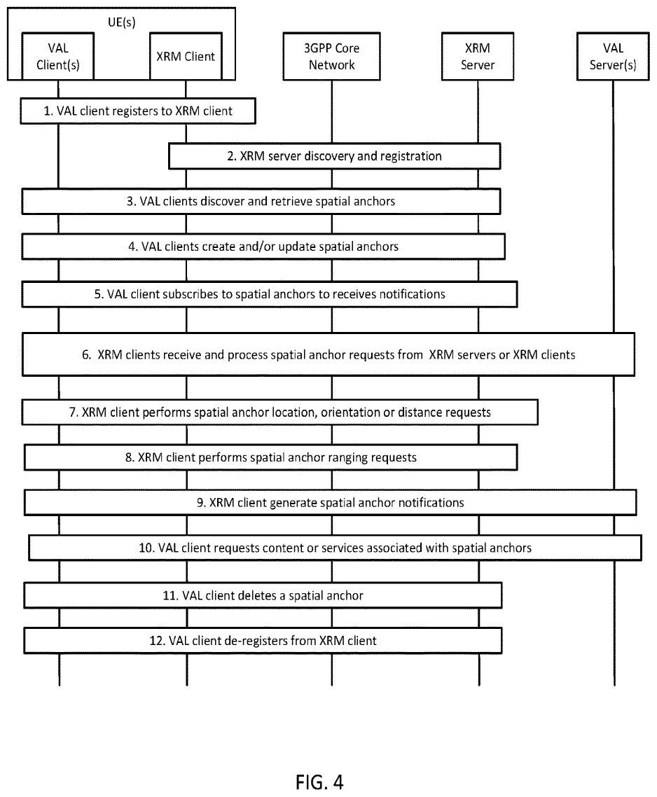

FIG. 4 provides an overview of the different types of device centric XRM spatial anchor procedures proposed in this invention. For each of the steps defined in FIG. 4, one or more separate procedures are defined in subsequent sections of this invention which provide additional proposed functionality and detail.

Step 1: An XRM client receives one or more requests from VAL clients to register to the XRM client and/or XRM server(s).

Step 2: An XRM client sends one or more requests to discover and/or register to one or more XRM servers or to other XRM clients.

Step 3: An XRM client receives one or more requests from a VAL client to discover spatial anchors of interest. The XRM client may send one or more requests to XRM servers or other XRM clients when processing the spatial anchor discovery requests from the VAL client.

Step 4: An XRM client receives one or more requests from a VAL client to create or update one or more spatial anchors. The XRM client may send requests to one or more XRM servers or other XRM clients when processing the spatial anchor create or update requests from the VAL client.

Step 5: An XRM client receives one or more requests from a VAL client to subscribe to one or more spatial anchors such that the VAL client receives notifications regarding spatial anchor events of interest. The XRM client may send requests to one or more XRM servers or other XRM clients when processing the spatial anchor subscription requests from the VAL client.

Step 6: An XRM client receives and processes one or more spatial anchor requests from XRM servers and/or other XRM clients.

Step 7: An XRM client performs spatial anchor location, orientation, and/or distance operations.

Step 8: An XRM client performs spatial anchor ranging operations. The ranging operations performed by an XRM client may be initiated/triggered by a VAL client, XRM server or another XRM client.

Step 9: An XRM client generates spatial anchor operations (e.g. spatial anchor location/orientation/distance notifications or spatial anchor ranging notifications).

Step 10: An XRM client receives and processes one or more requests from a VAL client, XRM server, or XRM client to access content or services associated with a spatial anchor.

Step 11: An XRM client receives one or more requests from a VAL client to delete one or more spatial anchors. The XRM client may send one or more requests to XRM servers or other XRM clients when processing the spatial anchor delete requests from the VAL client.

Step 12: An XRM client receives one or more requests from a VAL client to de-register from the XRM client. The XRM client may send one or more requests to XRM servers or other XRM clients when processing the XRM de-registration requests from the VAL client.

### VAL Client Initiated XRM Service Registration/De-Registration

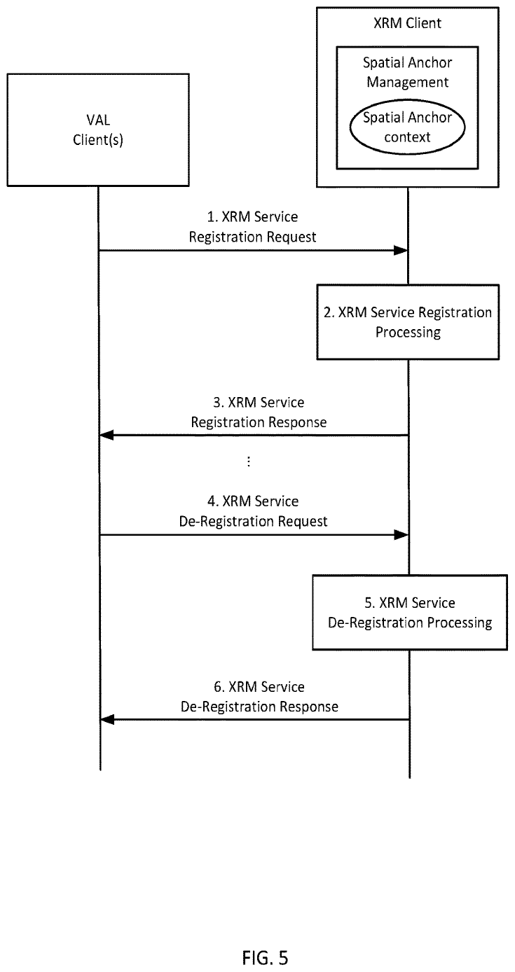

As shown in FIG. 5, a VAL client may register to an XRM client to receive XRM services by initiating a registration request to the XRM client. Likewise, a VAL client may de-register from an XRM client by initiating a de-registration request to the XRM client.

Step 1: A VAL client issues a registration request to an XRM client. The VAL client and XRM client may be resident on the same UE or different UEs. The registration request may comprise information elements such as but not limited to one or more of the following:
VAL client ID,
VAL service ID,
VAL client supported spatial anchors,
VAL client spatial anchors of interest,
VAL client address information (e.g., URI, port, callback function handle) which the XRM client may use to send future XRM messages to the VAL client,
types of XRM services required (e.g., spatial anchor services),
required XRM service requirements and/or KPIs, XRM service schedule,
security credentials required by the XRM client to authenticate and authorize the VAL client to access the XRM client,

Step 2: Upon receiving the registration request from the VAL client, the XRM client may process the request. The processing may include the XRM client authenticating and authorizing the VAL client to access services provided by the XRM client using the VAL client ID, VAL service ID and security credentials provided in the request. If authentication and authorization is successful, the XRM client may determine whether the requested types of XRM services, XRM service schedule and required XRM service KPIs are supported by the XRM client. The XRM client may initiate one or more requests to other functions and services in the 3GPP system to assist it with performing these operations. For example, the XRM client may send a request to an XRM server, another XRM client, and/or other types of functions or services.

Step 3: The XRM client may return an XRM registration response to the VAL client. The response may include information elements such as a status indicator whether the XRM registration was successful and information regarding one or more XRM services that the VAL client is permitted to access via the XRM client. This information may include an XRM registration ID such as the ID of a registration resource or session created by the request. The response may also include XRM client API information such as API addresses (e.g., URIs or function handles) and API security credentials (e.g., keys or tokens), security credentials).

Step 4: A VAL client issues a de-registration request to an XRM client. The VAL client and XRM client may be resident on the same UE or different UEs. The de-registration request may comprise information elements such as but not limited to the XRM registration ID which the VAL client received from the XRM client when registering. The VAL client may also include a VAL client ID.

Step 5: Upon receiving the de-registration request from the VAL client, the XRM client may process the request. The processing may include the XRM client removing any XRM state locally stored by the XRM client. This XRM state may include spatial anchors and any associated spatial anchor context related to the VAL client. The XRM client may also initiate one or more requests to other functions and services in the 3GPP system to clean-up and remove any XRM state stored on these entities. For example, the XRM client may send a request to an XRM server, another XRM client, and/or other types of functions or services in the 3GPP system.

Step 6: The XRM client may return an XRM de-registration response to the VAL client. The response may include information elements such as a status indicator whether the XRM de-registration was successful.

### VAL Client Initiated Spatial Anchor Advertisement

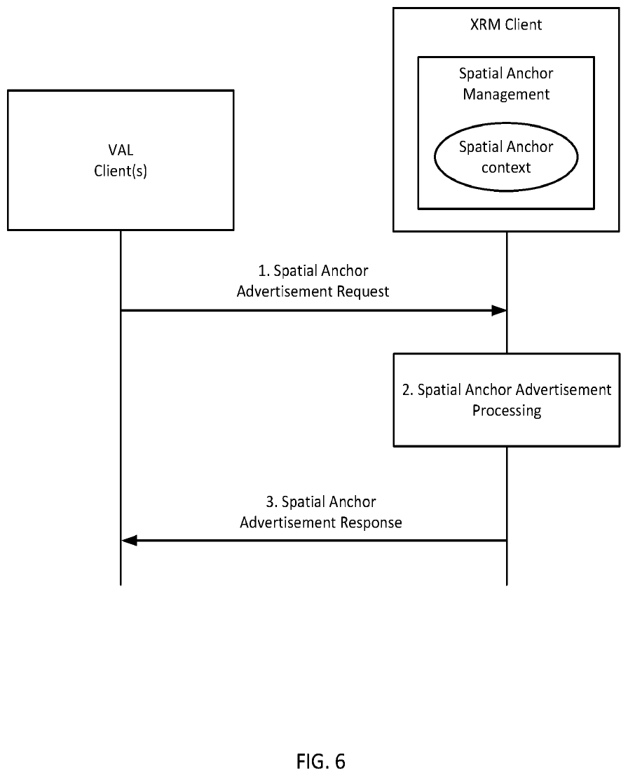

As shown in FIG. 6, a VAL client may issue a request to an XRM client to advertise a spatial anchor. For example, a VAL client may advertise a spatial anchor to other nearby VAL clients hosted on UEs in the local proximity of the VAL client.

Step 1: A VAL client may issue a request to an XRM client to advertise one or more spatial anchors. The request may include information elements such as but not limited to those defined in Table 1. In addition, the request may also include one or more of the following parameters:
An address of identifier of a targeted UE or a group of UEs
An address or identifier of a targeted VAL client or VAL server
An address or identifier of a targeted XRM client or XRM server
An identifier of one or more spatial anchors to advertise
An advertisement condition or criteria which the XRM client may use to qualify whether or not to advertise the spatial anchor such as only advertising spatial anchors to UEs which are within a specified range of the VAL client.

Step 2: Upon receiving the request to advertise one or more spatial anchors, the XRM client may process the request by first checking whether the VAL client originating the request has permissions. This check may be performed by the XRM client checking that the VAL client ID specified in the request matches an ID specified in the access control privileges of the XRM client. The check may also be performed by checking whether a token specified in the request matches a token specified in the targets spatial anchor(s). The check may also include verifying the type of spatial anchor operation being performed (i.e., advertisement) is allowed and/or allowed at the current time and/or from the current location that the VAL client resides. If allowed, the XRM client processes the request. When processing the request, the XRM client may check whether the request includes advertisement criteria. If present, the XRM client may compare the specified advertisement criteria against context information maintained by the XRM client or obtained from other entities either hosted on the same UE or elsewhere in the system. When comparing the advertisement criteria, the XRM client may determine whether any spatial anchor context information matches the specified advertisement criteria. Based on this determination, the XRM client may send one or more requests to other entities in the network to advertise one or more spatial anchors to the other entities in the system.

Step 3: The XRM client may return the advertisement results to the VAL client. The results may include a status indicating whether the advertisement request was processed successfully. The results may also include the identifiers of the entities where the spatial anchor(s) were announced to.

### VAL Client Initiated Spatial Anchor Discovery/Retrieval

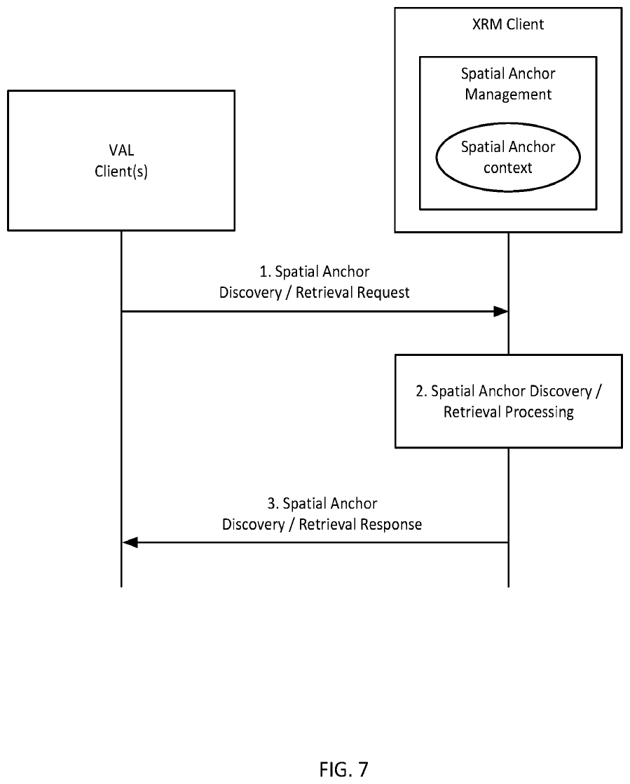

As shown in FIG. 7, a VAL client may initiate a request to an XRM server to retrieve or discover information regarding one or more spatial anchors.

Step 1: A VAL client may issue a request to an XRM client to retrieve context for one or more spatial anchors. Alternatively, the retrieval request may be used to discover one or more spatial anchors that match one or more specified criteria. The request may include information elements such as but not limited to those defined in Table 1. In addition, the request may also include a spatial anchor discovery criteria. These criteria may include variables, operators and/or values. The variables may refer to spatial anchor context information elements such as but not limited to the information elements defined in Table 1. The operators may include but are not limited to operators such as =, !=, <, >, <=, >=. The values may include numbers, strings, or complex types. Some examples of criteria may include but are not limited to a spatial anchor having:
a spatial anchor associated with a specific VAL client ID, VAL server ID or VAL service ID.
a specific type or instance of a spatial anchor
a spatial anchor status of enabled or disabled.
a spatial anchor currently anchored to a specific object.
a spatial anchor within a certain location and/or having a specific distance.
a spatial anchor enabled to track/detect changes in location, orientation, or distance of an object to which it is anchored to.
a spatial anchor capable of performing ranging and detecting UEs in range of the spatial anchor.
a spatial anchor having a particular type of linked or stored digital content.
a spatial anchor associated with a VAL client or VAL server having a specified VAL availability schedule.
a spatial anchor having a status that is active or inactive and/or having a specified availability schedule.
a spatial anchor having one or more specified subscriptions.
a spatial anchor having one or more specified access tokens, access control policies, and/or advertisement policies.

Step 2: Upon receiving the request to retrieve or discover context for spatial anchors, the XRM client may process the request by first checking whether the VAL client originating the request has permissions. This check may be performed by the XRM client checking that the VAL client ID specified in the request matches an ID specified in the access control privileges of the XRM client. The check may also be performed by checking whether a token specified in the request matches a token specified in the targets spatial anchor(s). The check may also include verifying the type of spatial anchor operation being performed (i.e., retrieval or discovery) is allowed and/or allowed at the current time and/or from the current location that the VAL client resides. If allowed, the XRM client processes the request. When processing the request, the XRM client may check whether the request includes filter criteria. If present, the XRM client may compare the specified filter criteria against context information within one or more spatial anchors stored locally by the XRM client. The XRM client may also send one or more requests to other entities in the network to retrieve or discover spatial anchors stored elsewhere in the network (e.g., stored within an XRM server, another XRM client, or a SEALDD data repository function). When comparing the filter criteria, the XRM client may determine whether any spatial anchor context information matches the specified filter criteria.

Step 3: If one or more spatial anchors are found to match the filter criteria, then representations of the spatial anchor(s) including information elements such as but not limited to those defined in Table 1 are returned in a response to the VAL client that originated the request. Alternatively, spatial anchor IDs (e.g., URIs) may be returned. Otherwise, an error indication is returned in the response indicating no spatial anchors matching the specified filter criteria were found.

### VAL Client Initiated Spatial Anchor Creation/Update

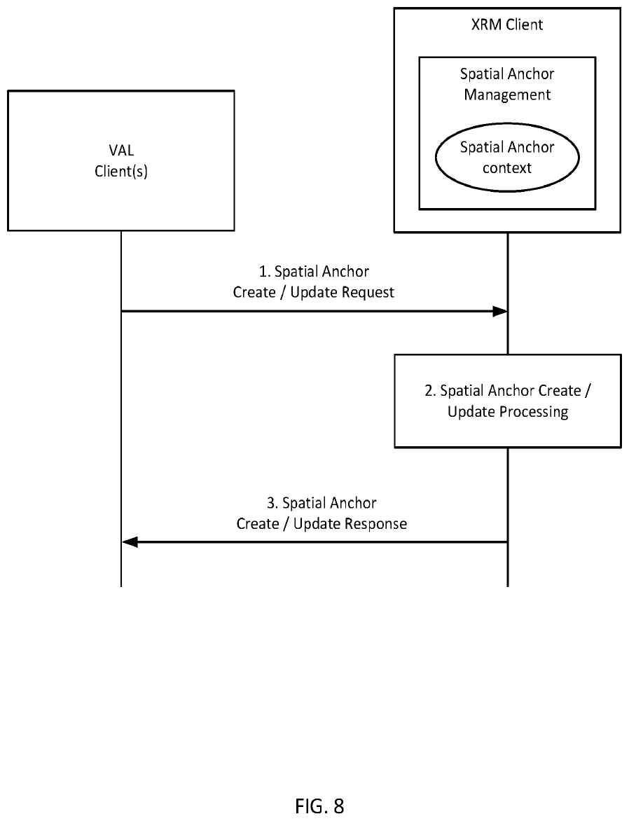

As shown in FIG. 8, a VAL client may create or update a spatial anchor by initiating a request to an XRM client. The creation or update of a spatial anchor may involve the exchange of spatial anchor context information as defined in Table 1 between the VAL client and XRM client.

Step 1: To create or update a spatial anchor, a VAL client may issue a spatial anchor create or update request to an XRM client. The request may include spatial anchor context information such as but not limited to the information elements defined in Table 1.

Step 2: Upon receiving the spatial anchor create or update request, the XRM client may process the request by first checking whether the VAL client originating the request has permissions to create or update the spatial anchor on the XRM client. This check may be performed in a similar manner a described in the aforementioned VAL client initiated spatial anchor discovery/retrieval procedure. If allowed, the XRM client creates or updates the spatial anchor context. When creating or updating the spatial anchor context, the XRM client may also perform one or more of the following operations based on spatial anchor context information contained within the request:
Assign a spatial anchor ID and/or address to the spatial anchor if one is not already assigned and/or included in the request.
Identify one or more spatial anchors associated with the received request. If a spatial anchor is being created and a spatial anchor ID is not specified in the request, then a new spatial anchor ID may be generated and assigned to the spatial anchor by the XRM client. If the spatial anchor(s) are being updated by the request, the spatial anchor context information in the request may be used to update one or more information elements of the existing spatial anchor(s) stored and managed locally by the XRM client or stored and managed by other functions in the network such as other XRM clients, XRM servers or SEALDD data repository functions.
Store the created or updated spatial anchor locally within the XRM client and/or elsewhere in the system such as but not limited to an XRM server, another XRM client or a SEALDD data repository function.
Based on information specified in the request (e.g., spatial anchor location, spatial anchor object ID), determine if the spatial anchor is to be anchored to a stationary/fixed location, orientation, and distance (e.g., location, orientation, and distance specified by the VAL client), or to an object that may move.
If a fixed location, orientation, and distance is specified in the request, the XRM client may use this information in the request to configure the spatial anchor with a fixed location, orientation, and distance.
If location, orientation, and distance information is not provided in the request, the XRM client may leverage information elements in the request such as an ID of an object that the spatial anchor is to be anchored to. Using this information, the XRM client may perform one or more operations to obtain the current location, orientation, and/or distance of the object as well as detect and track if/when the location, orientation, and/or distance of the object changes. The XRM client may store this location, orientation, and/or distance information within the spatial anchor and keep it updated if/when changes to location, orientation, or distance of the object are detected. To perform these types of operations, the XRM client may interface to an XRM server and/or query/subscribe to a location management server in the 3GPP system such as a SEAL location management server (e.g., using SEAL location client functionality supported by the XRM server). Alternatively, the XRM client may query the 3GPP core network (e.g., via the NEF location API) to a obtain the current location of a UE and/or subscribe to receive notifications if the future location of a UE changes.
Based on access control policies within the request and/or any local access control policies of the XRM client, the XRM client may configure the access control policies for the created spatial anchor.
Based on subscription information within the request and/or any local subscription policies of the XRM client, the XRM client may create and configure subscriptions to the spatial anchor.
Determine whether to enable the spatial anchor for access by other entities such as but not limited to, XRM clients, XRM servers, SEALDD clients, VAL clients and/or other VAL servers. This determination may be based on spatial anchor context information specified in the request such as an availability time window or schedule of the spatial anchor itself and/or of the VAL client associated with the spatial anchor. Alternatively, the XRM client may enable the spatial anchor when the spatial anchor is created and disable it when it is deleted.
After enabling the spatial anchor, the XRM client may update the spatial anchor status to reflect whether the spatial anchor is active or inactive.

Note, when performing the above operations, the XRM client may initiate one or more requests to functions or services in the 3GPP system such as but not limited to an XRM server, other XRM clients, SEAL clients and servers, SEALDD client and servers.

Step 3: Generate and return a spatial anchor create or update response to the VAL client that originated the request. The response may include but is not limited to one or more of the information elements defined in defined in Table 1 and/or a status code indicating whether the request was successfully processed.

### VAL Client Initiated Spatial Anchor Subscribe/Unsubscribe

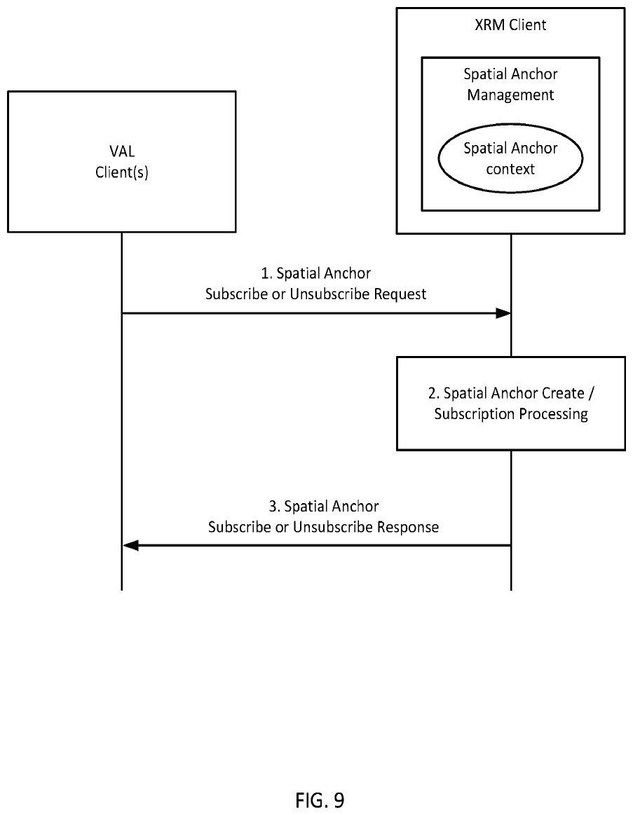

As shown in FIG. 9, a VAL client may initiate a request to an XRM client to subscribe to spatial anchor related events of interest to the VAL client which may be detected by the XRM client.

Step 1: A VAL client issues a spatial anchor subscription request to an XRM client, where the request may include but is not limited to one or more information elements defined in Table 1 (e.g., spatial anchor subscription information).

Step 2: Upon receiving the spatial anchor subscription request, the targeted XRM client may process the request by first checking whether the VAL client originating the request has permissions to subscribe to a spatial anchor on the XRM client. This check may be performed in a similar manner as described in the aforementioned VAL client initiated spatial anchor discovery/retrieval procedure. If allowed, the XRM client processes the request. When processing the request, the XRM client may begin to monitor the spatial anchor subscription criteria specified in the request to detect if/when the criteria has been met.

Note, when performing the above operations, the XRM client may initiate one or more requests to functions or services in the 3GPP system such as but not limited to an XRM server, other XRM clients, SEAL clients and servers, SEALDD client and servers.

Step 3: Generate and return a spatial anchor subscription response to the VAL client that originated the request. Where the response may include but is not limited one or more information elements defined in Table 1.

### VAL Client Initiated Spatial Anchor Content or Service Request

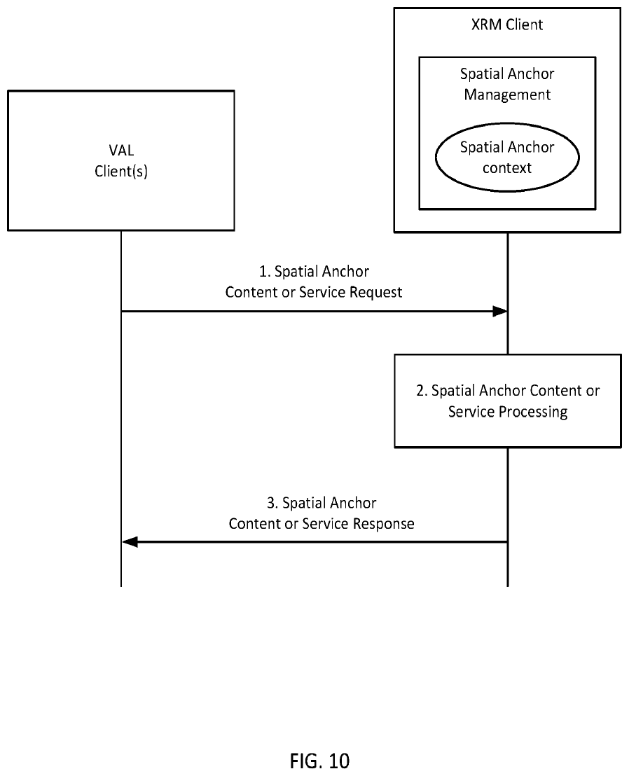

As shown in FIG. 10, a VAL client may initiate a request to an XRM client to access VAL content or services associated with a spatial anchor.

Step 1: A VAL client issues a request to an XRM client to access VAL content or services associated with a spatial anchor. The request may include but is not limited one or more information elements defined in Table 1 (e.g., spatial anchor ID, spatial anchor content link).

Step 2: Upon receiving the request to access content or services associated with a spatial anchor, the targeted XRM client may process the request by first checking whether the VAL client originating the request has permissions to access the content or services of the spatial anchor. This check may be performed in a similar manner a described in the aforementioned VAL client initiated spatial anchor discovery/retrieval procedure. If allowed, the XRM client processes the request. When processing the request, the XRM client may forward the request to a VAL client or VAL server to process (e.g., to retrieve VAL content from a VAL client or VAL server). Alternatively, the XRM client may service the request using VAL content stored within the targeted spatial anchor.

Note, when performing the above operations, the XRM client may initiate one or more requests to VAL servers, VAL clients, XRM servers, other XRM clients and other functions or services in the 3GPP system such as but not limited to SEAL clients and servers or SEALDD client and servers.

Step 3: Generate and return a response to the VAL client that originated the request. Where the response may include but is not limited to VAL content and/or the results of VAL services performed based on the request. The response may also include other information elements defined in Table 1.

### VAL Client Initiated Spatial Anchor Delete

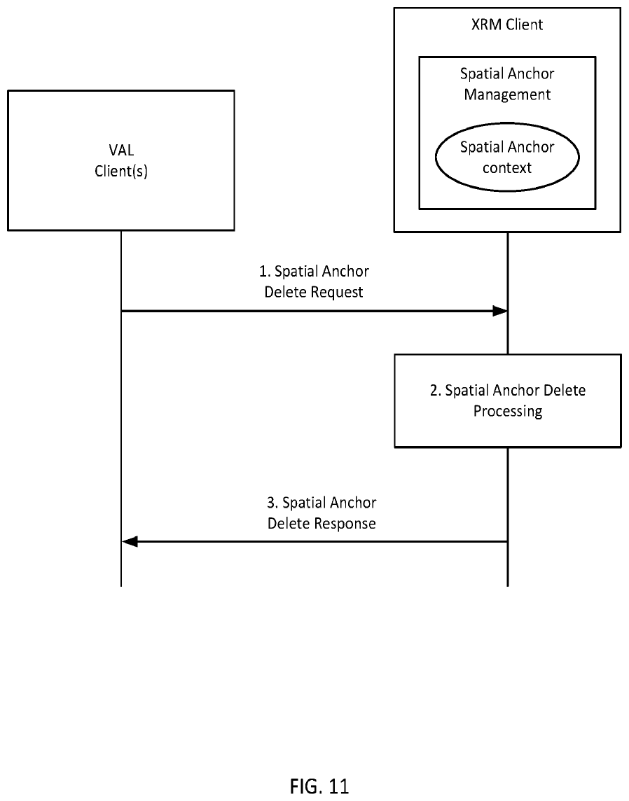

As shown in FIG. 11, a VAL client may initiate a request to an XRM client to delete a spatial anchor.

Step 1: A VAL client may delete a spatial anchor by issuing a spatial anchor delete request to an XRM client. The request may include but is not limited to one or more of the information elements defined in Table 1 (e.g., VAL client ID, spatial anchor ID).

Step 2: Upon receiving the spatial anchor delete request, the targeted XRM client may process the request by first checking whether the VAL client originating the request has permissions to delete a spatial anchor. This check may be performed in a similar manner a described in the aforementioned VAL client initiated spatial anchor discovery/retrieval procedure. If allowed, the XRM client processes the request. When processing the request, the XRM client may perform one or more of the following operations based on spatial anchor context information contained within the request or stored within the spatial anchor:
Delay processing of the delete request until the XRM client finishes any outstanding operations associated with the spatial anchor (e.g., notifications, retrieval, or discovery of the spatial anchor, etc.)
Trigger the tear-down of any underlying transports (PDU sessions, SEALDD flows) associated with the spatial anchor.
Delete any subscriptions associated with the spatial anchor and stop sending notifications to subscribers.
Notify subscribers (e.g., VAL servers) of the spatial anchor and subscriptions being deleted and that spatial anchor notifications associated with the spatial anchor will no longer be sent.
Reject any subsequent requests attempting to access the spatial anchor.
Delete any access control policies associated with the spatial anchor.
Delete any additional subscriptions or spatial anchor context that the XRM client created at other functions and services in the 3GPP system in order to service this spatial anchor (e.g., subscriptions to XRM server, other XRM clients, location management server, subscription to SEAL server, subscription to SEALDD server, etc.)

Note, when performing the above operations, the XRM client may initiate one or more requests to functions or services in the 3GPP system such as but not limited to an XRM server, other XRM clients, SEAL clients and servers, SEALDD client and servers.

Step 3: Generate and return a spatial anchor delete response to the VAL client that originated the request. Where the response may include but is not limited to information elements defined in Table 1.

### XRM Client Initiated Procedures

For each spatial anchor that an XRM client manages on behalf of a VAL client, the XRM client may create and store the spatial anchor context information locally on the XRM client. Alternatively, the XRM client may create and store the spatial anchor context information remotely at other functions or services in the 3GPP system. For example, the XRM client may create and store spatial anchor context information on an XRM server, a SEALDD data repository server, on a location management server, or on another XRM client in the network (e.g., an XRM client deployed on another UE). For cases where spatial anchor information is created and stored on another function or service, an XRM client may also initiate discover, retrieve, update, subscribe, unsubscribe, and delete spatial anchor operations to these entities. An XRM client may initiate these spatial anchor operations if/when it receives a corresponding spatial anchor operation from a VAL client, XRM server, or another XRM client. Alternatively, an XRM client may initiate these operations autonomously when detecting other types of events on spatial anchors.

### XRM Client Initiated XRM Discovery

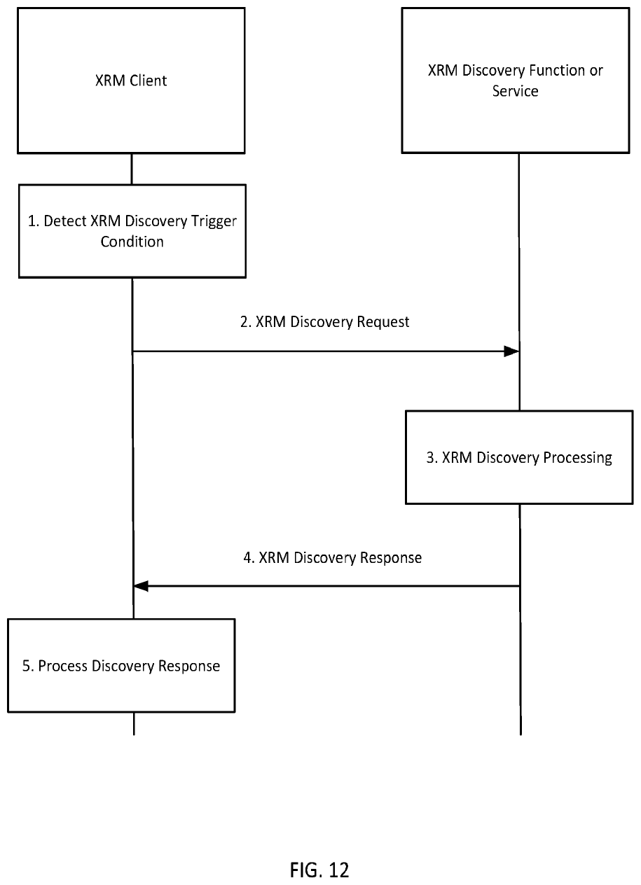

As shown in FIG. 12, an XRM client may issue an XRM discovery request to a function or service in the 3GPP system to obtain contact information for an XRM server and/or another XRM client. The XRM discovery function or service may be a dedicated function or service in the 3GPP system. Alternatively, it may be a capability of another function of service in the 3GPP system. For example, a DNS service, a SEAL service, a SEALDD service, an EDGEAPP service (e.g., ECS, EES, EEC). An XRM client or XRM server may also support a local XRM discovery capability. For example, a capability that supports multicasting or broadcasting XRM discovery information in a local subnet or receiving and responding to multi-casted or broadcasted XRM discovery requests in a local subnet.

Step 1: An XRM client detects a trigger condition to issue an XRM discovery request. Some possible triggers conditions may include but are not limited to receiving a request from a VAL client (e.g., an XRM registration request or a spatial anchor discovery, retrieval, create, update, subscribe, or delete request), detecting loss of connectivity or communication with an another XRM client or XRM server, or mobility/roaming scenarios resulting in a change of PLMN of EDN for the UE and XRM client.

Step 2: The XRM client sends an XRM discovery request. The request may comprise one or more XRM discovery criteria such as but not limited to types of XRM services required (e.g., spatial anchor services), required XRM service requirements and/or KPIs, XRM service schedule.

Step 3: The XRM discovery function or service processes the request by identifying XRM server(s) and/or XRM client(s) that match the specified discovery criteria.

Step 4: The XRM discovery function or service returns a discovery response to the XRM client. The response may include information regarding XRM server(s) and/or XRM client(s) that match the discovery criteria. The information may include one or more of the following attributes pertaining to the discovered XRM servers or XRM clients:
XRM server/client IDs,
XRM server/XRM client network addresses/contact information,
Types of XRM services supported,
XRM service KPIs supported,
XRM service schedules

Step 5: The XRM client receives and processes the response. Using the information contained in the response, the XRM client may select one or more XRM servers or XRM clients to register with in order to access the XRM services of these XRM servers or XRM clients.

### XRM Client Initiated XRM Registration/De-Registration

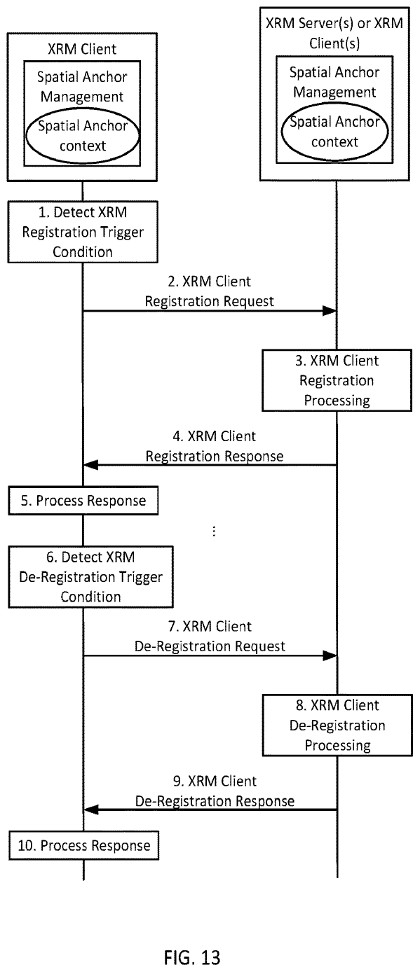

As shown in FIG. 13, an XRM client may issue an XRM registration or de-registration request to an XRM server and/or another XRM client.

Step 1: An XRM client detects a trigger condition to issue an XRM registration request. Some possible triggers conditions may include but are not limited to receiving a request from a VAL client (e.g., an XRM registration request or a spatial anchor discovery, retrieval, create, update, subscribe, or delete request), receiving an XRM discovery response comprising discovery information for one or more XRM servers or XRM clients, detecting loss of connectivity or communication with an another XRM client or XRM server, or mobility/roaming scenarios resulting in a change of PLMN of EDN for the UE and XRM client.

Step 2: The XRM client sends an XRM registration request to an XRM server or another XRM client. The request may comprise one or more information elements such as but not limited to an XRM client ID, security credentials to authenticate/authorize the XRM client, the types of XRM services required (e.g., spatial anchor services), the required XRM service requirements and/or KPIs, XRM service schedule.

Step 3: The targeted XRM server or client processes the request. The processing may include authenticating and authorizing the requesting XRM client to access the XRM services of the targeted XRM server or client by using the XRM ID and security credentials within the request. The processing may also include verifying whether the type(s) of XRM services required (e.g., spatial anchor services), the required XRM service requirements and/or KPIs, and the required XRM service schedule can be supported by the targeted XRM server or client.

Step 4: The targeted XRM server or client returns a registration response to the XRM client. The response may include an indication of whether the registration was successful or not. The response may also include information regarding one or more XRM services that the VAL client is permitted to access via the XRM client. The response may include schedule information regarding when the XRM server or client may be accessible. This information may include an XRM registration ID such as the ID of a registration resource or session created by the request. The response may also include XRM server/client API information such as API addresses (e.g., URIs or function handles) and API security credentials (e.g., keys or tokens), security credentials). The response may also include an XRM registration lifetime.

Step 5: The XRM client receives and processes the XRM registration response by storing the XRM registration ID, registration lifetime and XRM server/client API information such that it can be used for subsequent XRM operations initiated by the XRM client to the targeted XRM server or XRM client.

Step 6: The XRM client detects a trigger condition to issue an XRM de-registration request. Some possible triggers conditions may include but are not limited to receiving a request from a VAL client (e.g., an XRM de-registration request or a spatial anchor delete request), detecting a mobility/roaming scenario requiring a change of PLMN of EDN, discovering a different XRM server or XRM client having superior capabilities than an existing XRM server or XRM client, detecting that an XRM expiration timer is going to expire.

Step 7: The XRM client issues a de-registration request to a targeted XRM server or XRM client. The de-registration request may comprise information elements such as but not limited to the XRM registration ID which the XRM client received from the XRM registration process. The XRM client may also include an XRM client ID.

Step 8: Upon receiving the de-registration request from the XRM client, the targeted XRM server or XRM client may process the request. The processing may include the targeted XRM server or XRM client removing any XRM state locally stored for the XRM client. This XRM state may include spatial anchors and any associated spatial anchor context related to the XRM client. The targeted XRM server or XRM client may also initiate one or more requests to other functions and services in the 3GPP system to clean-up and remove any XRM state stored on these entities. For example, the targeted XRM server or XRM client may send a request to another XRM server or XRM client, and/or other types of functions or services.

Step 9: The targeted XRM server or XRM client may return an XRM de-registration response to the XRM client. The response may include information elements such as a status indicator whether the XRM de-registration was successful.

Step 10: The XRM client receives and processes the XRM de-registration response. If de-registration was successful, the XRM client may delete any locally stored XRM registration information (e.g., XRM registration ID, XRM server or client API information, or XRM server or client schedule information).

### XRM Client Initiated Spatial Anchor Advertisement

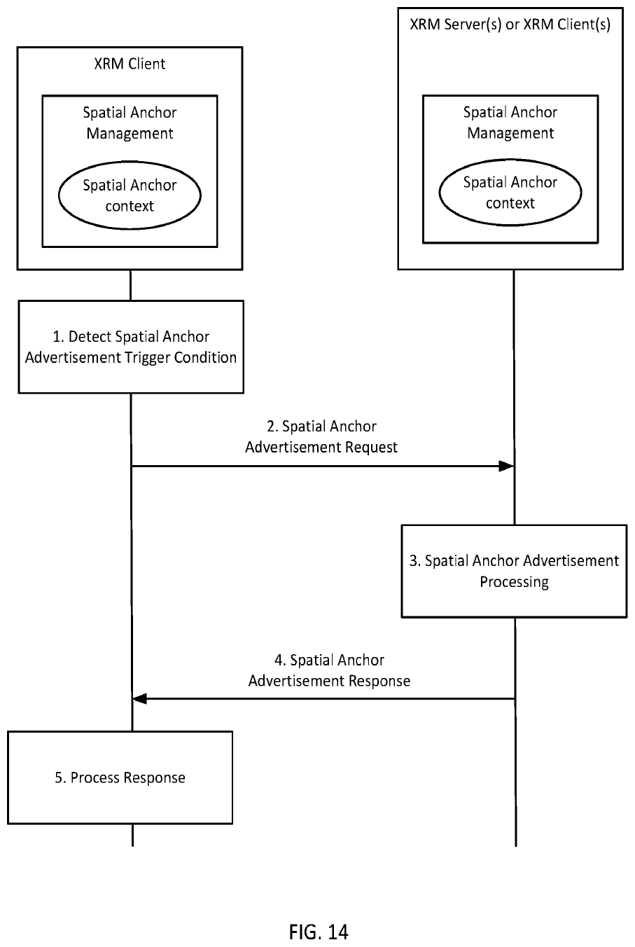

As shown in FIG. 14, an XRM client may issue a request to an XRM server and/or another XRM client to advertise a spatial anchor. For example, a XRM client may advertise a spatial anchor to other nearby XRM clients hosted on UEs in the local proximity of the XRM client.

Step 1: An XRM client may detect a trigger condition to issue a spatial anchor advertisement request. Some possible triggers conditions may include but are not limited to receiving a spatial anchor advertisement request from a VAL client, an XRM server or another XRM client.

Step 2: A XRM client may issue a request to an XRM server and/or another XRM client to advertise one or more spatial anchors. The request may include information elements such as but not limited to those defined in Table 1. In addition, the request may also include one or more of the following parameters:
An address of identifier of a targeted UE or a group of UEs
An address or identifier of a targeted VAL client or VAL server
An address or identifier of a targeted XRM client or XRM server

Step 3: Upon receiving the request advertise one or more spatial anchors, the targeted XRM server or XRM client may process the request by first checking whether the XRM client originating the request has permissions to advertise spatial anchors. This check may be performed by checking that the XRM client ID specified in the request matches an ID specified in the access control privileges of the targeted XRM server or XRM client. The check may also be performed by checking whether a token specified in the request matches a token specified in the targets spatial anchor(s). The check may also include verifying the type of spatial anchor operation being performed (i.e., advertisement) is allowed and/or allowed at the current time and/or from the current location that the XRM client resides. If allowed, the targeted XRM server or XRM client processes the request. When processing the request, the targeted XRM server or XRM client may also send one or more requests to other entities in the network to advertise spatial anchors to another XRM server, XRM client, or a SEALDD data repository function.

Step 4: The XRM client may receive the advertisement results. The results may include a status indicating whether the advertisement request was processed successfully. The results may also include the identifiers of the entities where the spatial anchor(s) were announced to.

Step 5: The XRM client may process the spatial anchor advertisement response. The processing of the response may include forwarding spatial anchor advertisement information within the response to a VAL client. The XRM client may also store spatial anchor advertisement information from the response and use this information when processing future spatial anchor operations.

### XRM Client Initiated Spatial Anchor Discovery/Retrieval

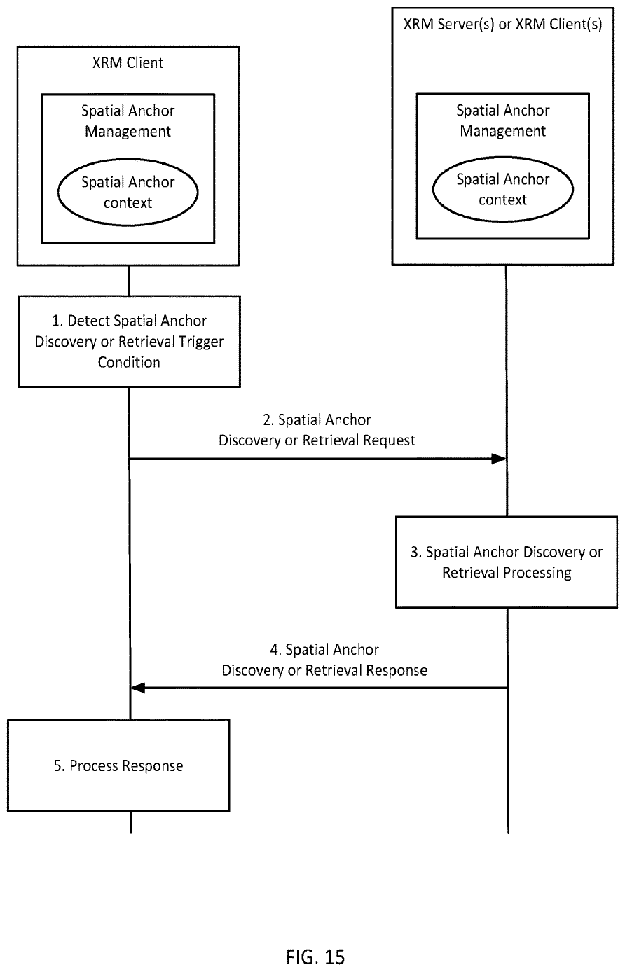

As shown in FIG. 15, an XRM client may issue a spatial anchor discovery or retrieval request to an XRM server and/or another XRM client.

Step 1: An XRM client may detect a trigger condition to issue a spatial anchor discovery or retrieval request. Some possible triggers conditions may include but are not limited to receiving a spatial anchor discovery, retrieval, create, update, subscribe, or delete request from a VAL client, an XRM server or another XRM client.

Step 2: An XRM client may issue a request to an XRM server or another XRM client to retrieve context for one or more spatial anchors. Alternatively, the retrieval request may be used to discover one or more spatial anchors that match one or more specified criteria. The request may include information elements such as but not limited to those defined in Table 1. In addition, the request may also include a spatial anchor discovery criteria. These criteria may include variables, operators and/or values. The variables may refer to spatial anchor context information elements such as but not limited to the information elements defined in Table 1. The operators may include but are not limited to operators such as =, !=, <, >, <=, >=. The values may include numbers, strings, or complex types. Some examples of criteria may include but are not limited to a spatial anchor having:
a spatial anchor associated with a specific VAL client ID, VAL server ID or VAL service ID.
a specific type or instance of a spatial anchor
a spatial anchor status of enabled or disabled.
a spatial anchor currently anchored to a specific object.
a spatial anchor within a certain location, orientation, and/or having a specific distance.
a spatial anchor enabled to track/detect changes in location, orientation, or distance of an object to which it is anchored to.
a spatial anchor capable of performing ranging and detecting UEs in range of the spatial anchor.
a spatial anchor having a particular type of linked or stored digital content.
a spatial anchor associated with a VAL client or VAL server having a specified VAL availability schedule.
a spatial anchor having a status that is active or inactive and/or having a specified availability schedule.
a spatial anchor having one or more specified subscriptions.
a spatial anchor having one or more specified access tokens, access control policies, and/or advertisement policies.

Step 3: Upon receiving the request to retrieve or discover context for spatial anchors, the targeted XRM server or XRM client may process the request by first checking whether the XRM client originating the request has permissions to retrieve or discover spatial anchors. This check may be performed by checking that the XRM client ID specified in the request matches an ID specified in the access control privileges of the targeted XRM server or XRM client. The check may also be performed by checking whether a token specified in the request matches a token specified in the targets spatial anchor(s). The check may also include verifying the type of spatial anchor operation being performed (i.e., retrieval or discovery) is allowed and/or allowed at the current time and/or from the current location that the XRM client resides. If allowed, the targeted XRM server or XRM client processes the request. When processing the request, the targeted XRM server or XRM client may check whether the request includes filter criteria. If present, the targeted XRM server or XRM client may compare the specified filter criteria against context information within one or more spatial anchors stored locally by the targeted XRM server or XRM client. The targeted XRM server or XRM client may also send one or more requests to other entities in the network to retrieve or discover spatial anchors stored elsewhere in the network (e.g., stored within another XRM server, another XRM client, or a SEALDD data repository function). When comparing the filter criteria, the targeted XRM server or XRM client may determine whether any spatial anchor context information matches the specified filter criteria.

Step 4: If one or more spatial anchors are found to match the filter criteria, then representations of the spatial anchor(s) including information elements such as but not limited to those defined in Table 1 may be returned in a response to the XRM client that originated the request. Alternatively, spatial anchor IDs (e.g., URIs) may be returned. Otherwise, an error indication may be returned in the response indicating no spatial anchors matching the specified filter criteria were found.

Step 5: The XRM client receives and processes the spatial anchor retrieve or discovery response. The processing of the response may include forwarding spatial anchor context information within the response to a VAL client. The XRM client may also store spatial anchor context information from the response and use this information when processing future spatial anchor operations.

### XRM Client Initiated Spatial Anchor Creation/Update

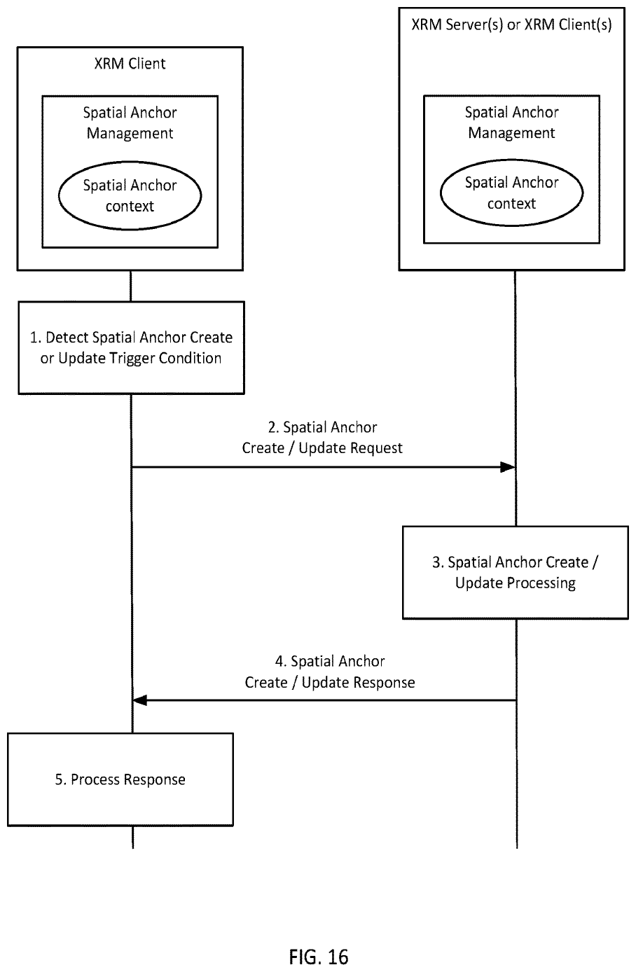

As shown in FIG. 16, an XRM client may issue a spatial anchor create or update request to an XRM server and/or another XRM client.

Step 1: An XRM client may detect a trigger condition to issue a spatial anchor create or update request. Some possible triggers conditions may include but are not limited to receiving a spatial anchor create or update request from a VAL client, an XRM server or another XRM client.

Step 2: The XRM client may issue a spatial anchor create or update request to an XRM server or another XRM client. The request may include spatial anchor context information such as but not limited to the information elements defined in Table 1.

Step 3: Upon receiving the request to retrieve or discover context for spatial anchors, the targeted XRM server or XRM client may process the request by first checking whether the XRM client originating the request has permissions to create or update spatial anchors. This check may be performed in a similar manner a described in the aforementioned XRM client initiated spatial anchor discovery/retrieval procedure. If allowed, the targeted XRM server or XRM client processes the request. When processing the request, the targeted XRM server or XRM client may create a new spatial anchor if one does not already exist, or update and existing spatial anchor if the request includes a spatial anchor ID and it matches an existing spatial anchor on the targeted XRM server or XRM client. The targeted XRM server or XRM client may also send one or more requests to other entities in the network to create or update spatial anchors elsewhere in the network. For example, an XRM client may create a spatial anchor on an XRM server in the network. The spatial anchor created on an XRM server may be a copy of the spatial anchor maintained on an XRM client.

When creating or updating the spatial anchor context, the targeted XRM server or XRM client may also perform one or more of the following operations based on spatial anchor context information contained within the request:
Assign a spatial anchor ID and/or address to the spatial anchor if one is not already assigned and/or included in the request.
Identify one or more spatial anchors associated with the received request. If a spatial anchor is being created and a spatial anchor ID is not specified in the request, then a new spatial anchor ID may be generated and assigned to the spatial anchor by the targeted XRM server or XRM client. If the spatial anchor(s) are being updated by the request, the spatial anchor context information in the request may be used to update one or more information elements of the existing spatial anchor(s) stored and managed locally by the targeted XRM server or XRM client or stored and managed by other functions in the network such as other XRM clients, XRM servers or SEALDD data repository functions.
Store the created or updated spatial anchor locally within the targeted XRM server or XRM client and/or elsewhere in the system such as but not limited to another XRM server, another XRM client or a SEALDD data repository function.
Based on information specified in the request (e.g., spatial anchor location, spatial anchor object ID), determine if the spatial anchor is to be anchored to a stationary/fixed location, orientation, and distance (e.g., location, orientation, and distance specified by the XRM client), or to an object that may move.
If a fixed location, orientation, and distance is specified in the request, the targeted XRM server or XRM client may use this information in the request to configure the spatial anchor with a fixed location, orientation, and distance.
If location, orientation, and distance information is not provided in the request, the targeted XRM server or XRM client may leverage information elements in the request such as an ID of an object that the spatial anchor is to be anchored to. Using this information, the targeted XRM server or XRM client may perform one or more operations to obtain the current location, orientation, and/or distance of the object as well as detect and track if/when the location, orientation, and/or distance of the object changes. The targeted XRM server or XRM client may store this location, orientation, and/or distance information within the spatial anchor and keep it updated if/when changes to location, orientation, or distance of the object are detected. To perform these types of operations, the targeted XRM server or XRM client may interface to another XRM server or XRM client and/or query/subscribe to a location management server in the 3GPP system such as a SEAL location management server (e.g., using SEAL location client functionality supported by the XRM server). Alternatively, the targeted XRM server or XRM client may query the 3GPP core network (e.g., via the NEF location API) to a obtain the current location of a UE and/or subscribe to receive notifications if the future location of a UE changes.
Based on access control policies within the request and/or any local access control policies of the targeted XRM server or XRM client, the targeted XRM server or XRM client may configure the access control policies for the created spatial anchor.
Based on subscription information within the request and/or any local subscription policies of the targeted XRM server or XRM client, the targeted XRM server or XRM client may create and configure subscriptions to the spatial anchor.
Determine whether to enable the spatial anchor for access by other entities such as but not limited to, XRM clients, XRM servers, SEALDD clients, VAL clients and/or other VAL servers. This determination may be based on spatial anchor context information specified in the request such as an availability time window or schedule of the spatial anchor itself and/or of the XRM client associated with the spatial anchor. Alternatively, the targeted XRM server or XRM client may enable the spatial anchor when the spatial anchor is created and disable it when it is deleted.
After enabling the spatial anchor, the targeted XRM server or XRM client may update the spatial anchor status to reflect whether the spatial anchor is active or inactive.

Note, when performing the above operations, the targeted XRM server or XRM client may initiate one or more requests to functions or services in the 3GPP system such as but not limited to another XRM server, another XRM client, SEAL client or server, SEALDD client or server.

Step 4: Generate and return a spatial anchor create or update response to the XRM client that originated the request. Where the response may include but is not limited to one or more of the information elements defined in defined in Table 1 and/or a status code indicating whether the request was successfully processed.

Step 5: The XRM client receives and processes the spatial anchor create or update response. The processing of the response may include forwarding spatial anchor context information within the response to a VAL client. The XRM client may also store spatial anchor context information from the response and use this information when processing future spatial anchor operations.

### XRM Client Initiated Spatial Anchor Subscribe/Unsubscribe

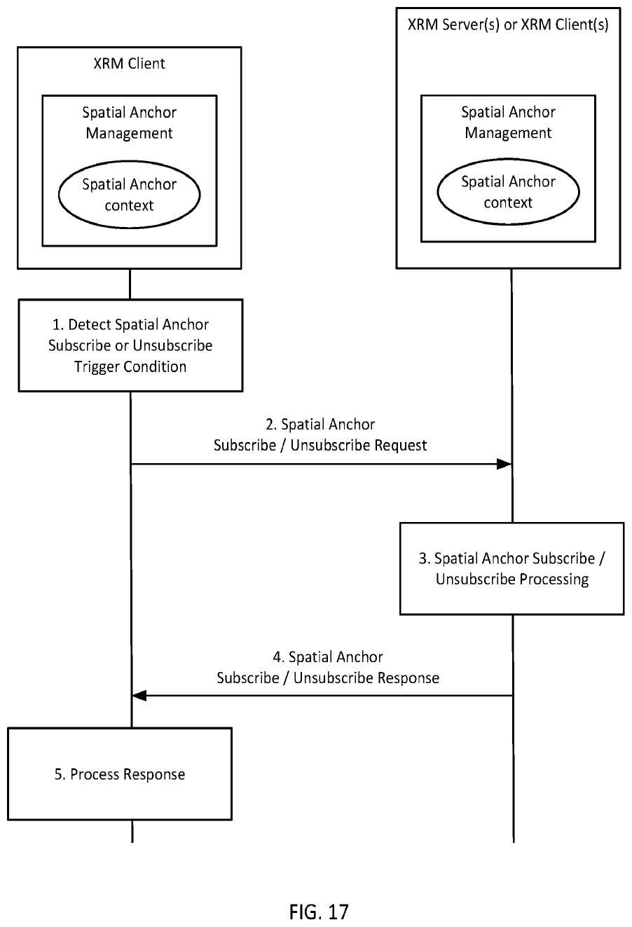

As shown in FIG. 17, an XRM client may issue a spatial anchor subscribe or unsubscribe request to an XRM server and/or another XRM client.

Step 1: An XRM client may detect a trigger condition to issue a spatial anchor subscribe or unsubscribe request. Some possible triggers conditions may include but are not limited to receiving a spatial anchor subscribe or unsubscribe request from a VAL client, an XRM server or another XRM client.

Step 2: The XRM client may issue a spatial anchor subscribe or unsubscribe request to an XRM server or another XRM client. The request may include spatial anchor context information such as but not limited to the information elements defined in Table 1 (e.g., spatial anchor subscription information).

Step 3: Upon receiving the request to subscribe or unsubscribe to spatial anchors, the targeted XRM server or XRM client may process the request by first checking whether the XRM client originating the request has permissions to create or update spatial anchors. This check may be performed in a similar manner a described in the aforementioned XRM client initiated spatial anchor discovery/retrieval procedure. If allowed, the targeted XRM server or XRM client processes the request. When processing a subscribe request, the targeted XRM server or XRM client may create a new spatial anchor subscription if one does not already exist, or update and existing spatial anchor if the request includes a spatial anchor subscription ID and it matches an existing spatial anchor subscription on the targeted XRM server or XRM client. When processing a unsubscribe request, the targeted XRM server or XRM client may delete spatial anchor subscription if the request includes a spatial anchor subscription ID and it matches an existing spatial anchor subscription on the targeted XRM server or XRM client. The targeted XRM server or XRM client may also send one or more requests to other entities in the network to subscribe or unsubscribe to spatial anchors elsewhere in the network. For example, an XRM client may subscribe to a spatial anchor on an XRM server in the network.

Step 4: The targeted XRM server or XRM client may generate and return a spatial anchor subscription response to the VAL client that originated the request. Where the response may include but is not limited one or more information elements defined in Table 1 (e.g., spatial anchor subscription ID).

Step 5: The XRM client may receive and processes the spatial anchor subscribe or unsubscribe response. The processing of the response may include forwarding spatial anchor subscription information within the response to a VAL client. The XRM client may also store spatial anchor subscription information from the response and use this information when processing future spatial anchor operations.

### XRM Client Initiated Spatial Anchor Anchoring

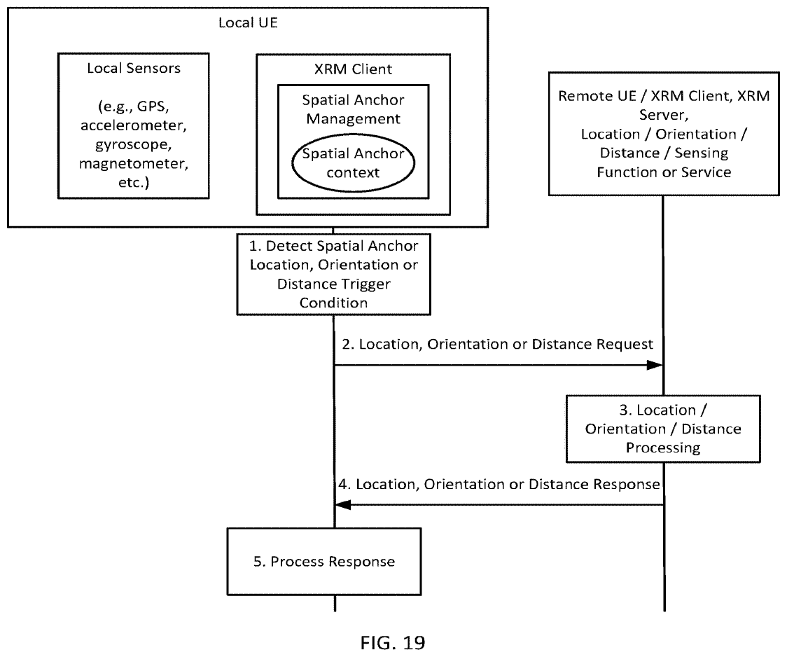

As shown in FIG. 19, for each spatial anchor that an XRM client manages on behalf of a VAL client or an XRM server, the XRM client may perform anchoring operations to associate a spatial anchor to the local UE hosting the XRM client, another nearby UE, or a nearby passive object (e.g., a piece of furniture in a room) whose location, orientation, and distance can be determined by either the local UE or another nearby UE.

Whether or not an XRM client performs anchoring operations for a given spatial anchor may be determined by one or more information elements configured within the spatial anchor. For example, an indicator such as the “Spatial anchor object ID” information element proposed in Table 1 may be used by the XRM client to determine whether and which UE or object a spatial anchor should be anchored to. After determining anchoring of a spatial anchor to UE or object is required, the XRM client may collect and monitor location, orientation, and/or distance information of the UE or object for which the spatial anchor is anchored to.

Once a spatial anchor is anchored, the XRM client may then keep the location, orientation, and distance of the spatial anchor updated with any changes to the location, orientation, and distance of the UE or object it is anchored to. For example, if/when the XRM client detects changes to either the location, orientation, or distance of the anchored UE or object, the XRM client can keep the location, orientation, and/or distance of the spatial anchor synchronized and updated. This synchronized location information can in turn be used to enable ranging operations to be performed between the UE or object which the spatial anchor is anchored to and other UEs and objects which may enter and leave the vicinity of the spatial anchor. For example, range calculations can be performed between spatial anchors anchored to store fronts in a mall and customers walking through the mall and carrying their UEs (i.e., phones).

Step 1: An XRM client detects a trigger condition for initiating a spatial anchor anchoring operation. For example, an XRM client may initiate spatial anchor anchoring operations if/when it receives a corresponding spatial anchor operation from a VAL client (e.g., creation or update of a spatial anchor). Alternatively, an XRM client may initiate these operations autonomously when detecting one or more types of events defined by a local policy.

Step 2: Using spatial anchor context information (e.g., spatial anchor object ID), the XRM client may determine a UE or object to anchor a spatial anchor to. If the specified spatial anchor object ID matches the ID of the UE upon which the XRM client is hosted, then the XRM client may anchor the spatial anchor to the local UE. If the specified spatial anchor object ID matches the ID of object in the local proximity of the UE the XRM client is hosted, then the XRM client may perform one or more operations to anchor the object to the spatial anchor such as discover the object and its location, orientation, and/or distance. To perform these operations, the XRM client may rely on local sensors on its local UE as described in the Client Initiated Spatial Anchor Location/Orientation/Distance procedure (e.g., to measure the location, orientation, and/or distance of the object with respect to the local UE). If the specified spatial anchor object ID matches the ID of another UE or an object associated with another UE, the XRM may perform one or more operations such as UE discovery and/or XRM discovery operations. The XRM client may also send a spatial anchor anchoring request to the other UE. This request may include one or more spatial anchor information elements defined in Table 1. The other UE may or may not support an XRM client.

Step 3: Upon receiving the anchoring request, the other UE may process the request by first checking whether the UE and/or XRM client originating the request has permissions to perform the anchoring operation. If allowed, the request may be processed by the other UE. To process this request, the UE may collect location, orientation, and/or distance information of the UE itself, or an object in the vicinity of the UE. The UE may use local sensors to measure the location or position of an object in its vicinity.

Step 4: The other UE may generate and return a spatial anchor anchoring response to the XRM client. The response may include a status indicating whether the anchoring operation was performed successfully and/or the current location, orientation, and/or distance of the UE or object anchored to the spatial anchor.

Step 5: Upon receiving a response, the XRM client may perform additional spatial anchor operations such as subscribing to receive location, orientation, and/or distance updates from the other UE, updating spatial anchor context information with the location, orientation, and distance of the UE or object the spatial anchor is anchored to, generating notifications to other entities in the 3GPP system (e.g., VAL client, XRM server, other XRM clients) regarding updates to the spatial anchor's location or distance based on changes to the location, orientation, or distance of the UE or object that the spatial anchor is anchored to, or perform additional spatial anchor operations such as spatial anchor ranging operations defined in the XRM Client Initiated Spatial Ranging procedure.

### XRM Client Initiated Spatial Anchor Location/Orientation/Distance

An XRM client may perform spatial anchor location, orientation, and/or distance management operations. The location, orientation, and/or distance management operations may include identifying the current or expected location, orientation, or distance of a spatial anchor, an object anchored to a spatial anchor, and/or objects that come into the proximity of a spatial anchor (e.g., UEs).

An XRM client may leverage local sensors available on the same UE as the XRM client when performing location, orientation, and/or distance management operations. For example, global positioning system (GPS), accelerometer, gyroscope or magnetometer sensors can be used by an XRM client to detect the location, orientation, and distance of the UE upon which the XRM client is hosted. If a spatial anchor is anchored to the local UE, then the XRM client can leverage these local sensors to track the location, orientation, and distance of this spatial anchor.

If a spatial anchor is not anchored to the local UE, then an XRM client may leverage remote sensors available on one or more other UEs located within the vicinity of the XRM client UE to collect location, orientation, and distance information. For example if a spatial anchor is anchored to another UE, an XRM client may request location, orientation, and distance information from this other UE. The other UE may leverage its local sensors to collect location, orientation, and distance information which it then shares with the XRM client. The other UE may also support XRM client functionality to enable the sharing and exchange of this information.

Instead of (or in addition to) relying on local/remote UE sensors to collect location, orientation, and distance information, an XRM client may collect location, orientation, and distance information from other functions or services in the 3GPP system. For example, an XRM client may retrieve and/or subscribe to receive location, orientation, and/or distance notifications from an XRM server, a core network function, or a location management server in the network. The location, orientation, or distance information provided by these entities may pertain to the local UE upon which the XRM client is hosted, or other UEs in the vicinity of the XRM client.

An XRM client may use information elements configured within a spatial anchor to control how the XRM client performs location, orientation, and/or distance management for a given spatial anchor. For example, the spatial anchor location, orientation, and location requirements such as those defined in Table 1 may be used by the XRM client to determine precision, type and/or format of location, orientation, and distance information collected and/or stored by the XRM client for a given spatial anchor. Based on these requirements, the XRM client may determine the type of location, orientation, and/or distance sensors, functions and/or services it determines to use when collecting location and distance information. For example, the requirements may determine the frequency the XRM client interacts with these sensors and/or the functions and services to meet the location, orientation, and/or distance requirements of the spatial anchor.

When generating or collecting location, orientation, and/or distance information for a spatial anchor, the XRM client may store this location, orientation, and/or distance information within a spatial anchor maintained locally by the XRM client. The XRM client may share location, orientation, and distance information with other entities in the 3GPP system. For example, an XRM client may share location, orientation, and distance information with an XRM server, other XRM clients, VAL clients, VAL servers, core network functions, SEAL client or server, SEALDD client or server. An XRM client may share location, orientation, or distance information with these entities using mechanisms such as sending spatial anchor notifications to these entities, allowing these entities to retrieve this information from the XRM client, or sending spatial anchor update requests to these other entities to update spatial anchors stored remotely on these entities.

Whether or not an XRM client performs location, orientation, and/or distance management operations (for a given spatial anchor, object anchored to the spatial anchor, or UEs in proximity of spatial anchors) may be determined by one or more information elements configured within a spatial anchor. For example, a spatial anchor indicator used to enable/disable spatial anchor tracking may be used by an XRM client to determine whether or not to collect and track location, orientation, and/or distance information for a spatial anchor.

Step 1: An XRM client detects a trigger condition for initiating a spatial anchor location, orientation, and/or distance operation. The XRM client may collect location, orientation, or distance information using local sensors located on the same UE as the XRM client. Alternatively, the XRM client may collect location, orientation, or distance information from other UEs and/or functions or services in the 3GPP system. Some example of trigger conditions may be a request for location, orientation, or distance information which the XRM client receives from a VAL client or another XRM client. Alternatively, an XRM client may initiate these operations autonomously when detecting one or more types of events such as a time duration has elapsed since the XRM client has collected the last location, orientation, or distance update for a spatial anchor.

Step 2: The XRM client sends one or more spatial anchor location, orientation, or distance requests to one or more entities in a 3GPP system such as but not limited to an XRM server, another XRM client, SEALD client/server, SEALDD client/server. One type of operation may include sending a request to discover and/or retrieve an updated location, orientation, and/or distance of a spatial anchor, an object anchored to a spatial anchor, and/or UE(s) in the proximity of a spatial anchor. Another type of operation may include sending a request to subscribe to receive location, orientation, and/or distance updates for a spatial anchor, an object anchored to a spatial anchor, and/or UE(s) in the proximity of a spatial anchor if/when specified criteria have been met. For example, a specified time period has elapsed since last location, orientation, and/or distance update, a spatial anchor, an object anchored to a spatial anchor, and/or UE(s) in the proximity of a spatial anchor has moved more than a specified distance or changed its distance by more than a specified threshold. The requests may also include one or more of the following information elements:
Identifier(s) of a spatial anchor, an object anchored to a spatial anchor, and/or UE(s) in the proximity of a spatial anchor.
The current or last known location(s), orientation(s) and/or distance of a spatial anchor, an object anchored to a spatial anchor, and/or UE(s)
Location, orientation, and/or distance requirements of the spatial anchor defining the location precision, format, and/or dimensionality required for location information returned for the UE.

Step 3: Upon receiving the location, orientation, and/or distance request, the function or service may process the request by first checking whether the XRM client originating the request has permissions to perform the spatial anchor location, orientation, and/or distance operation. If allowed, the request is processed. When processing the request, the function or service may return location, orientation, and/or distance information for a spatial anchor, an object anchored to a spatial anchor, and/or object(s)/UE(s) in the proximity of a spatial anchor. If the operation is a subscribe operation, the function or service may create a subscription and begin monitoring for any location, orientation, or distance criteria specified in the subscription.

Step 4: The function or service generates and returns a spatial anchor location, orientation, and/or distance response to the XRM client that originated the request. Where the response may include but is not limited to a location, orientation, and/or distance of the spatial anchor, an object anchored to the spatial anchor, and/or object(s)/UE(s) in the proximity of the spatial anchor. The location, orientation, and/or distance of an object anchored to the spatial anchor, and/or object(s)/UE(s) in the proximity of the spatial anchor may be provided in an absolute format which is independent of the location, orientation, and distance of the spatial anchor. Alternatively, it may be provided in relative format that is relative to the location, orientation, and/or distance of the specified spatial anchor.

Step 5: Upon receiving a spatial anchor location, orientation, and/or distance response, the XRM client may perform additional spatial anchor operations such as update the spatial anchor context information, generate notifications to other entities in the 3GPP system (e.g., VAL clients, UEs, etc.), perform additional spatial anchor operations (e.g., ranging operations).

### XRM Client Initiated Spatial Anchor Ranging

The XRM client may perform ranging operations to detect if/when objects (e.g., 3GPP devices/UEs, non-3GPP devices, passive objects not having network connectivity) are within the service area range limits of a spatial anchor. Ranging operations performed by an XRM client may include identifying the current location, orientation, and/or distance of a spatial anchor and detecting if/when the location, orientation, and/or distance of other objects in the vicinity of the spatial anchor meet the service area limits and requirements of the spatial anchor. For example, whether a mobile UE comes within a specified distance (e.g., within 100 ft) of a spatial anchor and is within a certain distance from the spatial anchor (e.g., headed in a direction that is moving towards the spatial anchor).

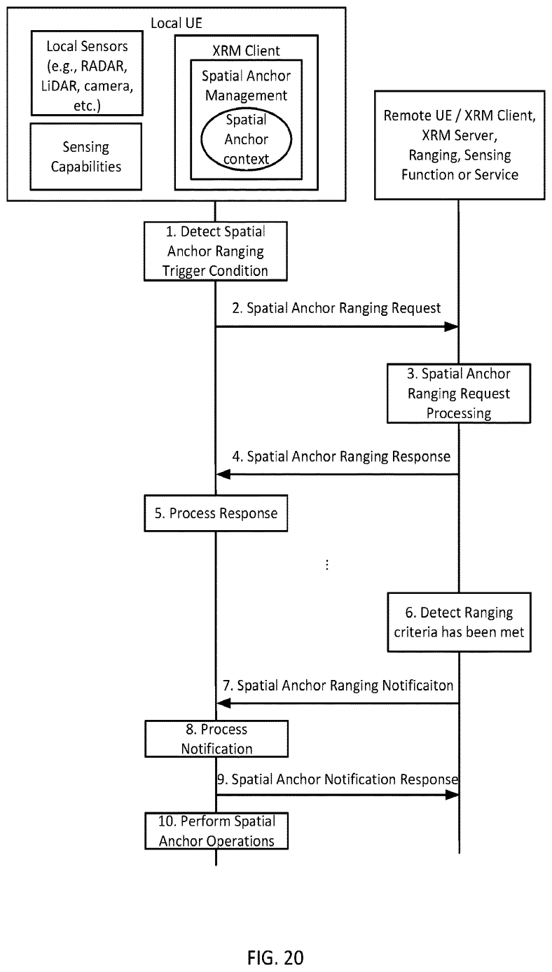

To perform these ranging operations, the XRM client may rely on information collected from local sensing capabilities and/or sensors resident on the same UE as the XRM client, sensing capabilities and/or sensors located on remote UEs, and/or functions or services within the 3GPP system (e.g., ranging and/or sensing functions in the network). As shown in FIG. 19, the XRM client may collect location, orientation, and/or distance centric information using local sensing capabilities and/or sensors such as global positioning system (GPS), accelerometer, gyroscope, or magnetometer sensors. In addition, the XRM client may collect ranging centric information using sensing capabilities and/or sensors such as RADAR, LiDAR, and optics (cameras) as shown in FIG. 20. The XRM client may leverage one or more of these types of measurements to determine if/when objects are within the service area of a spatial anchor.

A spatial anchor may be anchored to the local UE which hosts the XRM client. For example, a VAL client on the UE may provide content or services associated with a spatial anchor. In this case, an XRM client may keep the location, orientation, and distance of the spatial anchor synchronized with the location, orientation, and distance of the local UE. The XRM client may also use sensing capabilities and/or sensors locally hosted on the local UE to perform ranging operations to calculate the distance and distance of other objects with respect to the spatial anchor anchored to the XRM client's UE. For example, the XRM client may detect the location, orientation, and distance of other nearby UEs and/or objects and compare these to the location, orientation, and distance of its local UE to determine a range between nearby UEs and/or objects and the spatial anchor. The XRM client may then compare this range against the service area range of the spatial anchor anchored to the UE to determine whether any objects are within the specified service area range limits of the spatial anchor.

The XRM client may also perform additional operations to determine if nearby UEs and/or objects detected to be within the service area range of the spatial anchor should be notified and made aware of the spatial anchor. The XRM client may collect additional forms of information regarding nearby UEs and/or objects such as the identifiers (UE IDs, VAL client IDs, VAL service IDs, XRM client IDs), types of spatial anchors of interest. The XRM client may collect this information by sending one or more requests to XRM server(s) and/or other XRM client(s). The XRM client may also use information stored in the spatial anchor such as one or more of the information element defined in Table 1 to make this determination. For example, information elements such as spatial anchor access control policies.

A spatial anchor may be anchored to another object other than the UE which hosts the XRM client. For example, a spatial anchor may be anchored to another UE (not having XRM client capabilities) or a passive object not having network connectivity (e.g., a product on a store shelf). In this case, the XRM client may track the location, orientation, and distance of this other UE or a passive object to which the spatial anchor is anchored to. The XRM client may then keep the location, orientation, and distance of the spatial anchor updated with this tracked location, orientation, and distance. In addition, the XRM client may also detect the location, orientation, and distance of other nearby UEs and/or passive objects and compare them to the location, orientation, and distance of the spatial anchor which it is tracking. The XRM client may use sensing capabilities and/or sensors locally hosted on its UE to detect the locations, orientations, and distance of other UEs and passive objects. The XRM client may also communicate with other UEs to leverage the sensing capabilities and/or sensors on these remote UEs to collect ranging measurements which the XRM client may use. The XRM client may also interact with other functions or services in the 3GPP system to collect sensing and/or ranging measurements as shown in FIG. 19. For example, an XRM client may retrieve and/or subscribe to receive sensing and/or ranging notifications from other XRM clients, XRM servers, or one or more other functions or services in the 3GPP system such as a core network function, ranging function, sensing function or a location management server supporting ranging and/or sensing capabilities.

Based on these measurements, the XRM client may then determine the ranges between the spatial anchor and nearby UEs and/or passive objects. The XRM client may then determine whether any UEs and/or passive objects are within the specified service area range limits of the spatial anchor. If so, the XRM client may trigger an event and may send a notification to other entities in the 3GPP system (e.g. to an XRM server).

Step 1: An XRM client detects a trigger condition for initiating a spatial anchor ranging operation. The operations may be performed locally (e.g., using local sensing capabilities and/or sensors). Alternatively, the XRM client may interface with other UEs, functions, or services in the 3GPP system to assist it with performing ranging measurements. Trigger conditions for performing the ranging operations may be if/when it receives a spatial anchor operation from a VAL client (e.g., to create a spatial anchor), XRM server or another XRM client. Alternatively, an XRM client may initiate these operations autonomously when detecting one or more types of events such as the XRM client receiving location, orientation, and/or distance information for UE(s).

Step 2: The XRM client may send one or more requests to get ranging information from one or more UEs, functions, or services in the 3GPP system. The XRM client may then use this ranging information to determine whether any UEs or objects are within the range of a spatial anchor. The request may retrieve ranging information from these other entities. Alternatively, the request may include sending a subscription to receive ranging notifications from these other entities if/when specified ranging criteria have been met. For example, an XRM client may specify ranging criteria such as a certain distance and/or certain distance that an object must have with respect to a reference location, orientation, or distance. This reference location, orientation, or distance may be the current location, orientation, and distance of a spatial anchor which the XRM client is managing. The ranging criteria may be the service area range limits of the spatial anchor which the XRM client is managing. For example, an object must be within a range of 300 feet of the spatial anchor and must be headed in a direction towards the spatial anchor and with a particular angle of arrival. A ranging request may also include ranging requirements of the spatial anchor such as the location precision, format, and/or dimensionality required for location information returned for the UE.

Step 3: Upon receiving the spatial anchor ranging request, the other UE, function, or service may process the request by first checking whether the XRM client originating the request has permissions to perform the spatial anchor ranging operation. If allowed, the request may be processed. When processing the request, the other UE, function, or service may return ranging information. If the operation is a subscribe operation, the function or service may create a subscription and begin monitoring to detect if/when any ranging criteria specified in the subscription has been met.

Step 4: A ranging response may be returned to the XRM client that originated the request. The ranging information within the response may include but is not limited to a distance of one or more objects. This distance may be relative to the location of a spatial anchor managed by the XRM client. The response may also include an indication whether the location, orientation, and/or distance of the object meets the service area range limits and requirements of the spatial anchor.

Step 5: The XRM client receives and processes the ranging response. Based on the response, the XRM client may perform one more additional operations. For example, if an indication is not already provided in the response, the XRM client may use the information in the response to detect if the spatial anchor service area range limits or requirements have been met for any objects in the proximity of a spatial anchor. If XRM client detects an object that satisfies the range limits of the spatial anchor, it may notify other entities in the 3GPP system such as but not limited to a VAL client, VAL server, or XRM server (if these entities have requested to be notified of such events).

Step 6: If the XRM client subscribes to receive ranging information from another UE, function, or service in the 3GPP system, and if the ranging criteria specified in this subscription is met, then a notification may be sent to the XRM client. For example, the function or service may initiate notifications to an XRM client if/when it detects a change in a UE's location, orientation, or distance which meets the ranging limits/requirements specified in the ranging subscription criteria specified by the XRM client.

Step 7: The ranging function or service sends one or more spatial anchor ranging notifications to the XRM client. Within a notification, the function or service may include ranging information for one or more objects or UEs relative to a spatial anchor. The notification may also include an indication that the location, orientation, and/or distance of the object or UE meets (or no longer meets) the service area range limits and requirements of the spatial anchor.

Step 8: Upon receiving the spatial anchor ranging notification, the XRM client may process the notification by performing spatial anchor ranging operations to determine whether the ranging information provided in the notification meets the service area range limits and requirements of the spatial anchor (if this information is not provided within the notification received from the ranging function or service)

Step 9: The XRM client may return a response back to the function or service indicating that it received and processed the spatial anchor ranging notification.

Step 10: After receiving a ranging response or notification, the XRM client may use this information to detect one or more objects or UEs that have met the service area range limits and requirements of a spatial anchor. Thereafter, the XRM client may perform one or more of the following actions.
Determine whether the UE(s) are allowed to have awareness and knowledge of the spatial anchor and the information stored within a spatial anchor and/or linked to a spatial anchor. The XRM client may use information elements configured within a spatial anchor, local policies of the XRM client, and/or additional information that the XRM client receives from other functions or services in the 3GPP system to make this determination. For example, the XRM client may receive and/or determine an identifier of a UE (e.g., UE ID) and/or an identifier of an application or service on the UE (e.g., XRM client ID, VAL client ID). This information may be provided to the XRM client from the UE or another function or service in the 3GPP system. Using this information, the XRM client may compare it against spatial anchor access control policies to determine if the UE is permitted to have awareness and knowledge of the spatial anchor. The XRM client may also check spatial anchor advertisement policies configured within a spatial anchor to determine if sharing (i.e., advertising) spatial anchor information with the UE is permitted. The XRM client may also issue a request to a VAL client associated with a spatial anchor to request permission from the VAL client to share spatial anchor information with a UE. The XRM client may also query another function or service in the 3GPP system to determine whether the UE wishes to receive information regarding spatial anchors.
Determine whether the UE(s) or their owner(s) have provided consent to have the UE's location tracked and detecting if/when the UE has come within the range limits of one or more consented types of spatial anchors. The XRM client may use information stored locally at the XRM client to make this determination. Alternatively, the XRM client may query information (e.g., device and/or user profile information) from one or more functions or services in the 3GPP system. For example, in one embodiment, the XRM client may query a 3GPP defined CAPIF authorization function.
Determine whether the spatial anchor is of interest to the UE(s) that have come within the range limits of one or more types of spatial anchors. The XRM client may use information stored locally at the XRM client to make this determination. Alternatively, the XRM client may query information from one or more functions or services in the 3GPP system. For example, in one embodiment, the XRM client may query information such as the types of applications or services supported by a UE (e.g., VAL service IDs), the types of spatial anchors (e.g., spatial anchor IDs) of interest to the UE, the types of spatial anchor content (e.g., VAL content ID) of interest to the UE, a scheduled time window of when the UE is interested in spatial anchors, an indication of whether the object is currently interested in spatial anchors, and/or a scheduled time window of when the object is interested in spatial anchors.
Create spatial anchor notifications comprising spatial anchor information such as but not limited to the types of information defined in Table 2.
Send the spatial anchor notifications to one or more UEs detected within range of the spatial anchor or to one or more VAL clients having an association with the spatial anchor.

Whether or not an XRM client performs ranging operations for a given spatial anchor may be determined by one or more information elements configured within the spatial anchor. For example, whether indicator may be specified by a VAL client and used by the XRM client to determine whether or not to track and detect location of UEs and if the UEs come within the defined range limits of the spatial anchor (or object anchored to spatial anchor).

### XRM Client Initiated Spatial Anchor Content or Service Request

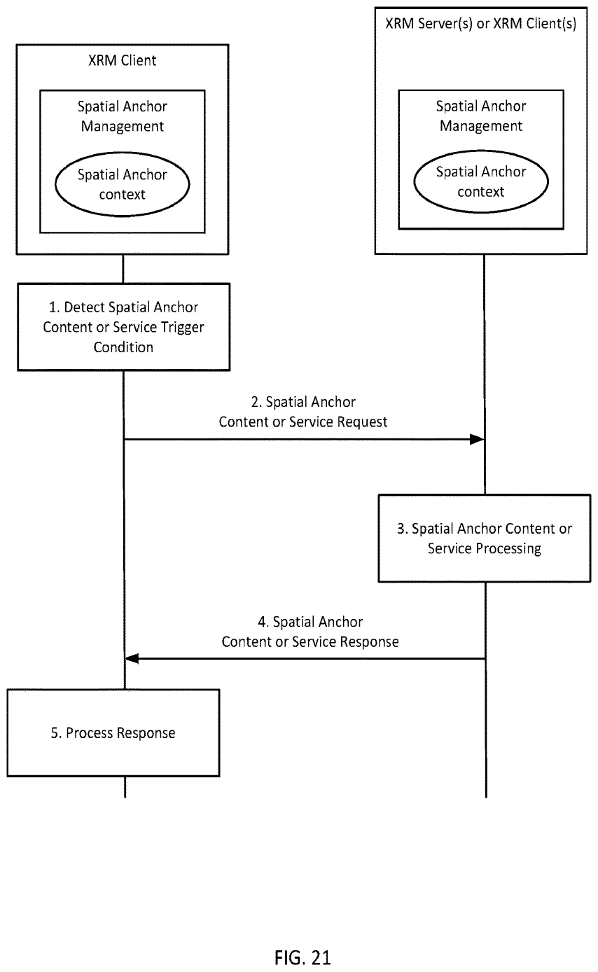

As shown in FIG. 21, an XRM client may initiate a request to an XRM server or another XRM client to access VAL content or services associated with a spatial anchor.

Step 1: An XRM client may detect a trigger condition to issue a spatial anchor content or service request. Some possible triggers conditions may include but are not limited to receiving a spatial anchor content or service request from a VAL client hosted on the same UE as the XRM client or another UE. An XRM client may also receive a spatial anchor content or service request from an XRM server or another XRM client (e.g., on a different UE).

Step 2: Upon detecting the trigger condition, the XRM client may determine whether it needs to generate a spatial anchor content or service request or if the XRM client can process the request using spatial anchor content stored locally in a spatial anchor which the XRM client manages. If the XRM client is not able to process the request using local spatial anchor content, then the XRM client may generate a request for spatial anchor content or services. This request may target a local VAL client or a remote XRM client or XRM server. To determine the target, the XRM client may check the spatial anchor ID of an incoming request and/or information elements stored within the targeted spatial anchor (e.g., VAL content or service API information) to make this determination. If the XRM client sends a request to a local VAL client or a remote XRM client or XRM server, the request may include but is not limited to one or more information elements defined in Table 1 (e.g., VAL client ID, XRM client ID, spatial anchor ID, spatial anchor API information).

Step 3: Upon receiving a request to access content or services associated with a spatial anchor, the targeted VAL client, XRM client or XRM server may process the request by first checking whether the XRM client originating the request has permissions to access the content or services of the spatial anchor.

Step 4: The XRM client may receive a response to the spatial anchor content or service request. The response may include but is not limited to VAL content and/or the results of VAL services associated with the spatial anchor. The response may also include other information elements defined in Table 1.

Step 5: The XRM client may process the response by extracting content and/or service results from the response. The XRM client may forward this information to other entities (e.g., VAL client, another XRM client or another XRM server) such as the entity which the XRM client received the original spatial anchor content or service request described in Step 1. The XRM client may also store this information locally. For example, the XRM client may store this information within a spatial anchor managed locally by the XRM client. Thereafter, an XRM client may use this locally stored information to service future spatial anchor content or service requests.

### XRM Client Initiated Spatial Anchor Notifications

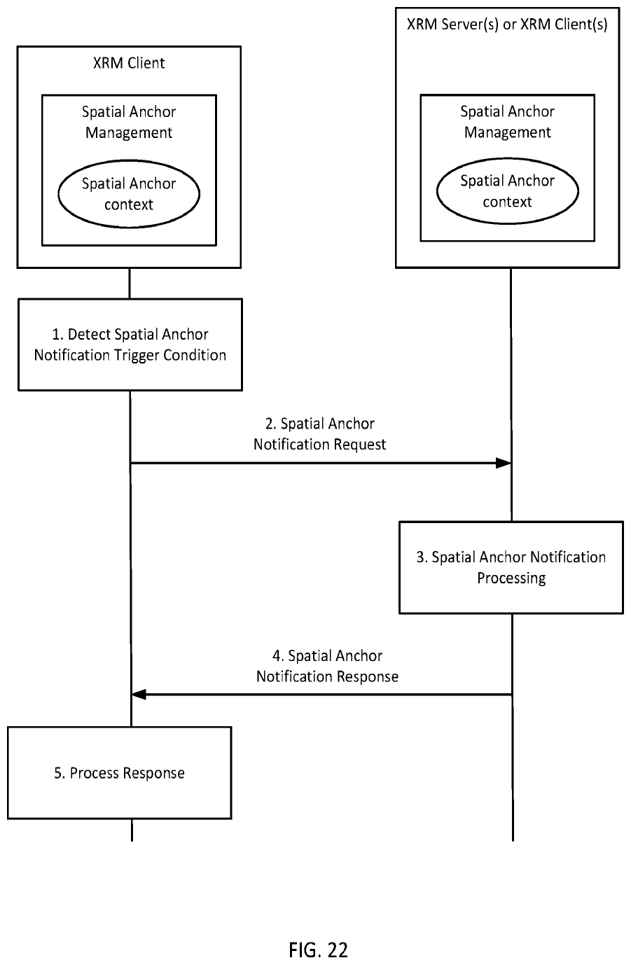

As shown in FIG. 22, an XRM client may issue a spatial anchor notification request to an XRM server and/or another XRM client.

Step 1: An XRM client detects that spatial anchor notification criteria have been met. The detection of notification criteria by the XRM client may involve detecting one or more events such as but not limited to the following:
A change in the location, orientation, and/or distance of a spatial anchor, an object anchored to a spatial anchor, or one or more objects(s)/UE(s) in the proximity of a spatial anchor.
Detecting that one or more objects/UEs have met (or no longer meet) the spatial anchor service area range limits or requirements.
A change in the spatial anchor service area range limits or requirements
A change in one or more VAL clients associated with a spatial anchor and/or update to the VAL client callback address(s).
A new/different object being anchored to the spatial anchor.
Spatial anchor location tracking being enabled or disabled for the spatial anchor.
Spatial anchor ranging being enabled or disabled for the spatial anchor.
New/updated content or services being linked to a spatial anchor or being stored within the context information of a spatial anchor.
A change in the availability status or schedule of a spatial anchor
A change in the availability status and/or schedule of one or more VAL clients providing content associated with a spatial anchor.
A change to spatial anchor access control or advertisement policies

The spatial anchor related events may be detected by the XRM client based on operations performed on a spatial anchor and/or upon spatial anchor event criteria defined within a spatial anchor subscription. Spatial anchor event criteria may by defined within individual information elements within spatial anchors and/or within individual subscriptions to spatial anchors. Alternatively, these criteria may be defined within local policies configured on the XRM client. An XRM client may monitor and detect if/when the configured criteria have been met and then generate one or more spatial anchor notifications.

Step 2: If/when an XRM client detects that the notification criteria have been met, it may generate one or more spatial anchor notifications that may include but are not limited to one or more of the information elements defined in Table 2. To determine which information to include in a spatial anchor notification, the XRM client may rely on one or more of the following: a notification content parameter specified within the spatial anchor or a spatial anchor subscription which defines which information elements of the spatial anchor to include in the notification, an access control and/or advertisement policy defining access control rules regarding which entities are allowed to access certain information elements of the spatial anchor, and/or local policies.

TABLE 2
Spatial Anchor Notification Request Elements

| Request Element | Description |
|---|---|
| Notification ID | Identifier of this spatial anchor notification |
| Subscription ID | Identifier of the spatial anchor subscription associated with this |
| | notification |
| Spatial anchor context | See Error! Reference source not found. for a list of spatial |
| information | anchor context Information elements that may be included. |
| Spatial anchor event(s) | Indicators of one or more events that triggered and caused the |
| | spatial anchor notification |
| Target | Information regarding the target of this spatial anchor |
| | notification: |
| | IP address of the target |
| | Port that the target receives spatial anchor notifications on |
| | Identifier of a resource or topic (e.g., URI, topic name, etc.) |
| | that the target receives spatial anchor notifications |
| XRM server ID | Identifier of the XRM server initiating the spatial anchor |
| | notification request |

Step 3: Upon receiving the spatial anchor notification request, the target may perform one or more follow-on operations based on spatial anchor centric information. The follow-on operations may include the target sending one or more of the following requests to the XRM client to process:
A request to obtain privileges to access information elements of the spatial anchor, an object anchored to the spatial anchor, content linked to the spatial anchor, or a service linked to the spatial anchor.
A request to perform an operation targeting the spatial anchor such as a discover, retrieve, update, or subscribe operation to the spatial anchor.
A request to retrieve content linked to the spatial anchor (e.g., content hosted by a VAL client for which the spatial anchor contains a link to)
A request to access a service linked with the spatial anchor (e.g., a service accessible via a VAL client for which the spatial anchor contains a link to)
A request to perform an action on the object anchored to the spatial anchor (e.g., activate a switch upon a device anchored to the spatial anchor)

Upon receiving one or more of the above requests, the XRM client may process the requests. When processing the received requests, the XRM client may interface to one or more VAL client and/or other functions or services in the 3GPP system. For example, the XRM client may forward a spatial anchor content request to a VAL client to process. When processing the received requests, the XRM client may use spatial anchor context information stored in a spatial anchor. For example, the XRM client may use a VAL client ID, VAL client callback address and/or VAL client content or service link stored in a spatial anchor to determine where to forward a spatial anchor content or service request to. Likewise, an XRM client may use a of a VAL client availability schedule information to determine when to schedule and forward a spatial anchor content or service request to a VAL client. Alternatively, an XRM client may service a request to access spatial anchor content by retrieving content that is stored within a spatial anchor and returning this content to the requestor.

Step 4: The target may generate and return a spatial anchor notification response to the XRM client that originated the notification request.

Step 5: The XRM client may receive and processes the spatial anchor notification response. The processing of the response may include generating subsequent notifications (e.g., to VAL clients) or performing other actions contingent upon the successful notification completing. For example, the XRM client may perform spatial anchor location, orientation, distance or ranging operations upon successful completion of a notification.

### XRM Client Initiated Spatial Anchor Delete

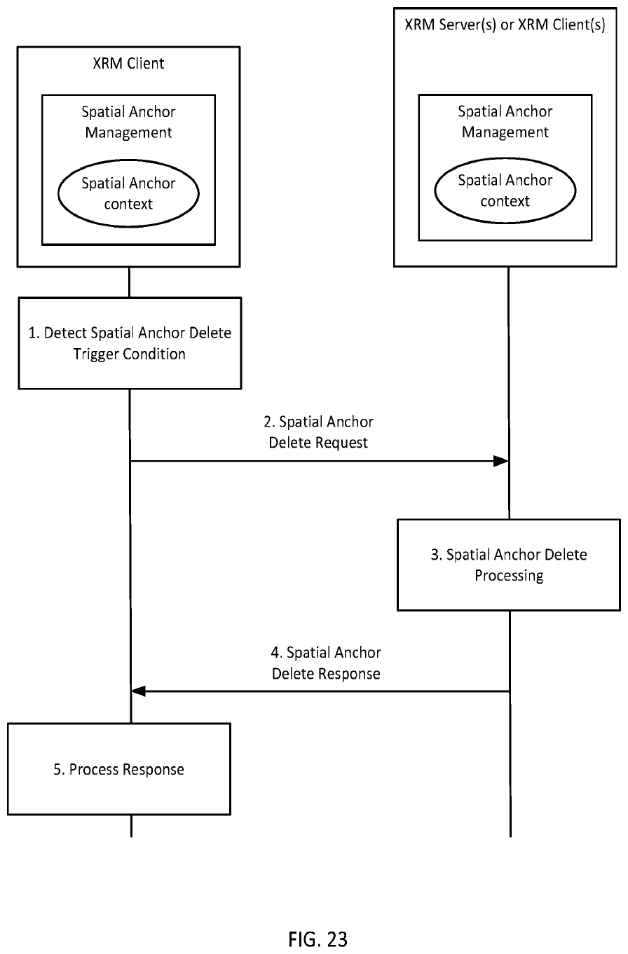

As shown in FIG. 23, an XRM client may initiate a request to an XRM server or another XRM client to delete a spatial anchor.

Step 1: An XRM client may detect a trigger condition to issue a spatial anchor delete request. Some possible triggers conditions may include but are not limited to receiving a spatial anchor delete request or an XRM de-registration request from a VAL client, an XRM server or another XRM client.

Step 2: The XRM client may issue a spatial anchor delete request to an XRM server or another XRM client. The request may include spatial anchor context information such as but not limited to the information elements defined in Table 1.

Step 3: Upon receiving the request to delete context for spatial anchors, the targeted XRM server or XRM client may process the request by first checking whether the XRM client originating the request has permissions to delete spatial anchors. This check may be performed in a similar manner a described in the aforementioned XRM client initiated spatial anchor discovery/retrieval procedure. If allowed, the targeted XRM server or XRM client processes the request. When processing the request, the targeted XRM server or XRM client may delete spatial anchor(s). The targeted XRM server or client may also perform one or more of the following operations:
Delay processing of the delete request until the XRM server or client finishes any outstanding operations associated with the spatial anchor (e.g., notifications, retrieval, or discovery of the spatial anchor, etc.)
Trigger the tear-down of any underlying transports (PDU sessions, SEALDD flows) associated with the spatial anchor.
Delete any subscriptions associated with the spatial anchor and stop sending notifications to subscribers.
Notify subscribers (e.g., VAL clients) of the spatial anchor and subscriptions being deleted and that spatial anchor notifications associated with the spatial anchor will no longer be sent.
Reject any subsequent requests attempting to access the spatial anchor.
Delete any access control policies associated with the spatial anchor.
Delete any additional subscriptions or spatial anchor context that the XRM server or client created at other functions and services in the 3GPP system in order to service this spatial anchor (e.g., subscriptions to XRM server, other XRM clients, location management server, subscription to SEAL server, subscription to SEALDD server, etc.)

Step 4: Generate and return a spatial anchor delete response to the XRM client that originated the request. Where the response may include but is not limited to one or more of the information elements defined in defined in Table 1 and/or a status code indicating whether the request was successfully processed.

Step 5: The XRM client receives and processes the spatial anchor delete response. The XRM client may also perform one or more operations similar to the operations defined in Step 3.

### XRM Server Initiated Spatial Anchor Advertisement

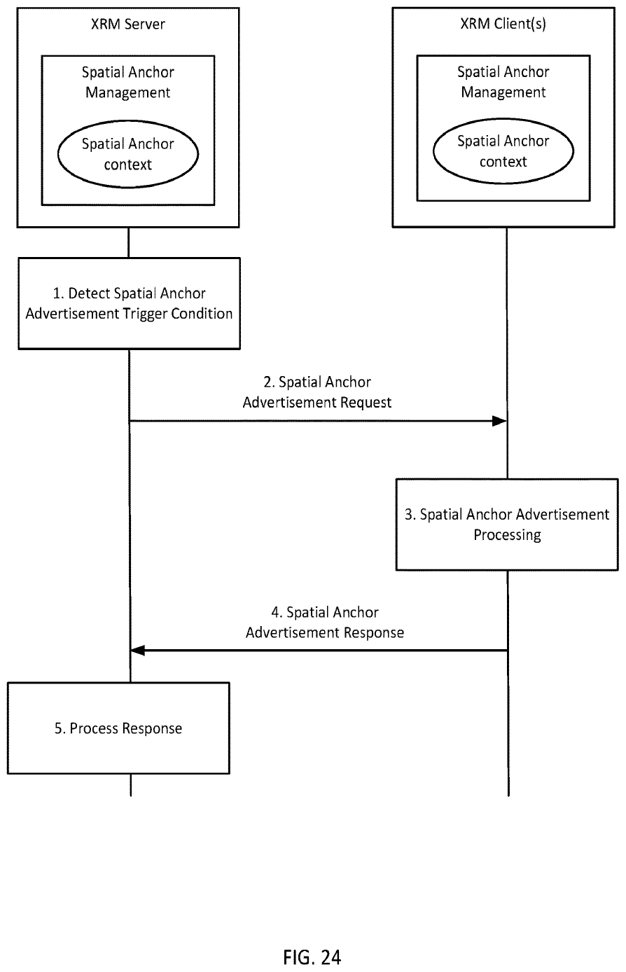

As shown in FIG. 24, an XRM client may receive a spatial anchor advertisement request from an XRM server.

Step 1: An XRM server may detect a trigger condition to issue a spatial anchor advertisement request to one or more XRM clients. Some possible triggers conditions may include but are not limited to receiving a spatial anchor discovery, retrieval, create, advertisement, update, subscribe, or delete request from a VAL server, another XRM client or another XRM server.

Step 2: An XRM server may issue a request to an XRM client to advertise one or more spatial anchors. The request may include information elements such as those previously defined in Step 2 of the XRM Client Initiated Spatial Anchor Advertisement procedure.

Step 3: Upon receiving the request to advertise spatial anchors, the targeted XRM client may process the request in a similar manner as previously described in Step 3 of the XRM Client Initiated Spatial Anchor Advertisement procedure, but with the exception the XRM client performs the XRM server defined operations and vice versa.

Step 4: If one or more spatial anchors are advertised successfully, then representations of the advertised anchor(s) including information elements such as but not limited to those defined in Table 1 are returned by the XRM client to the XRM server. Alternatively, spatial anchor IDs (e.g., URIs) may be returned. Otherwise, an error indication may be returned in the response indicating no spatial anchors were not advertised successfully.

Step 5: The XRM server may receive and process the spatial anchor advertisement response. The processing of the response may include forwarding spatial anchor advertisement information within the response to a VAL server, another XRM client or another XRM server. The XRM server may also store spatial anchor advertisement information from the response and use this information when processing future spatial anchor operations.

### XRM Server Initiated Spatial Anchor Discovery/Retrieval

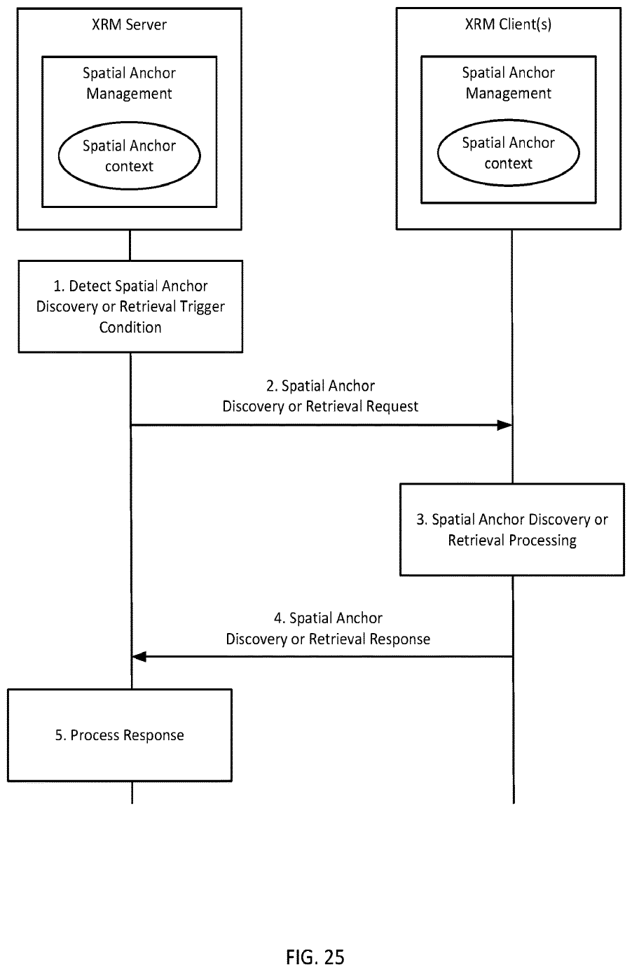

As shown in FIG. 25, an XRM client may receive a spatial anchor discovery or retrieval request from an XRM server.

Step 1: An XRM server may detect a trigger condition to issue a spatial anchor discovery or retrieval request to one or more XRM clients. Some possible triggers conditions may include but are not limited to receiving a spatial anchor discovery, retrieval, create, update, subscribe, or delete request from a VAL server, another XRM client or another XRM server.

Step 2: An XRM server may issue a request to an XRM client to retrieve context for one or more spatial anchors. Alternatively, the retrieval request may be used to discover one or more spatial anchors that match one or more specified criteria. The request may include information elements such as those previously defined in Step 2 of the XRM Client Initiated Spatial Anchor Discovery or Retrieve procedure.

Step 3: Upon receiving the request to retrieve or discover context for spatial anchors, the targeted XRM client may process the request in a similar manner as previously described in Step 3 of the XRM Client Initiated Spatial Anchor Discovery or Retrieve procedure, but with the exception the XRM client performs the XRM server defined operations and vice versa.

Step 4: If one or more spatial anchors are found to match the filter criteria, then representations of the spatial anchor(s) including information elements such as but not limited to those defined in Table 1 are returned by the XRM client to the XRM server. Alternatively, spatial anchor IDs (e.g., URIs) may be returned. Otherwise, an error indication may be returned in the response indicating no spatial anchors matching the specified filter criteria were found.

Step 5: The XRM server receives and processes the spatial anchor retrieve or discovery response. The processing of the response may include forwarding spatial anchor context information within the response to a VAL server, another XRM client or another XRM server. The XRM server may also store spatial anchor context information from the response and use this information when processing future spatial anchor operations.

### XRM Server Initiated Spatial Anchor Creation/Update

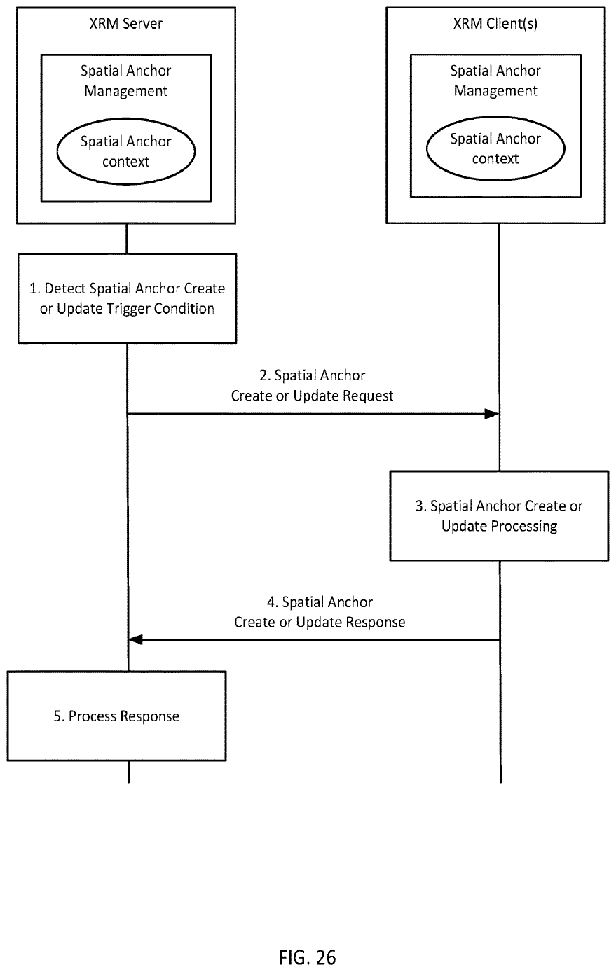

As shown in FIG. 26, an XRM client may receive a spatial anchor create or update request from an XRM server.

Step 1: An XRM server may detect a trigger condition to issue a spatial anchor create or update request to one or more XRM clients. Some possible triggers conditions may include but are not limited to receiving a spatial anchor create or update request from a VAL server, another XRM server or another XRM client.

Step 2: The XRM server may issue a spatial anchor create or update request to an XRM client. The request may include spatial anchor context information such as but not limited to the information elements defined in Table 1.

Step 3: Upon receiving the request to create or update spatial anchors, the targeted XRM client may process the request in a similar manner as previously described in Step 3 of the XRM Client Initiated Spatial Anchor Creation/Update procedure, but with the exception the XRM client performs the XRM server defined operations and vice versa.

Step 4: The XRM client generates and returns a spatial anchor create or update response to the XRM server that originated the request. Where the response may include but is not limited to one or more of the information elements defined in defined in Table 1 and/or a status code indicating whether the request was successfully processed.

Step 5: The XRM server receives and processes the spatial anchor create or update response. The processing of the response may include forwarding spatial anchor context information within the response to a VAL server, another XRM server, or another XRM client. The XRM server may also store spatial anchor context information from the response and use this information when processing future spatial anchor operations.

### XRM Server Initiated Spatial Anchor Subscribe/Unsubscribe

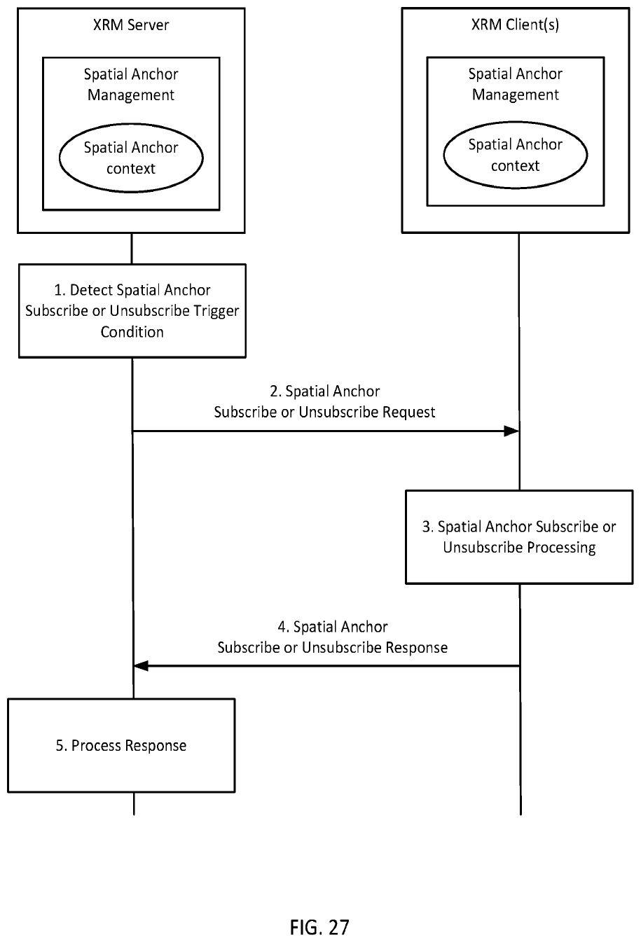

As shown in FIG. 27, an XRM client may receive a spatial anchor subscribe or unsubscribe request from an XRM server.

Step 1: An XRM server may detect a trigger condition to issue a spatial anchor subscribe or unsubscribe request to an XRM client. Some possible triggers conditions may include but are not limited to receiving a spatial anchor subscribe or unsubscribe request from a VAL server, another XRM server or another XRM client.

Step 2: The XRM server may issue a spatial anchor subscribe or unsubscribe request to an XRM client. The request may include spatial anchor context information such as but not limited to the information elements defined in Table 1 (e.g., spatial anchor subscription information).

Step 3: Upon receiving the request to subscribe or unsubscribe to spatial anchors, the targeted XRM client may process the request in a similar manner as described in Step 3 of the XRM Client Initiated Spatial Anchor Subscribe/Unsubscribe procedure, but with the exception that operations performed by the XRM server are instead performed by the XRM client and vice versa.

Step 4: The targeted XRM client may generate and return a spatial anchor subscribe or unsubscribe response to the XRM server. Where the response may include but is not limited one or more information elements defined in Table 1 (e.g., spatial anchor subscription ID).

Step 5: The XRM server may receive and processes the spatial anchor subscribe or unsubscribe response. The processing of the response may include forwarding spatial anchor subscription information within the response to a VAL server, another XRM server or another XRM client. The XRM server may also store spatial anchor subscription information from the response and use this information when processing future spatial anchor operations.

### XRM Server Initiated Spatial Anchor Anchoring

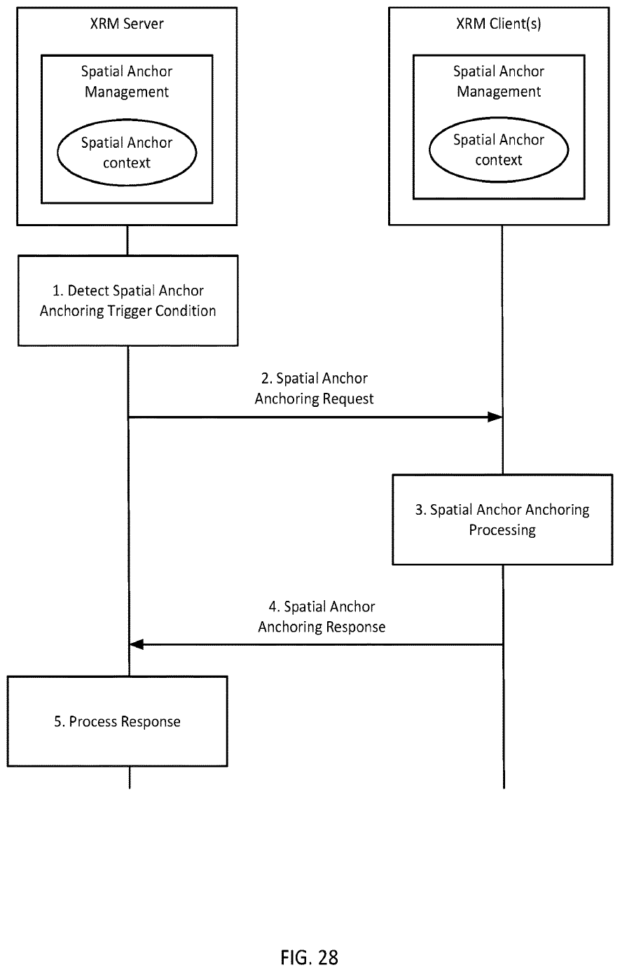

As shown in FIG. 28, an XRM client may receive a spatial anchor anchoring request from an XRM server.

Step 1: An XRM server detects a trigger condition for initiating a spatial anchor anchoring operation to an XRM client. For example, an XRM server may initiate spatial anchor anchoring operations if/when it receives a corresponding spatial anchor operation from a VAL server (e.g., creation or update of a spatial anchor). Alternatively, an XRM server may initiate these operations autonomously when detecting one or more types of events defined by a local policy.

Step 2: Using spatial anchor context information (e.g., spatial anchor object ID), the XRM server may determine an XRM client that is hosted on a UE to which a spatial anchor is to be anchored to, or an XRM client that is hosted on a UE that is within the vicinity of an object to which a spatial anchor is to be anchored to. Based on this information, the XRM server may send a spatial anchor anchoring request to this XRM client. Within the request, the XRM server may include spatial anchor context information such as but not limited to one or more elements defined in Table 1 (e.g., Spatial anchor ID, Anchored object ID, VAL client ID, required spatial anchor location, orientation, and distance, required spatial anchor service area, required spatial anchor capabilities, required spatial anchor service KPIs, spatial anchor security credentials, spatial anchor access control policies, spatial anchor advertisement policies).

Step 3: Upon receiving the anchoring request, the XRM client may process the request by first checking whether the XRM server originating the request has permissions to perform the anchoring operation. If allowed, the XRM client may perform one or more operations such as those defined in the XRM Client Initiated Spatial Anchor Anchoring procedure.

Step 4: The XRM client may generate and return a spatial anchor anchoring response to the XRM server. The response may include a status indicating whether the anchoring operation was performed successfully and/or the current location, orientation, and/or distance of the object anchored to the spatial anchor.

Step 5: Upon receiving a response, the XRM server may perform additional spatial anchor operations such as subscribing to receive location, orientation, and/or distance updates from the XRM client, updating spatial anchor context information with the location, orientation, and distance of the UE or object the spatial anchor is anchored to, generating notifications to other entities in the 3GPP system (e.g., VAL server, another XRM server, another XRM client) regarding updates to the spatial anchor's location, orientation, or distance based on changes to the location, orientation, or distance of the UE or object that the spatial anchor is anchored to, or perform additional spatial anchor operations such as spatial anchor ranging operations defined in the XRM Server Initiated Spatial Ranging procedure.

### XRM Server Initiated Spatial Anchor Location/Orientation/Distance Request

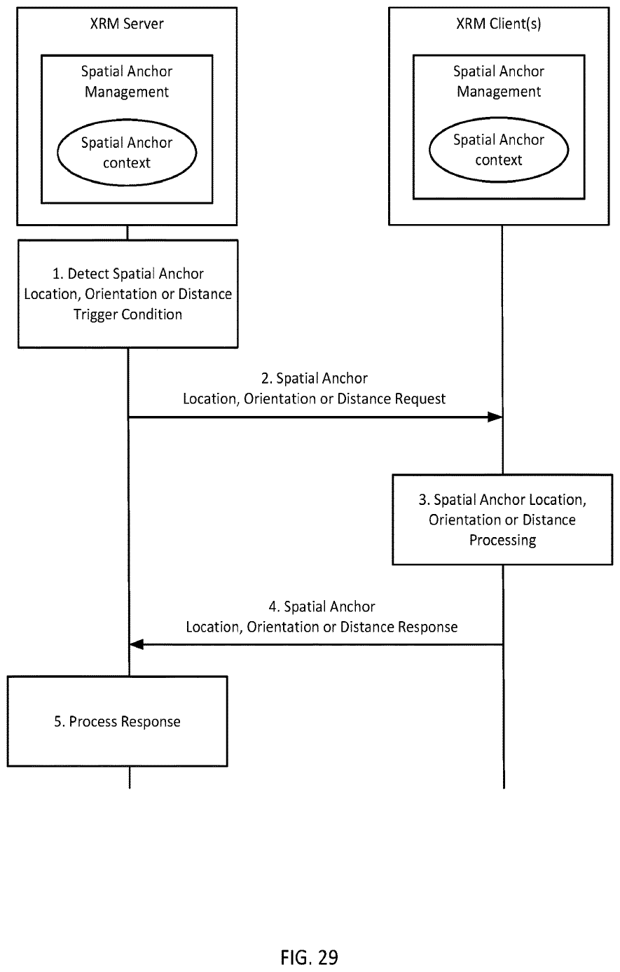

As shown in FIG. 29, an XRM client may receive a spatial anchor location, orientation, or distance request from an XRM server.

Step 1: An XRM server detects a trigger condition for initiating a spatial anchor location, orientation, and/or distance operation to an XRM client. Some example of trigger conditions may be a request for location, orientation, or distance information which the XRM server receives from a VAL server or another XRM client or another XRM server. Alternatively, an XRM server may initiate these operations autonomously when detecting one or more types of events such as a time duration has elapsed since the XRM server has collected the last location, orientation, or distance update for a spatial anchor.

Step 2: The XRM server sends one or more spatial anchor location, orientation, or distance requests to one or more XRM clients. One type of request may be to discover and/or retrieve an updated location, orientation, and/or distance of a spatial anchor associated with the XRM client (e.g., a spatial anchor anchored to the same UE upon which the XRM client is hosted, or an object that is in close proximity to the UE and which can be located using sensors hosted on this UE). Another type of operation may include the XRM server sending a request to subscribe to the XRM client to receive location, orientation, and/or distance updates for a spatial anchor associated with the XRM client and to receive spatial anchor location notifications if/when specified criteria have been met. For example, a specified time period has elapsed since the last spatial anchor location, orientation, and/or distance update, or a spatial anchor (or UE/object anchored to a spatial anchor) has moved more than a specified distance threshold. The requests may also include one or more of the following information elements:
Identifier(s) of a spatial anchor, an object anchored to a spatial anchor, and/or object(s) or UE(s) in the proximity of a spatial anchor.
The current or last known location(s), orientation, and/or distance of a spatial anchor, an object anchored to a spatial anchor, and/or object(s) or UE(s)
Location, orientation, and/or distance requirements of the spatial anchor defining the location precision, format, and/or dimensionality required for location information returned for the object or UE.

Step 3: Upon receiving the location, orientation, and/or distance request, the XRM client may process the request by first checking whether the XRM server originating the request has permissions to perform the spatial anchor location, orientation, and/or distance operation. If allowed, the XRM client may perform one or more operations such as those defined in the XRM Client Initiated Spatial Anchor Location/Orientation/Distance procedure.

Step 4: The XRM client may return a spatial anchor location, orientation, and/or distance response to the XRM server that originated the request. Where the response may include but is not limited to a location, orientation, and/or distance of the spatial anchor, an object anchored to the spatial anchor, and/or object(s) or UE(s) in the proximity of the spatial anchor. The location, orientation, and/or distance of an object anchored to the spatial anchor, and/or object(s) or UE(s) in the proximity of the spatial anchor may be provided in an absolute format which is independent of the location, orientation, and distance of the spatial anchor. Alternatively, it may be provided in relative format that is relative to the location, orientation, and/or distance of the specified spatial anchor.

Step 5: Upon receiving a spatial anchor location, orientation, and/or distance response, the XRM server may perform additional spatial anchor operations such as update spatial anchor context information stored locally at the XRM server or elsewhere in the 3GPP system, generate spatial anchor notifications to other entities in the 3GPP system (e.g., VAL servers, other XRM clients or other XRM servers, etc.), perform additional spatial anchor operations (e.g., ranging operations).

### XRM Server Initiated Spatial Anchor Ranging Request

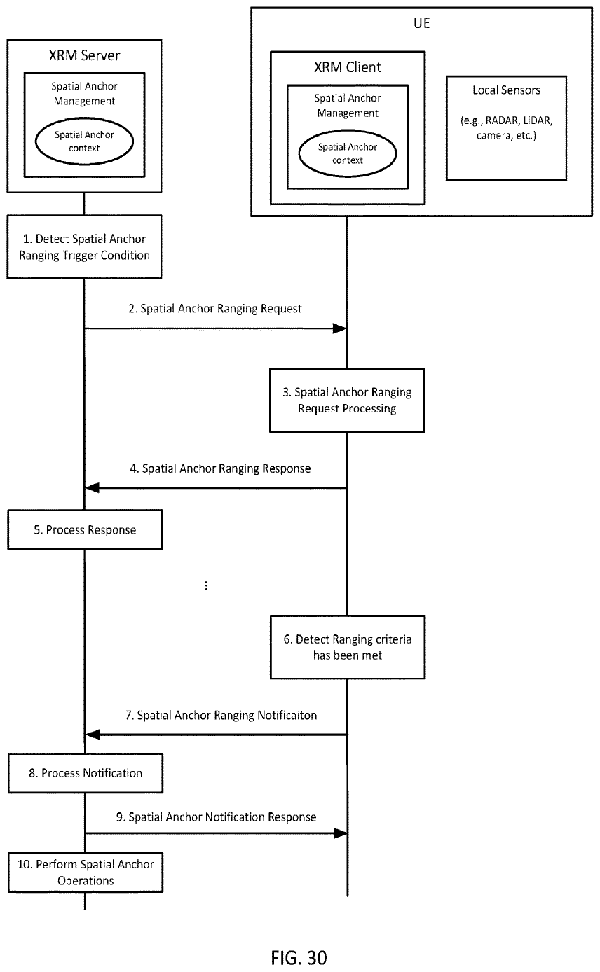

As shown in FIG. 30, an XRM client may receive a spatial anchor ranging request from an XRM server.

Step 1: An XRM server may detect a trigger condition for initiating a spatial anchor ranging operation to an XRM client. A trigger conditions for performing the ranging operations may be if/when the XRM server receives a spatial anchor operation from a VAL server (e.g., to create a spatial anchor), another XRM server or another XRM client. Alternatively, an XRM server may initiate trigger a ranging operation autonomously when detecting one or more types of events such as the XRM server receiving a notification from a function or service in the 3GPP system that a UE is in a certain geographical location in which spatial anchors are located.

Step 2: The XRM server may send one or more requests to get spatial anchor ranging information from one or more XRM clients. The XRM server may then use this ranging information to determine whether any UEs or objects are within the specified service area ranges of one or more spatial anchors. A request may retrieve spatial anchor ranging information from an XRM client. Alternatively, the XRM server may send spatial anchor ranging subscription request to an XRM client to receive spatial anchor ranging notifications from the XRM client if/when specified spatial anchor ranging criteria have been met. For example, an XRM server may specify ranging criteria such as a certain distance and/or certain distance an object must have with respect to a reference location, orientation, or distance. This reference location, orientation, or distance may be the current location, orientation, and distance of a spatial anchor. The ranging criteria may be the service area range limits of the spatial anchor. For example, an object must be within a range of 300 feet of the spatial anchor and must be headed in a direction towards the spatial anchor and with a particular angle of arrival. A ranging request may also include ranging requirements of the spatial anchor such as the location precision, format, and/or dimensionality required for location information.

Step 3: Upon receiving the spatial anchor ranging request, the XRM client may process the request by first checking whether the XRM server originating the request has permissions to perform the spatial anchor ranging operation. If allowed, the XRM client may perform one or more operations such as those defined in the XRM Client Initiated Spatial Anchor Ranging procedure.

Step 4: The XRM client may return a spatial anchor ranging response to the XRM server. The ranging information within the response may include but is not limited to a distance of one or more objects or UEs. This distance may be relative to the location, orientation, and distance of a spatial anchor. The response may also include an indication whether the location, orientation, and/or distance of the object or UE meets the service area range limits and requirements of the spatial anchor.

Step 5: The XRM server receives and processes the ranging response. Based on the response, the XRM server may perform one more additional operations. For example, if an indication is not already provided in the response, the XRM server may use the information in the response to detect if the spatial anchor service area range limits or requirements have been met for any objects or UEs in the proximity of a spatial anchor. If the XRM server detects an object that satisfies the service area range limits of the spatial anchor, it may notify other entities in the 3GPP system such as but not limited to a VAL server, another XRM server, another XRM client.

Step 6: If the XRM server subscribes to receive ranging information from the XRM client, and if the spatial anchor ranging notification criteria specified by the XRM server is met, then a spatial anchor ranging notification may be sent to the XRM server. For example, the XRM client may initiate spatial anchor ranging notifications to an XRM server if/when it detects a change in an object's or UE's location, orientation, or distance which meets the ranging limits/requirements specified in the ranging subscription criteria specified by the XRM server.

Step 7: The XRM client sends one or more spatial anchor ranging notifications to the XRM server. Within a notification, the XRM client may include ranging information for one or more objects or UEs with respect to the location, orientation, and distance of a spatial anchor. The notification may also include an indication that the location, orientation, and/or distance of the object of UE meets (or no longer meets) the service area range limits and requirements of the spatial anchor.

Step 8: Upon receiving the spatial anchor ranging notification, the XRM server may process the notification by performing spatial anchor ranging operations to determine whether the ranging information provided in the notification meets the service area range limits and requirements of the spatial anchor (if this information is not provided within the notification received from the ranging function or service)

Step 9: The XRM server may return a response back to the XRM client indicating that it received and processed the spatial anchor ranging notification.

Step 10: After receiving a spatial anchor ranging response or notification, the XRM server may use this information to detect one or more objects or UEs that have met the service area range limits and requirements of a spatial anchor. Thereafter, the XRM server may perform one or more actions such as but not limited to the actions defined in Step 10 of the XRM Client Initiated Spatial Anchor Ranging procedure, with the exception the XRM server performs the actions instead of the XRM client.

Whether or not an XRM server performs ranging operations for a given spatial anchor may be determined by one or more information elements configured within the spatial anchor. For example, an indicator such as the “spatial anchor ranging enabled” information element proposed in Table 1 may be used by the XRM server to determine whether or not to track and detect locations of objects and UEs and if these objects or UEs come within specified range limits of the spatial anchor.

### XRM Server Initiated Spatial Anchor Content or Service Request

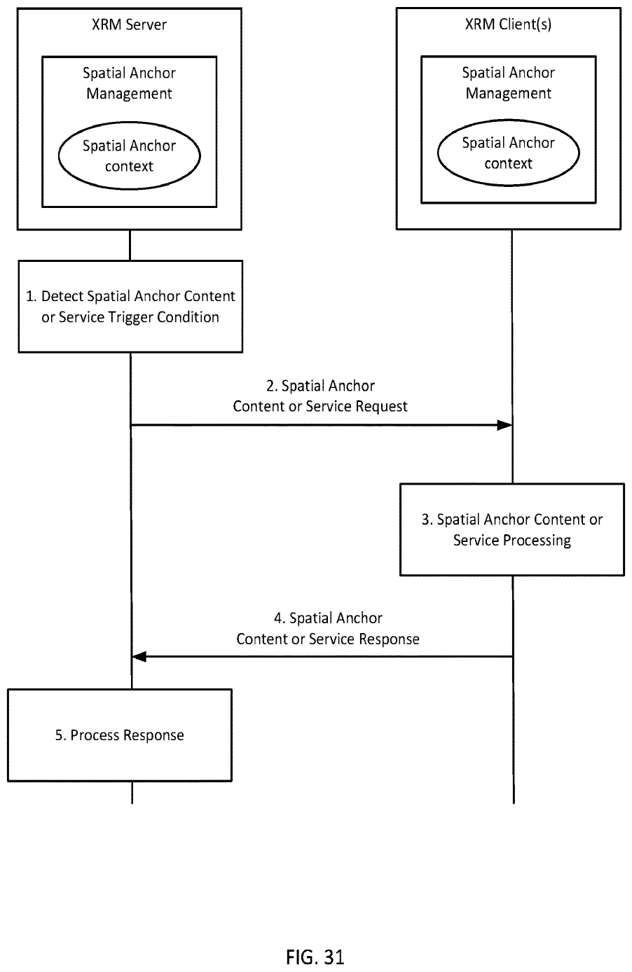

As shown in FIG. 31, an XRM client may receive a spatial anchor content or service request from an XRM server.

Step 1: An XRM server may detect a trigger condition to issue a spatial anchor content or service request to an XRM client. Some possible triggers conditions may include but are not limited to receiving a spatial anchor content or service request from a VAL server, another XRM server, or another XRM client.

Step 2: Upon detecting the trigger condition, the XRM server may determine whether it needs to generate a spatial anchor content or service request or if the XRM server can process the request using spatial anchor content stored locally in a spatial anchor which the XRM server manages. If the XRM server is not able to process the request using local spatial anchor content, then the XRM server may generate a request for spatial anchor content or services. This request may target an XRM client. To determine the target, the XRM server may check the spatial anchor ID of an incoming request and/or information elements stored within the targeted spatial anchor (e.g., VAL content or service API information) to make this determination. If the XRM server sends a request to an XRM client, the request may include but is not limited to one or more information elements defined in Table 1 (e.g., XRM server ID, spatial anchor ID, spatial anchor API information).

Step 3: Upon receiving a request to access content or services associated with a spatial anchor, the targeted XRM client may process the request by first checking whether the XRM server originating the request has permissions to access the content or services of the spatial anchor. If allowed, the XRM client may perform one or more operations such as those defined in the XRM Client Initiated Spatial Anchor Content or Service procedure. The XRM client may also perform one or more of the following types of operations:
Determine if XRM server has privileges to access information elements of the spatial anchor, an object anchored to the spatial anchor, content linked to the spatial anchor, or a service linked to the spatial anchor.
Perform an operation targeting the spatial anchor such as a discover, retrieve, update, or subscribe operation to the spatial anchor.
Retrieve content linked to the spatial anchor (e.g., content hosted by a VAL client for which the spatial anchor contains a link to)
Access a service linked with the spatial anchor (e.g., a service accessible via a VAL client for which the spatial anchor contains a link to)
Perform an action on the object anchored to the spatial anchor (e.g., activate a switch upon a device anchored to the spatial anchor)

Step 4: The XRM server may receive a response to the spatial anchor content or service request from the XRM client. The response may include but is not limited to VAL content and/or the results of VAL services associated with the spatial anchor. The response may also include other information elements defined in Table 1.

Step 5: The XRM server may process the response by extracting content and/or service results from the response. The XRM server may forward this information to other entities (e.g., VAL server, another XRM client or another XRM server) such as the entity which the XRM server received the original spatial anchor content or service request described in Step 1. The XRM server may also store this information locally. For example, the XRM server may store this information within a spatial anchor managed locally by the XRM server. Thereafter, an XRM server may use this locally stored information to service future spatial anchor content or service requests.

### XRM Server Initiated Spatial Anchor Notifications

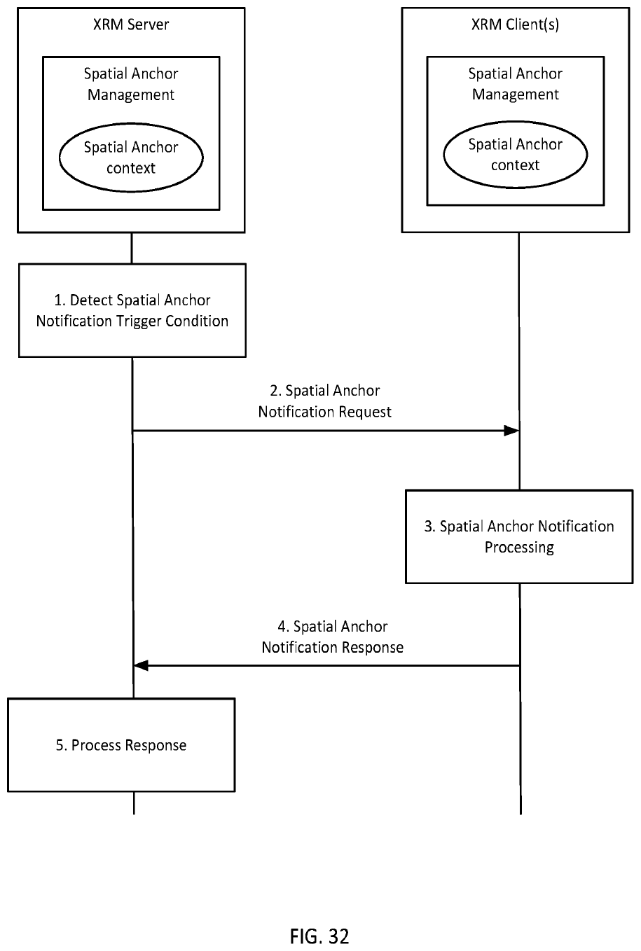

As shown in FIG. 32, an XRM client may receive a spatial anchor notification request from an XRM server.

Step 1: An XRM server detects that spatial anchor notification criteria have been met. The detection of notification criteria by the XRM server may involve detecting one or more events. The types of events may be similar to those defined in Step 1 of the XRM Client Initiated Spatial Anchor Subscribe/Unsubscribe procedure, however from the perspective of the XRM server rather than the XRM client.

Step 2: If/when an XRM server detects that the notification criteria have been met, it may generate one or more spatial anchor notifications to an XRM client. The notifications may include but are not limited to one or more of the information elements defined in Table 2. To determine which information to include in a spatial anchor notification, the XRM server may rely on one or more of the following: a notification content parameter specified within the spatial anchor or a spatial anchor subscription which defines which information elements of the spatial anchor to include in the notification, an access control and/or advertisement policy defining access control rules regarding which entities are allowed to access certain information elements of the spatial anchor, and/or local policies.

Step 3: Upon receiving the spatial anchor notification request, the XRM client may perform one or more follow-on operations based on spatial anchor centric information. The follow-on operations may include the notification target sending one or more requests to the XRM server to process such as those defined in Step 3 of the XRM Client Initiated Spatial Anchor Subscribe/Unsubscribe procedure.

Upon receiving the one or more of the above requests, the XRM server may process the requests. When processing the received requests, the XRM server may interface to one or more VAL servers and/or other functions or services in the 3GPP system. For example, the XRM server may forward a spatial anchor content request to a VAL server to process. When processing the received requests, the XRM server may use spatial anchor context information stored in a spatial anchor. For example, the XRM server may use a VAL server ID, VAL server callback address and/or VAL server content or service link stored in a spatial anchor to determine where to forward a spatial anchor content or service request to. Likewise, an XRM server may use a of a VAL server availability schedule information to determine when to schedule and forward a spatial anchor content or service request to a VAL server. Alternatively, an XRM server may service a request to access spatial anchor content by retrieving content that is stored within a spatial anchor and returning this content to the requestor.

Step 4: The XRM client may generate and return a spatial anchor notification response to the XRM server.

Step 5: The XRM server may receive and processes the spatial anchor notification response. The processing of the response may include generating subsequent notifications (e.g., to VAL servers) or performing other actions contingent upon the successful notification completing. For example, the XRM server may perform spatial anchor location, orientation, distance or ranging operations upon successful completion of a notification.

### XRM Server Initiated Spatial Anchor Delete

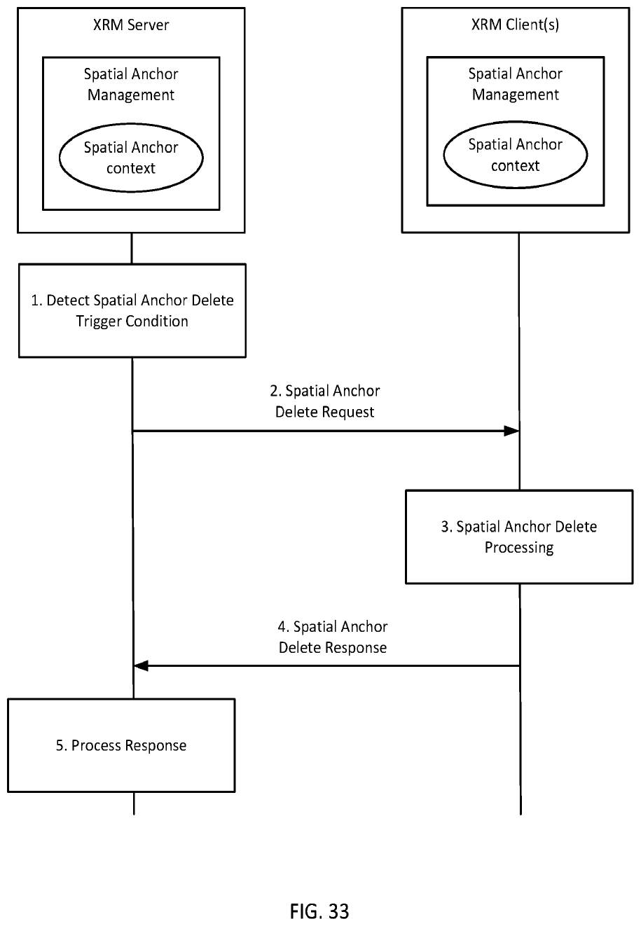

As shown in FIG. 33, an XRM client may receive a spatial anchor delete request from an XRM server.

Step 1: An XRM server may detect a trigger condition to issue a spatial anchor delete request to one or more XRM clients. Some possible triggers conditions may include but are not limited to receiving a spatial anchor delete request from a VAL server, another XRM server or another XRM client. Another possible trigger condition is the XRM server receives an XRM de-registration request from an XRM client or another XRM server.

Step 2: The XRM server may issue a spatial anchor delete request to an XRM client. The request may include spatial anchor context information such as but not limited to the information elements defined in Table 1.

Step 3: Upon receiving the request to delete context for spatial anchors, the targeted XRM client may process the request in a similar manner as previously described in Step 3 of the XRM Client Initiated Spatial Anchor Delete procedure, but with the exception the XRM client performs the XRM server defined operations and vice versa.

Step 4: The XRM client generates and returns a spatial anchor delete response to the XRM server that originated the request. Where the response may include but is not limited to one or more of the information elements defined in defined in Table 1 and/or a status code indicating whether the request was successfully processed.

Step 5: The XRM server receives and processes the spatial anchor delete response. The XRM server may also perform one or more operations similar to the operations defined in Step 3.

### Graphical User Interface

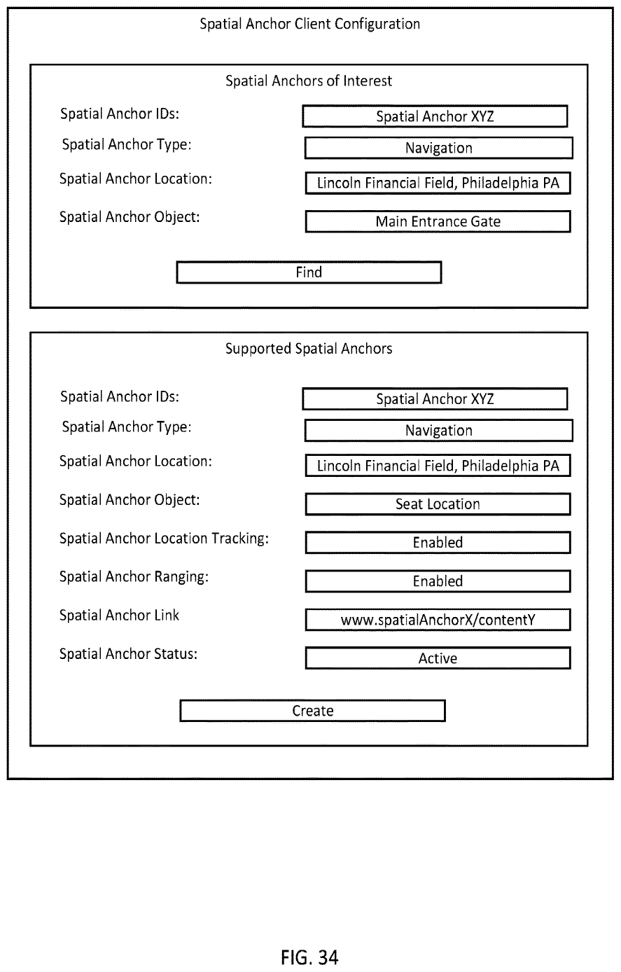

FIG. 34 shows an example of a graphical user interface for a spatial anchor device that could leverage the device centric spatial anchor capabilities proposed in this invention. Via this GUI a user could discover spatial anchors of interest as well as create spatial anchors which are anchored to a user's device at a particular location (e.g., a stadium).

### Example Communications System

The 3rd Generation Partnership Project (3GPP) develops technical standards for cellular telecommunications network technologies, including radio access, the core transport network, and service capabilities-including work on codecs, security, and quality of service. Recent radio access technology (RAT) standards include WCDMA (commonly referred as 3G), LTE (commonly referred as 4G), LTE-Advanced standards, and New Radio (NR), which is also referred to as “5G”. 3GPP NR standards development is expected to continue and include the definition of next generation radio access technology (new RAT), which is expected to include the provision of new flexible radio access below 7 GHZ, and the provision of new ultra-mobile broadband radio access above 7 GHz. The flexible radio access is expected to consist of a new, non-backwards compatible radio access in new spectrum below 7 GHz, and it is expected to include different operating modes that may be multiplexed together in the same spectrum to address a broad set of 3GPP NR use cases with diverging requirements. The ultra-mobile broadband is expected to include cmWave and mmWave spectrum that will provide the opportunity for ultra-mobile broadband access for, e.g., indoor applications and hotspots. In particular, the ultra-mobile broadband is expected to share a common design framework with the flexible radio access below 7 GHZ, with cmWave and mmWave specific design optimizations.

3GPP has identified a variety of use cases that NR is expected to support, resulting in a wide variety of user experience requirements for data rate, latency, and mobility. The use cases include the following general categories: enhanced mobile broadband (eMBB) ultra-reliable low-latency Communication (URLLC), massive machine type communications (mMTC), network operation (e.g., network slicing, routing, migration and interworking, energy savings), and enhanced vehicle-to-everything (eV2X) communications, which may include any of Vehicle-to-Vehicle Communication (V2V), Vehicle-to-Infrastructure Communication (V2I), Vehicle-to-Network Communication (V2N), Vehicle-to-Pedestrian Communication (V2P), and vehicle communications with other entities. Specific service and applications in these categories include, e.g., monitoring and sensor networks, device remote controlling, bi-directional remote controlling, personal cloud computing, video streaming, wireless cloud-based office, first responder connectivity, automotive ecall, disaster alerts, real-time gaming, multi-person video calls, autonomous driving, augmented reality, tactile internet, virtual reality, home automation, robotics, and aerial drones to name a few. All of these use cases and others are contemplated herein.

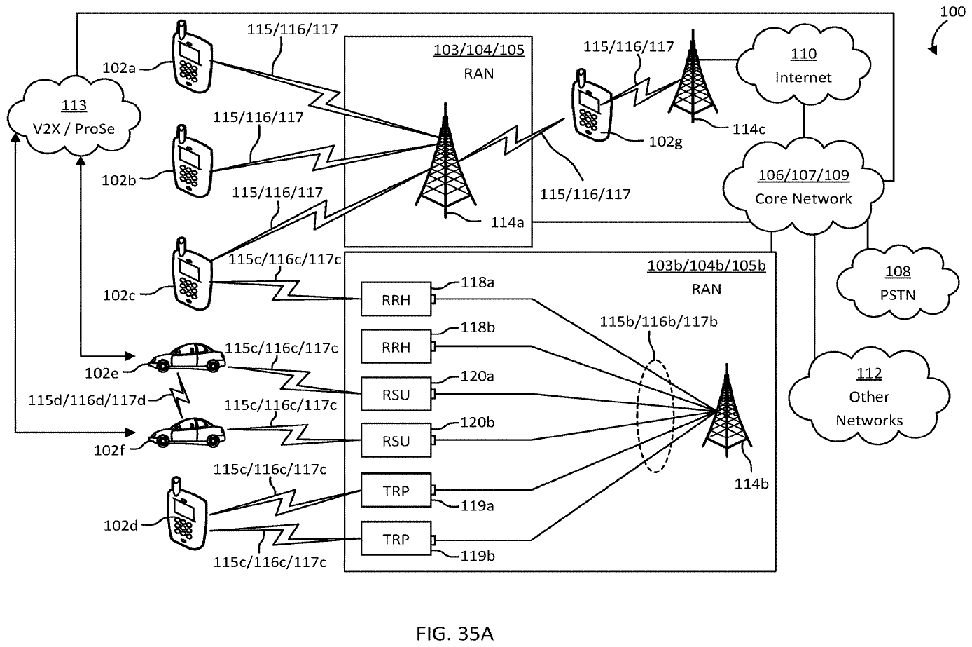

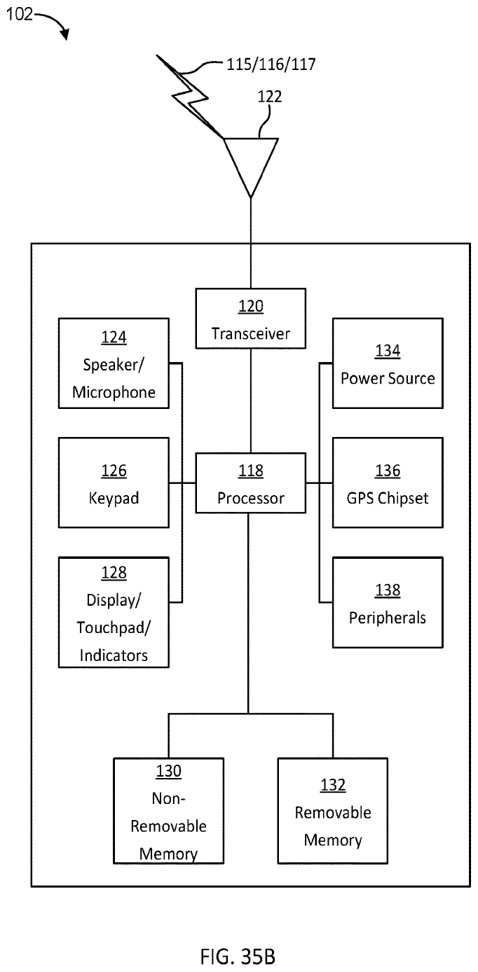

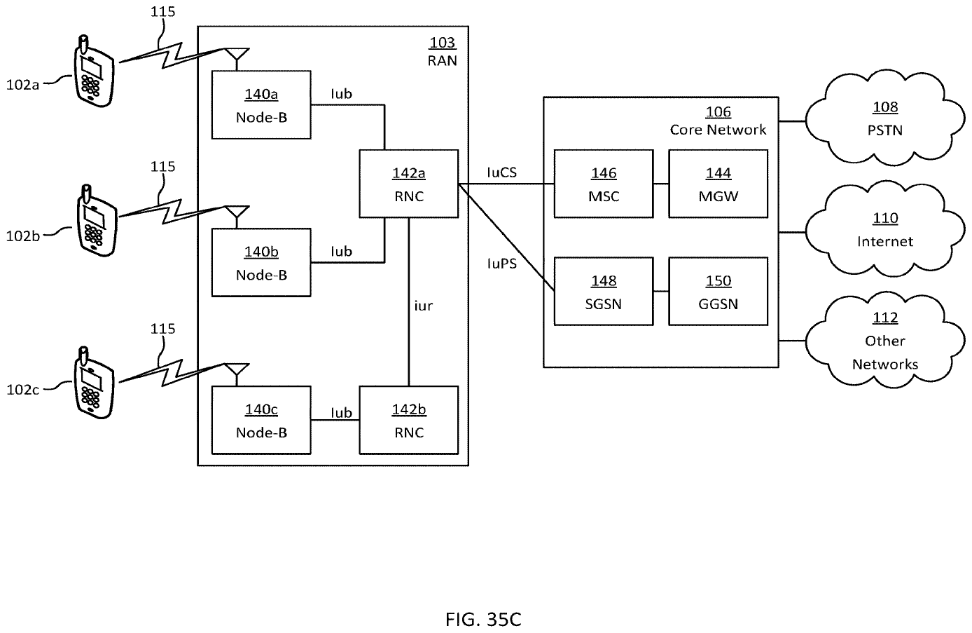

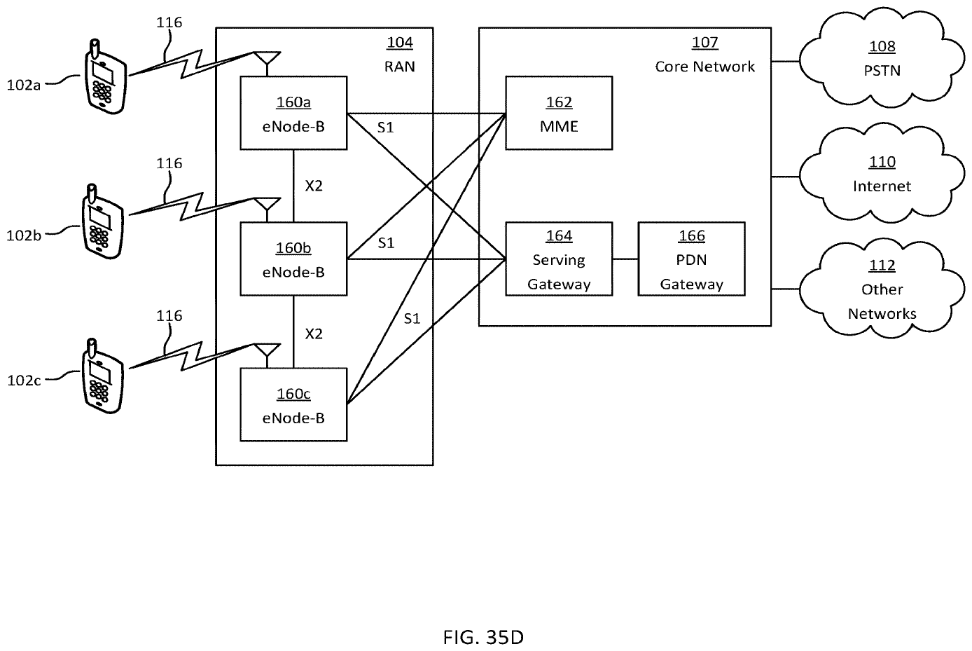

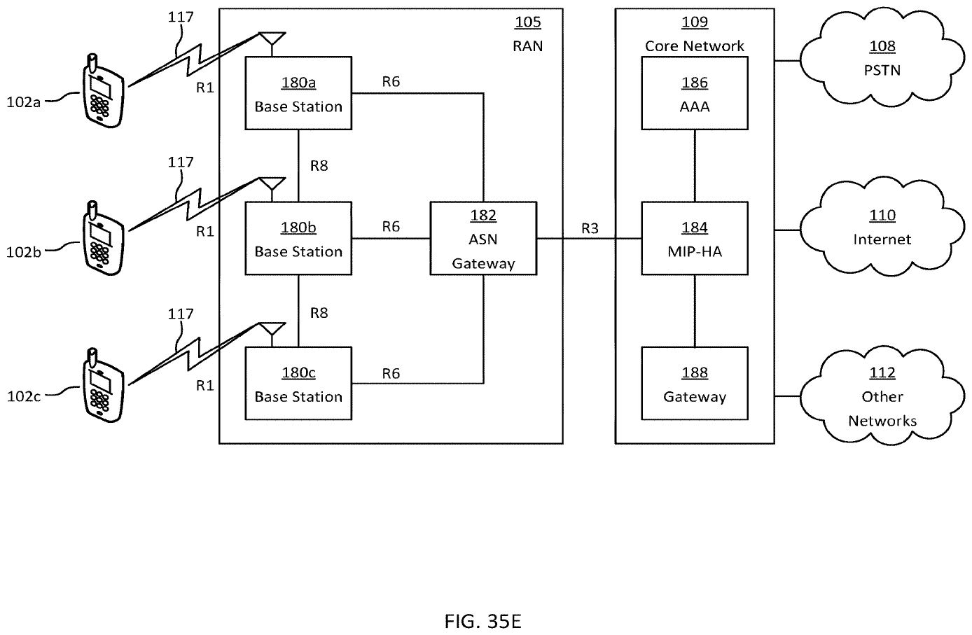

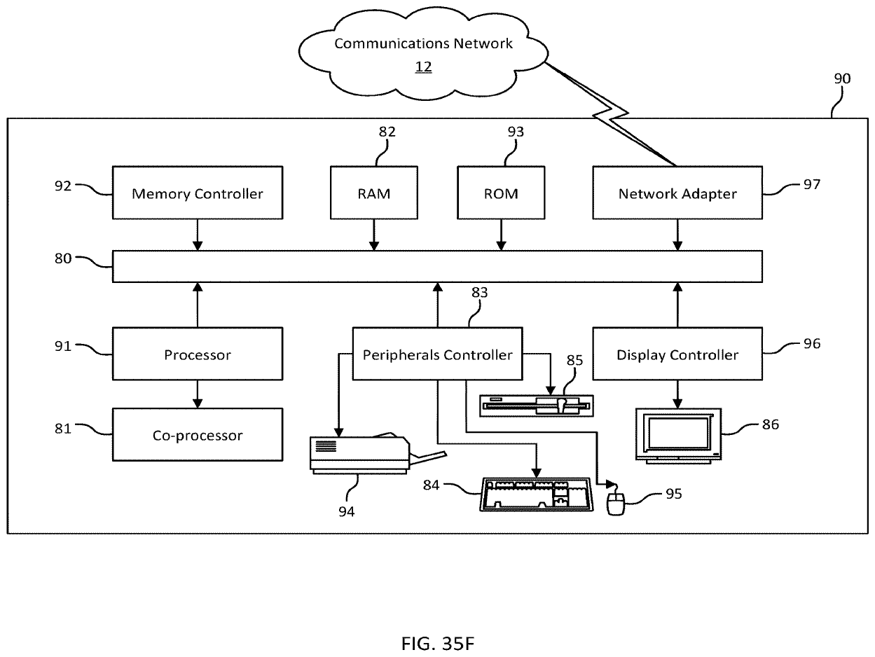

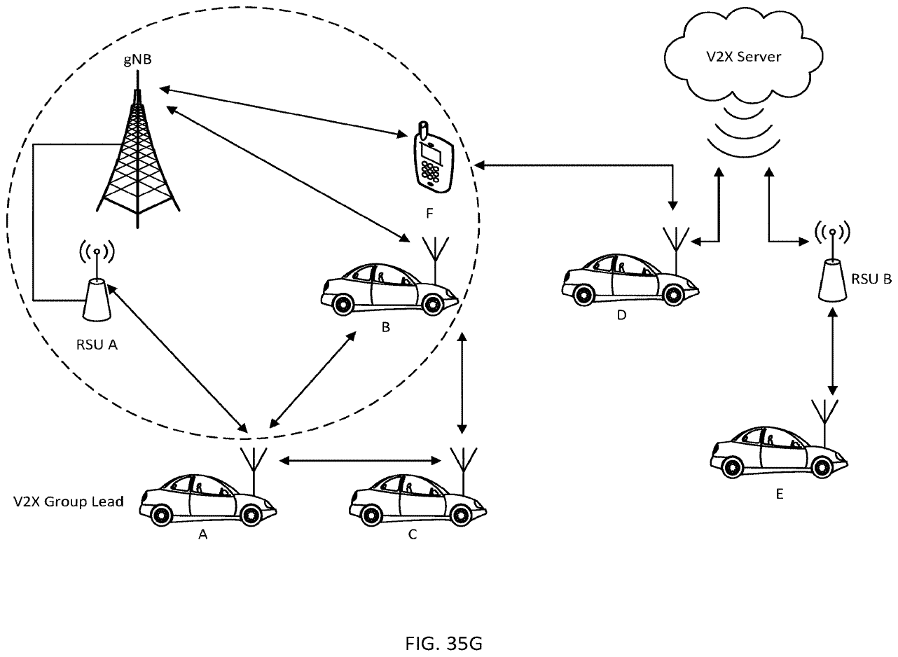

FIG. 35A illustrates an example communications system 100 in which the methods and apparatuses described and claimed herein may be an aspect of. As shown, the example communications system 100 may include wireless transmit/receive units (WTRUs) 102a, 102b, 102c, 102d, 102e, 102f, and/or 102g (which generally or collectively may be referred to as WTRU 102), a radio access network (RAN) 103/104/105/103b/104b/105b, a core network 106/107/109, a public switched telephone network (PSTN) 108, the Internet 110, other networks 112, and V2X server (or ProSe function and server) 113, though it will be appreciated that the disclosed examples contemplate any number of WTRUs, base stations, networks, and/or network elements. Each of the WTRUs 102a, 102b, 102c, 102d, 102e, 102f, 102g may be any type of apparatus or device configured to operate and/or communicate in a wireless environment. Although each WTRU 102a, 102b, 102c, 102d, 102e, 102f, 102g is depicted in 35A-35E as a hand-held wireless communications apparatus, it is understood that with the wide variety of use cases contemplated for 5G wireless communications, each WTRU may comprise or be embodied in any type of apparatus or device configured to transmit and/or receive wireless signals, including, by way of example only, user equipment (UE), a mobile station, a fixed or mobile subscriber unit, a pager, a cellular telephone, a personal digital assistant (PDA), a smartphone, a laptop, a tablet, a netbook, a notebook computer, a personal computer, a wireless sensor, consumer electronics, a wearable device such as a smart watch or smart clothing, a medical or eHealth device, a robot, industrial equipment, a drone, a vehicle such as a car, truck, train, or airplane, and the like.

The communications system 100 may also include a base station 114a and a base station 114b. Base stations 114a may be any type of device configured to wirelessly interface with at least one of the WTRUs 102a, 102b, 102c to facilitate access to one or more communication networks, such as the core network 106/107/109, the Internet 110, and/or the other networks 112. Base stations 114b may be any type of device configured to wiredly and/or wirelessly interface with at least one of the RRHs (Remote Radio Heads) 118a, 118b, TRPs (Transmission and Reception Points) 119a, 119b, and/or RSUs (Roadside Units) 120a and 120b to facilitate access to one or more communication networks, such as the core network 106/107/109, the Internet 110, the other networks 112, and/or V2X server (or ProSe function and server) 113. RRHs 118a, 118b may be any type of device configured to wirelessly interface with at least one of the WTRU 102c, to facilitate access to one or more communication networks, such as the core network 106/107/109, the Internet 110, and/or the other networks 112. TRPs 119a, 119b may be any type of device configured to wirelessly interface with at least one of the WTRU 102d, to facilitate access to one or more communication networks, such as the core network 106/107/109, the Internet 110, and/or the other networks 112. RSUs 120a and 120b may be any type of device configured to wirelessly interface with at least one of the WTRU 102e or 102f, to facilitate access to one or more communication networks, such as the core network 106/107/109, the Internet 110, the other networks 112, and/or V2X server (or ProSe function and server) 113. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 103/104/105, which may also include other base stations and/or network elements (not shown), such as a base station controller (BSC), a radio network controller (RNC), relay nodes, etc. The base station 114b may be part of the RAN 103b/104b/105b, which may also include other base stations and/or network elements (not shown), such as a base station controller (BSC), a radio network controller (RNC), relay nodes, etc. The base station 114a may be configured to transmit and/or receive wireless signals within a particular geographic region, which may be referred to as a cell (not shown). The base station 114b may be configured to transmit and/or receive wired and/or wireless signals within a particular geographic region, which may be referred to as a cell (not shown). The cell may further be divided into cell sectors. For example, the cell associated with the base station 114a may be divided into three sectors. Thus, the base station 114a may include three transceivers, e.g., one for each sector of the cell. In some cases, the base station 114a may employ multiple-input multiple output (MIMO) technology and, therefore, may utilize multiple transceivers for each sector of the cell.

The base stations 114a may communicate with one or more of the WTRUs 102a, 102b, 102c over an air interface 115/116/117, which may be any suitable wireless communication link (e.g., radio frequency (RF), microwave, infrared (IR), ultraviolet (UV), visible light, cmWave, mmWave, etc.). The air interface 115/116/117 may be established using any suitable radio access technology (RAT).

The base stations 114b may communicate with one or more of the RRHs 118a, 118b, TRPs 119a, 119b, and/or RSUs 120a and 120b, over a wired or air interface 115b/116b/117b, which may be any suitable wired (e.g., cable, optical fiber, etc.) or wireless communication link (e.g., radio frequency (RF), microwave, infrared (IR), ultraviolet (UV), visible light, cmWave, mmWave, etc.). The air interface 115b/116b/117b may be established using any suitable radio access technology (RAT).

The RRHs 118a, 118b, TRPs 119a, 119b and/or RSUs 120a, 120b, may communicate with one or more of the WTRUs 102c, 102d, 102e, 102f over an air interface 115c/116c/117c, which may be any suitable wireless communication link (e.g., radio frequency (RF), microwave, infrared (IR), ultraviolet (UV), visible light, cmWave, mmWave, etc.). The air interface 115c/116c/117c may be established using any suitable radio access technology (RAT).

The WTRUs 102a, 102b, 102c, 102d, 102e, 102f, and/or 102g may communicate with one another over an air interface 115d/116d/117d (not shown in the figures), which may be any suitable wireless communication link (e.g., radio frequency (RF), microwave, infrared (IR), ultraviolet (UV), visible light, cmWave, mmWave, etc.). The air interface 115d/116d/117d may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c, or RRHs 118a, 118b, TRPs 119a, 119b and RSUs 120a, 120b, in the RAN 103b/104b/105b and the WTRUs 102c, 102d, 102e, 102f, may implement a radio technology such as Universal Mobile Telecommunications System (UMTS) Terrestrial Radio Access (UTRA), which may establish the air interface 115/116/117 or 115c/116c/117c respectively using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In some cases, the base station 114a and the WTRUs 102a, 102b, 102c, or RRHs 118a, 118b, TRPs 119a, 119b, and/or RSUs 120a, 120b, in the RAN 103b/104b/105b and the WTRUs 102c, 102d, may implement a radio technology such as Evolved UMTS Terrestrial Radio Access (E-UTRA), which may establish the air interface 115/116/117 or 115c/116c/117c respectively using Long Term Evolution (LTE) and/or LTE-Advanced (LTE-A). In the future, the air interface 115/116/117 may implement 3GPP NR technology. The LTE and LTE-A technology includes LTE D2D and V2X technologies and interface (such as Sidelink communications, etc.) The 3GPP NR technology includes NR V2X technologies and interface (such as Sidelink communications, etc.)

In some cases, the base station 114a in the RAN 103/104/105 and the WTRUs 102a, 102b, 102c, or RRHs 118a, 118b, TRPs 119a, 119b and/or RSUs 120a, 120b, in the RAN 103b/104b/105b and the WTRUs 102c, 102d, 102e, 102f may implement radio technologies such as IEEE 802.16 (e.g., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114c in FIG. 35A may be a wireless router, Home Node B, Home eNode B, or access point, for example, and may utilize any suitable RAT for facilitating wireless connectivity in a localized area, such as a place of business, a home, a vehicle, a campus, and the like. In some cases, the base station 114c and the WTRUs 102e, may implement a radio technology such as IEEE 802.11 to establish a wireless local area network (WLAN). In some cases, the base station 114c and the WTRUs 102d, may implement a radio technology such as IEEE 802.15 to establish a wireless personal area network (WPAN). In some cases, the base station 114c and the WTRUs 102e, may utilize a cellular-based RAT (e.g., WCDMA, CDMA2000, GSM, LTE, LTE-A, etc.) to establish a picocell or femtocell. As shown in FIG. 35A, the base station 114b may have a direct connection to the Internet 110. Thus, the base station 114c may not be required to access the Internet 110 via the core network 106/107/109.

The RAN 103/104/105 and/or RAN 103b/104b/105b may be in communication with the core network 106/107/109, which may be any type of network configured to provide voice, data, applications, and/or voice over internet protocol (VOIP) services to one or more of the WTRUs 102a, 102b, 102c, 102d. For example, the core network 106/107/109 may provide call control, billing services, mobile location-based services, pre-paid calling, Internet connectivity, video distribution, etc., and/or perform high-level security functions, such as user authentication.

Although not shown in FIG. 35A, it will be appreciated that the RAN 103/104/105 and/or RAN 103b/104b/105b and/or the core network 106/107/109 may be in direct or indirect communication with other RANs that employ the same RAT as the RAN 103/104/105 and/or RAN 103b/104b/105b or a different RAT. For example, in addition to being connected to the RAN 103/104/105 and/or RAN 103b/104b/105b, which may be utilizing an E-UTRA radio technology, the core network 106/107/109 may also be in communication with another RAN (not shown) employing a GSM radio technology.

The core network 106/107/109 may also serve as a gateway for the WTRUs 102a, 102b, 102c, 102d, 102e to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 103/104/105 and/or RAN 103b/104b/105b or a different RAT.

Some or all of the WTRUs 102a, 102b, 102c, 102d in the communications system 100 may include multi-mode capabilities, e.g., the WTRUs 102a, 102b, 102c, 102d, and 102e may include multiple transceivers for communicating with different wireless networks over different wireless links. For example, the WTRU 102e shown in FIG. 35A may be configured to communicate with the base station 114a, which may employ a cellular-based radio technology, and with the base station 114c, which may employ an IEEE 802 radio technology.

FIG. 35B is a block diagram of an example apparatus or device configured for wireless communications in accordance with the aspects illustrated herein, such as for example, a WTRU 102. As shown in FIG. 35B, the example WTRU 102 may include a processor 118, a transceiver 120, a transmit/receive element 122, a speaker/microphone 124, a keypad 113, a display/touchpad/indicators 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an example. Also, in some cases the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, and proxy nodes, among others, may include some or all of the elements depicted in FIG. 35B and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 35B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 115/116/117. For example, in some cases, the transmit/receive element 122 may be an antenna configured to transmit and/or receive RF signals. In some cases, the transmit/receive element 122 may be an emitter/detector configured to transmit and/or receive IR, UV, or visible light signals, for example. In some cases, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 35B as a single element, the WTRU 102 may include any number of transmit/receive elements 122. More specifically, the WTRU 102 may employ MIMO technology. Thus, in some cases, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad/indicators 128 (e.g., a liquid crystal display (LCD) display unit or organic light-emitting diode (OLED) display unit). The processor 118 may also output user data to the speaker/microphone 124, the keypad 126, and/or the display/touchpad/indicators 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In some cases, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries, solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an aspect.

The processor 118 may further be coupled to other peripherals 138, which may include one or more software and/or hardware modules that provide additional features, functionality and/or wired or wireless connectivity. For example, the peripherals 138 may include various sensors such as an accelerometer, biometrics (e.g., finger print) sensors, an e-compass, a satellite transceiver, a digital camera (for photographs or video), a universal serial bus (USB) port or other interconnect interfaces, a vibration device, a television transceiver, a hands free headset, a Bluetooth® module, a frequency modulated (FM) radio unit, a digital music player, a media player, a video game player module, an Internet browser, and the like.

The WTRU 102 may be embodied in other apparatuses or devices, such as a sensor, consumer electronics, a wearable device such as a smart watch or smart clothing, a medical or eHealth device, a robot, industrial equipment, a drone, a vehicle such as a car, truck, train, or airplane. The WTRU 102 may connect to other components, modules, or systems of such apparatuses or devices via one or more interconnect interfaces, such as an interconnect interface that may comprise one of the peripherals 138.

FIG. 35C is a system diagram of the RAN 103 and the core network 106. As noted above, the RAN 103 may employ a UTRA radio technology to communicate with the WTRUs 102a, 102b, and 102c over the air interface 115. The RAN 103 may also be in communication with the core network 106. As shown in FIG. 35C, the RAN 103 may include Node-Bs 140a, 140b, 140c, which may each include one or more transceivers for communicating with the WTRUs 102a, 102b, 102c over the air interface 115. The Node-Bs 140a, 140b, 140c may each be associated with a particular cell (not shown) within the RAN 103. The RAN 103 may also include RNCs 142a, 142b. It will be appreciated that the RAN 103 may include any number of Node-Bs and RNCs while remaining consistent with an aspect of the disclosure.

As shown in FIG. 35C, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macro-diversity, security functions, data encryption, and the like.

The core network 106 shown in FIG. 35C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

FIG. 35D is a system diagram of the RAN 104 and the core network 107. As noted above, the RAN 104 may employ an E-UTRA radio technology to communicate with the WTRUs 102a, 102b, and 102c over the air interface 116. The RAN 104 may also be in communication with the core network 107.

The RAN 104 may include eNode-Bs 160a, 160b, 160c, though it will be appreciated that the RAN 104 may include any number of eNode-Bs while remaining consistent with an aspect of the disclosure. The eNode-Bs 160a, 160b, 160c may each include one or more transceivers for communicating with the WTRUs 102a, 102b, 102c over the air interface 116. In some cases, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink and/or downlink, and the like. As shown in FIG. 35D, the eNode-Bs 160a, 160b, 160c may communicate with one another over an X2 interface.

The core network 107 shown in FIG. 35D may include a mobility management gateway (MME) 162, a serving gateway 164, and a packet data network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, and 160c in the RAN 104 via the S1 interface. The serving gateway 164 may generally route and forward user data packets to/from the WTRUs 102a, 102b, 102c. The serving gateway 164 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 164 may also be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The core network 107 may facilitate communications with other networks. For example, the core network 107 may provide the WTRUs 102a, 102b, 102c with access to circuit-switched networks, such as the PSTN 108, to facilitate communications between the WTRUs 102a, 102b, 102c and traditional land-line communications devices. For example, the core network 107 may include, or may communicate with, an IP gateway (e.g., an IP multimedia subsystem (IMS) server) that serves as an interface between the core network 107 and the PSTN 108. In addition, the core network 107 may provide the WTRUs 102a, 102b, 102c with access to the networks 112, which may include other wired or wireless networks that are owned and/or operated by other service providers.

FIG. 35E is a system diagram of the RAN 105 and the core network 109. The RAN 105 may be an access service network (ASN) that employs IEEE 802.16 radio technology to communicate with the WTRUs 102a, 102b, and 102c over the air interface 117. As will be further discussed below, the communication links between the different functional entities of the WTRUs 102a, 102b, 102c, the RAN 105, and the core network 109 may be defined as reference points.

As shown in FIG. 35E, the RAN 105 may include base stations 180a, 180b, 180c, and an ASN gateway 182, though it will be appreciated that the RAN 105 may include any number of base stations and ASN gateways while remaining consistent with an aspect of the disclosure. The base stations 180a, 180b, 180c may each be associated with a particular cell in the RAN 105 and may include one or more transceivers for communicating with the WTRUs 102a, 102b, 102c over the air interface 117. In some cases, the base stations 180a, 180b, 180c may implement MIMO technology. Thus, the base station 180a, for example, may use multiple antennas to transmit wireless signals to, and receive wireless signals from, the WTRU 102a. The base stations 180a, 180b, 180c may also provide mobility management functions, such as handoff triggering, tunnel establishment, radio resource management, traffic classification, quality of service (QoS) policy enforcement, and the like. The ASN gateway 182 may serve as a traffic aggregation point and may be responsible for paging, caching of subscriber profiles, routing to the core network 109, and the like.

The air interface 117 between the WTRUs 102a, 102b, 102c and the RAN 105 may be defined as an R1 reference point that implements the IEEE 802.16 specification. In addition, each of the WTRUs 102a, 102b, and 102c may establish a logical interface (not shown) with the core network 109. The logical interface between the WTRUs 102a, 102b, 102c and the core network 109 may be defined as an R2 reference point, which may be used for authentication, authorization, IP host configuration management, and/or mobility management.

The communication link between each of the base stations 180a, 180b, and 180c may be defined as an R8 reference point that includes protocols for facilitating WTRU handovers and the transfer of data between base stations. The communication link between the base stations 180a, 180b, 180c and the ASN gateway 182 may be defined as an R6 reference point. The R6 reference point may include protocols for facilitating mobility management based on mobility events associated with each of the WTRUs 102a, 102b, 102c.

As shown in FIG. 35E, the RAN 105 may be connected to the core network 109. The communication link between the RAN 105 and the core network 109 may defined as an R3 reference point that includes protocols for facilitating data transfer and mobility management capabilities, for example. The core network 109 may include a mobile IP home agent (MIP-HA) 184, an authentication, authorization, accounting (AAA) server 186, and a gateway 188. While each of the foregoing elements are depicted as part of the core network 109, it will be appreciated that any one of these elements may be owned and/or operated by an entity other than the core network operator.

The MIP-HA may be responsible for IP address management, and may enable the WTRUs 102a, 102b, and 102c to roam between different ASNs and/or different core networks. The MIP-HA 184 may provide the WTRUs 102a, 102b, 102c with access to packet-switched networks, such as the Internet 110, to facilitate communications between the WTRUs 102a, 102b, 102c and IP-enabled devices. The AAA server 186 may be responsible for user authentication and for supporting user services. The gateway 188 may facilitate interworking with other networks. For example, the gateway 188 may provide the WTRUs 102a, 102b, 102c with access to circuit-switched networks, such as the PSTN 108, to facilitate communications between the WTRUs 102a, 102b, 102c and traditional land-line communications devices. In addition, the gateway 188 may provide the WTRUs 102a, 102b, 102c with access to the networks 112, which may include other wired or wireless networks that are owned and/or operated by other service providers.

Although not shown in FIG. 35E, it will be appreciated that the RAN 105 may be connected to other ASNs and the core network 109 may be connected to other core networks. The communication link between the RAN 105 the other ASNs may be defined as an R4 reference point, which may include protocols for coordinating the mobility of the WTRUs 102a, 102b, 102c between the RAN 105 and the other ASNs. The communication link between the core network 109 and the other core networks may be defined as an R5 reference, which may include protocols for facilitating interworking between home core networks and visited core networks.

The core network entities described herein and illustrated in FIGS. 35A, 35C, 35D, and 35E are identified by the names given to those entities in certain existing 3GPP specifications, but it is understood that in the future those entities and functionalities may be identified by other names and certain entities or functions may be combined in future specifications published by 3GPP, including future 3GPP NR specifications. Thus, the particular network entities and functionalities described and illustrated in FIGS. 35A, 35B, 35C, 35D, and 35E are provided by way of example only, and it is understood that the subject matter disclosed and claimed herein may be embodied or implemented in any similar communication system, whether presently defined or defined in the future.

FIG. 35F is a block diagram of an exemplary computing system 90 in which one or more apparatuses of the communications networks illustrated in FIGS. 35A, 35C, 35D and 35E may be embodied, such as certain nodes or functional entities in the RAN 103/104/105, Core Network 106/107/109, PSTN 108, Internet 110, or Other Networks 112. Computing system 90 may comprise a computer or server and may be controlled primarily by computer readable instructions, which may be in the form of software, wherever, or by whatever means such software is stored or accessed. Such computer readable instructions may be executed within a processor 91, to cause computing system 90 to do work. The processor 91 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 91 may perform signal coding, data processing, power control, input/output processing, and/or any other functionality that enables the computing system 90 to operate in a communications network. Coprocessor 81 is an optional processor, distinct from main processor 91, that may perform additional functions or assist processor 91. Processor 91 and/or coprocessor 81 may receive, generate, and process data related to the methods and apparatuses disclosed herein.

In operation, processor 91 fetches, decodes, and executes instructions, and transfers information to and from other resources via the computing system's main data-transfer path, system bus 80. Such a system bus connects the components in computing system 90 and defines the medium for data exchange. System bus 80 typically includes data lines for sending data, address lines for sending addresses, and control lines for sending interrupts and for operating the system bus. An example of such a system bus 80 is the PCI (Peripheral Component Interconnect) bus.

Memories coupled to system bus 80 include random access memory (RAM) 82 and read only memory (ROM) 93. Such memories include circuitry that allows information to be stored and retrieved. ROMs 93 generally contain stored data that cannot easily be modified. Data stored in RAM 82 may be read or changed by processor 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 90 may contain peripherals controller 83 responsible for communicating instructions from processor 91 to peripherals, such as printer 94, keyboard 84, mouse 95, and disk drive 85.

Display 86, which is controlled by display controller 96, is used to display visual output generated by computing system 90. Such visual output may include text, graphics, animated graphics, and video. The visual output may be provided in the form of a graphical user interface (GUI). Display 86 may be implemented with a CRT-based video display, an LCD-based flat-panel display, gas plasma-based flat-panel display, or a touch-panel. Display controller 96 includes electronic components required to generate a video signal that is sent to display 86.

Further, computing system 90 may contain communication circuitry, such as for example a network adapter 97, that may be used to connect computing system 90 to an external communications network, such as the RAN 103/104/105, Core Network 106/107/109, PSTN 108, Internet 110, or Other Networks 112 of FIGS. 35A, 35B, 35C, 35D, and 35E, to enable the computing system 90 to communicate with other nodes or functional entities of those networks. The communication circuitry, alone or in combination with the processor 91, may be used to perform the transmitting and receiving steps of certain apparatuses, nodes, or functional entities described herein.

FIG. 35G illustrates an example communications system 111 in which the methods and apparatuses described and claimed herein may be an aspect of. As shown, the example communications system 111 may include wireless transmit/receive units (WTRUs) A, B, C, D, E, F, a base station, a V2X server, and a RSUs A and B, though it will be appreciated that the disclosure contemplates any number of WTRUs, base stations, networks, and/or network elements. One or several or all WTRUs A, B, C, D, E can be out of range of the network (for example, in the figure out of the cell coverage boundary shown as the dash line). WTRUs A, B, C form a V2X group, among which WTRU A is the group lead and WTRUs B and C are group members. WTRUs A, B, C, D, E, F may communicate over Uu interface or Sidelink (PC5) interface.

It is understood that any or all of the apparatuses, systems, methods and processes described herein may be embodied in the form of computer executable instructions (e.g., program code) stored on a computer-readable storage medium which instructions, when executed by a processor, such as processors 118 or 91, cause the processor to perform and/or implement the systems, methods and processes described herein. Specifically, any of the steps, operations or functions described herein may be implemented in the form of such computer executable instructions, executing on the processor of an apparatus or computing system configured for wireless and/or wired network communications. Computer readable storage media include volatile and nonvolatile, removable and non-removable media implemented in any non-transitory (e.g., tangible or physical) method or technology for storage of information, but such computer readable storage media do not include signals. Computer readable storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible or physical medium which may be used to store the desired information and which may be accessed by a computing system.

### Definitions

Provided below are definitions for abbreviations found within the body of the disclosure.

| | |
|---|---|
| 3GPP | Third Generation Partnership Project |
| 5GS | 5G System |
| 6GS | 6G System |
| AF | Application Function |
| API | Application Programming Interface |
| AR | Augmented Reality |
| AS | Application Server |
| EAS | Edge Application Server |
| EEC | Edge Enabler Client |
| EES | Edge Enabler Server |
| FQDN | Fully Qualified Domain Name |
| GUI | Graphical User Interface |
| MNO | Mobile Network Operator |
| NEF | Network Exposure Function |
| RAN | Radio Access Network |
| TACMM | Tactile and multi-modality communication services |
| UE | User Equipment |
| URI | Uniform Resource Identifier |
| VAL | Vertical Application Layer |
| VR | Virtual Reality |
| XR | eXtended Reality |
| XRM | eXtended Reality and Media services |

What is claimed:

1. A method, comprising:
receiving, by an XRM client and from a VAL client, a discovery request for a spatial anchor, wherein the discovery request comprises spatial anchor contextual information;
sending, by the XRM client and to the VAL client, a discovery response indicative of one or more spatial anchors according to the spatial anchor contextual information; and
receiving, by the XRM client and from the VAL client, a subscription request for the one or more spatial anchors.

2. The method of claim 1, wherein the spatial anchor contextual information comprises criteria information for one or more spatial anchors.

3. The method of claim 2, wherein the criteria information comprises:
a spatial anchor association with a VAL client ID, a VAL server ID, or a VAL server ID;
a spatial anchor type or instance;
a spatial anchor status;
an anchoring with an object;
a location or distance;
an enabling to track or detect changes in location, orientation, or distance of an anchored object;
a ranging and UE detection capability;
a type of linked digital content;
a subscription association;
an activity schedule; or
a combination thereof.

4. The method of claim 1, wherein the spatial anchor contextual information comprises an orientation of a spatial anchor, a location of the spatial anchor, an identity of the spatial anchor, a ranging precision of the spatial anchor, one or more key performance indicator (KPI) values of the spatial anchor, or a combination thereof.

5. The method of claim 1, wherein the discovery response comprises identifiers of the one or more spatial anchors.

6. The method of claim 1, wherein the XRM client authenticates the VAL client prior to sending the response.

7. The method of claim 1, further comprising:
sending, by the XRM client and to the VAL client, a subscription response for the one or more spatial anchors.

8. The method of claim 1, further comprising:
receiving, by the XRM client and from the VAL client, a request to access VAL content or services associated with the one or more spatial anchors.

9. The method of claim 8, further comprising:
sending, by the XRM client and to the VAL client, an access response comprising VAL content or services associated with the one or more spatial anchors.

10. The method of claim 1, wherein the discovery response comprises a spatial anchor identifier, spatial anchor location information, validity criteria of a spatial anchor, endpoint information associated with a spatial anchor, service information associated with a VAL server, or a combination thereof.

11. An apparatus, comprising:
one or more processors; and
instructions stored in memory that, when executed by the one or more processors, cause the apparatus to:
receive, from a VAL client, a discovery request for a spatial anchor, wherein the discovery request comprises spatial anchor contextual information;
send, to the VAL client, a discovery response indicative of one or more spatial anchors according to the spatial anchor contextual information; and
receive, from the VAL client, a subscription request for the one or more spatial anchors.

12. The apparatus of claim 11, wherein the spatial anchor contextual information comprises criteria information for one or more spatial anchors.

13. The apparatus of claim 12, wherein the criteria information comprises:
a spatial anchor association with a VAL client ID, a VAL server ID, or a VAL server ID;
a spatial anchor type or instance;
a spatial anchor status;
an anchoring with an object;
a location or distance;
an enabling to track or detect changes in location, orientation, or distance of an anchored object;
a ranging and UE detection capability;
a type of linked digital content;
a subscription association;
an activity schedule; or
a combination thereof.

14. The apparatus of claim 11, wherein the spatial anchor contextual information comprises an orientation of a spatial anchor, a location of the spatial anchor, an identity of the spatial anchor, a ranging precision of the spatial anchor, one or more key performance indicator (KPI) values of the spatial anchor, or a combination thereof.

15. The apparatus of claim 11, wherein the response comprises identifiers of the one or more spatial anchors.

16. The apparatus of claim 11, wherein the apparatus authenticates the VAL client prior to sending the response.

17. The apparatus of claim 11, wherein the instructions, when executed, further cause the apparatus to:
send, to the VAL client, a subscription response for the one or more spatial anchors.

18. The apparatus of claim 11, wherein the instructions, when executed, further cause the apparatus to:
receive, from the VAL client, a request to access VAL content or services associated with the one or more spatial anchors.

19. The apparatus of claim 18, wherein the instructions, when executed, further cause the apparatus to:
send, to the VAL client, an access response comprising VAL content or services associated with the one or more spatial anchors.

20. The apparatus of claim 11, wherein the discovery response comprises a spatial anchor identifier, spatial anchor location information, validity criteria of a spatial anchor, endpoint information associated with a spatial anchor, service information associated with a VAL server, or a combination thereof.
